(19) United States
(12) Patent Application Publication
(10) Pub. No.: US 2025/0011545 A1
(43) Pub. Date: Jan. 9, 2025

(54) FUNCTIONALIZED Q-D/T-SILOXANE-BASED POLYMERIC MATERIALS AND FORMULATIONS AND METHOD FOR PREPARING SAME

(71) Applicant: SILOXENE AG, Bruttisellen (CH)

(72) Inventors: Matthias KOEBEL, Bruttisellen (CH); Gabriel MCMANNIS PAGOTTI, Bruttisellen (CH); Silvia PAZ, Bruttisellen (CH); Lilli Corinn KURTEN, Zurichstrasse 38 (CH); Marek NEMEC, Bruttisellen (CH)

(21) Appl. No.: 18/571,104

(22) PCT Filed: Jun. 15, 2022
(86) PCT No.: PCT/EP2022/066404

§ 371 Date: Dec. 15, 2023

(30) Foreign Application Priority Data
Jun. 15, 2021 (EP) 21179490.4

(51) Int. Cl. C08G 77/26; C08G 77/00; C08G 77/18; C08G 77/28; C08L 83/08

(52) U.S. Cl. CPC C08G 77/26; C08G 77/18; C08G 77/28; C08G 77/70; C08L 83/08; C08G 2150/00; C08G 2170/00

(57) ABSTRACT

The present invention pertains to a functionalized polymeric liquid polysiloxane material comprising non-organofunctional Q-type siloxane moieties and mono-organofunctional T- and/or D-type amino siloxane moieties, as well as optionally tri-organofunctional M-type siloxane moieties. The present invention further pertains to corresponding formulations and methods for producing the polymeric liquid polysiloxane material as well as associated uses of the material.

The present invention pertains to a functionalized polymeric liquid polysiloxane material comprising non-organofunctional Q-type siloxane moieties and mono-organofunctional T- and/or D-type amino siloxane moieties, as well as optionally tri-organofunctional M-type siloxane moieties. The present invention further pertains to corresponding formulations and methods for producing the polymeric liquid polysiloxane material as well as associated uses of the material.

In nanotechnology, organic/inorganic hybrid materials can be obtained through a rich variety of preparative techniques. Sol-gel based techniques for example operate in liquid solution, starting from a colloidal suspension of molecular or oligomeric precursors resulting in the spontaneous formation of nanoparticle building blocks. Sols are either prepared in situ from olation and condensation reactions of oligomeric polyhydroxymetallates or by hydrolysis of alkoxysilanes in water-alcohol mixtures. When a low degree of condensation is desired, only small amounts of water reactant are used which leads to branched siloxane compounds with low molecular weight. An example of such a preparation technique employing acid catalyzed hydrolysis in a neat system (solvent free) is described in EP 1510 520 A1. Generally, hydrolysis with such low amounts of water of monomeric alkoxysilane yields oligomers. Many of the single component compounds are commercial, for example, for the case of Q-type Tetraethoxysilane (TEOS) there exist ethylsilicate commercial oligomer mixtures with a silicate content of 40 or even up to 50%, commonly referred to as ethylsilicate 40, ethylsilicate 50 or also know by their brand names e.g. Dynasylan 40 or Dynasylan Silbond 50 (Evonik Industries).

Hyperbranched polyethoxysiloxanes (PEOS) are small molecular building blocks with typical molecular weights ranging from 500 to 50,000 Dalton, spanning a size range from several Angstroms to single digit nanometers. The word hyperbranched also means that those compounds feature a significant fraction of linear species, although they also contain siloxane rings to different extents. Preferred synthetic routes are water-free or “non-hydrolytic” reaction conditions. This is why in general, the preparation of hyperbranched siloxane polymers is far more versatile and offers better control over the final reaction products than the above-mentioned hydrolytic routes because the condensation reactions can be controlled by stoichiometric addition of the reactants. Furthermore, the synthesis can be carried out “neat”, that means in absence of additional cosolvents such as alcohols. As a result of their highly dendritic structure, with a higher degree of polymerization in the center and a lower degree of the linear chain arms at their perimeter, PEOSs exhibit lower melt viscosities and a much greater solubility in themselves but also in other organic solvents than their linear chain siloxane analogues.

Hyperbranched PEOS can be an intriguing class of molecular precursor for all sorts of hybrid molecular building blocks, readily accessible by “non-hydrolytic” methods such as:
1) Condensation of metal hydroxides obtained by reaction of a metal alkoxide with an alkali hydroxide (silanol route);
2) Condensation of metal chlorides with metal alkoxides (chloride route);
3) Condensation of a single metal alkoxide with itself by ether elimination;
4) Condensation of a mixed acetoxy-alkoxy-metallate with itself by elimination of the corresponding acetic acid ester (acetoxy route); or
5) Condensation of metal alkoxides by reaction with acetic anhydride in presence of a suitable catalyst by acetic acid ester elimination (anhydride route).

Method 2) is described in EP0728793A1, where the preparation of hyperbranched polysiloxanes proceeds through heterocondensation of chloro- and alkoxysilanes through alkyl halide elimination. The reaction is catalyzed by Ti-, V- and Zr-containing organometallic compounds.

Method 3) is not well studied but postulated to enable condensation of various transition metal oxides following the pioneering works of Bradley et al. on alkoxy rearrangement mechanisms (J. Chem. Soc., 1958, 99-101].

Method 4) generally uses rather costly acetoxysilanes. WO 00/40640 A1 describes the preparation of lightly branched organosilicon compounds through acetoxy derivatization starting from dimethylsiloxane prepolymers which are crosslinked using trifunctional silanes. WO 00/40640 A1 describes the usefulness of the classic acetoxy route when only a few condensation bonds need to be made i.e. when connecting monomeric with oligomeric/polymeric building blocks to create larger macromolecules. This can be done for example by refluxing silanol terminated prepolymers with alkoxy terminated crosslinkers in the presence of acetic acid under refluxing at elevated temperature or directly with acetoxy-terminated crosslinkers (e.g. triacetoxysilanes).

Method 5) was published by Moeller et al. (e.g. Macromolecules 2006, 39, 1701-1708) and is a more advanced technique for polyalkylmetallate (PAM) preparation in terms of scalability, process safety and ease of implementation compared to methods 1) through 4). WO 2004/058859 A1 describes the preparation of single component PAMs using the anhydride route.

WO 2019/234062 A1 discloses a process for manufacturing a core-shell PEOS-core with an organofunctional silane shell material. WO 2019/234062 A1 describes the preparation of a hyperbranched ethylsilicate “core” by means of non-hydrolytic acetic anhydride condensation chemistry and then the grafting of a shell, made preferentially from a selection of organofunctional T-type trialkoxysilanes in a second temporally separated step to create a hybrid organofunctional core-shell molecular building block. Both steps are preferably carried out in the presence of a tetraalkoxytitanate or related rearrangement catalyst.

PCT/EP2020/075890 describes hyperbranched polyalkoxysiloxane materials comprising Q- and M-, D- and/or T-type functionality within the same macromolecule.

It is the objective of the present invention to provide improved and functionalized organofunctional hyperbranched polyalkoxysiloxane materials comprising Q-, T- and/or D-type, as well as optionally M-type functionalities within the same macromolecule, corresponding formulations, methods for producing the same and various applications thereof.

In a first aspect, the present invention is directed to a polymeric liquid polysiloxane material comprising or consisting of:
(i) non-organofunctional Q-type siloxane moieties selected from the group consisting of:

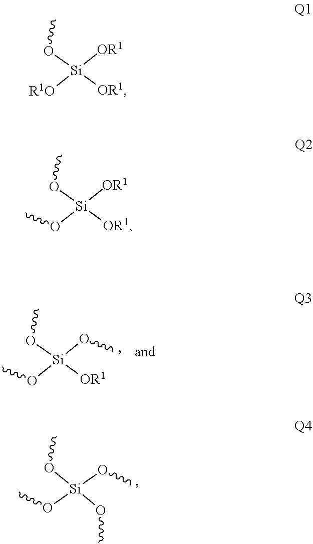

(ii) optionally tri-organofunctional M-type siloxane moieties selected from the group consisting of:

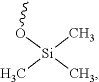

and at least one of
(iii) di-organofunctional D-type siloxane moieties selected from the group consisting of:

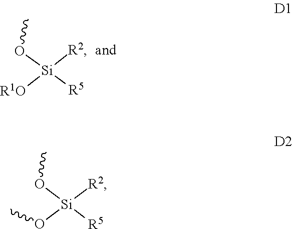

and
(iv) mono-organofunctional T-type siloxane moieties selected from the group consisting of:

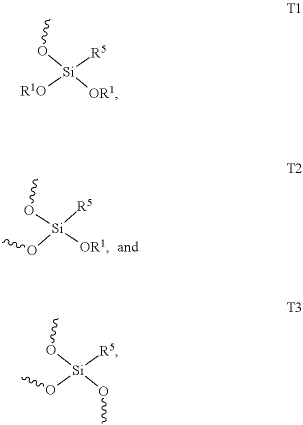

wherein
[symbol] indicates a covalent siloxane bond to a silicon atom of another Q-, M-, D- and/or T-type moiety as defined in (i), (ii), (iii) and/or (iv);
R¹ is selected from the group consisting of methyl, ethyl, propyl, R^{1′} and R³, optionally methyl, ethyl R^{1′} and R³,
R^{1′} is selected from the group consisting of polyols, optionally low molecular linear or branched polyols, polyether polyols, polyester polyols, acrylic polyols, polycarbonate polyols and natural oil based polyols;
R² are each independently methyl, phenyl or vinyl;
R³ is selected from the group consisting of

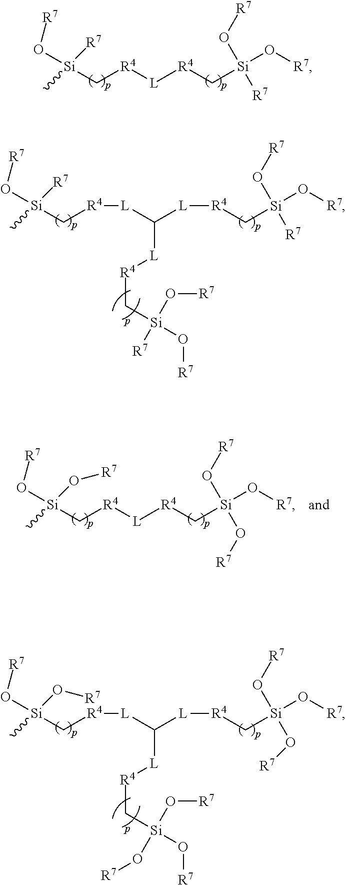

wherein p is an integer from 1 to 4;
R⁷ is methyl or ethyl, optionally propyl, or optionally a silicon atom of another Q-, D- and/or T-type moiety as defined in (i), (ii), (iii) and/or (iv);
L is selected from the group consisting of:

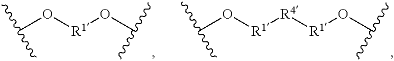

and L′, optionally

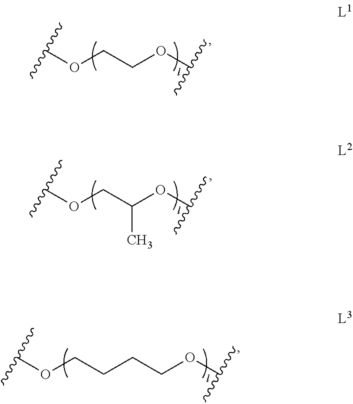

wherein I is an integer from 4 to 600;
L′ is selected from the group consisting of
   -(L)ₘ₁-[(L)ₘ₂-R^{4′}]ₘ₃-co-[(L)ₘ₂-R^{4′}]ₘ₄-co-[(L)ₘ₂-R^{4′}-]ₘ₅-(L)ₘ₁-, optionally
   -(L¹)ₘ₁-[(L¹)ₘ₂-R^{4′}]ₘ₃-co-[(L²)ₘ₂-R^{4′}]ₘ₄-co-[(L³)ₘ₂-R^{4′}-]ₘ₅-(L₁)ₘ₁-, and
   -(L²)ₘ₁-[(L¹)ₘ₂-R^{4′}]ₘ₃-co-[(L²)ₘ₂-R^{4′}]ₘ₄-co-[(L³)ₘ₂-R^{4′}-]ₘ₅-(L¹)ₘ₁-,
   wherein L′ is about or less than 40,000 g/mol, and
   wherein m1 is an integer from 0 to 15, m2 is an integer from 3 to 200, and m3, m4 and m5 are each independently integers from 0 to 10, with the proviso that at least one of m3 to m5 is not 0;
R^{4′} is absent or selected from the group consisting of

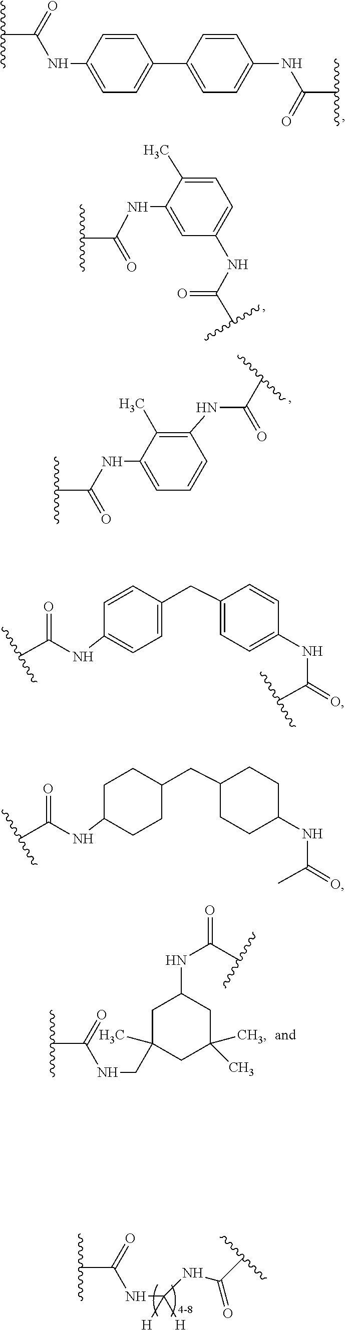

in monomeric, uretdione, biuret or tri-isocyanurate form;
R⁴ is absent, selected from a group defined for R^{4′}, or

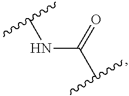 [SMILES: *NC(*)=O]

wherein the carbonyl is attached to the L moiety,
R⁵ is R^{5U} or R^{5S},
   wherein
R^{5U} is selected from the group consisting of

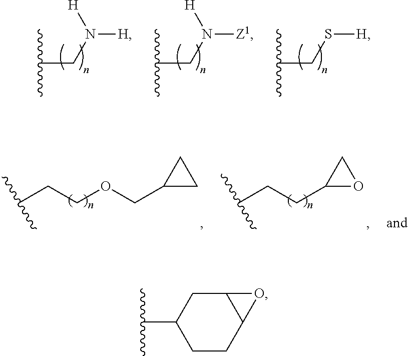

wherein n is an integer from 1 to 5;
Z¹ is selected from the group consisting of

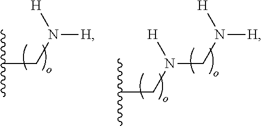

methyl and ethyl, wherein o is an integer from 1 to 3;
R^{5S} is selected from the group consisting of

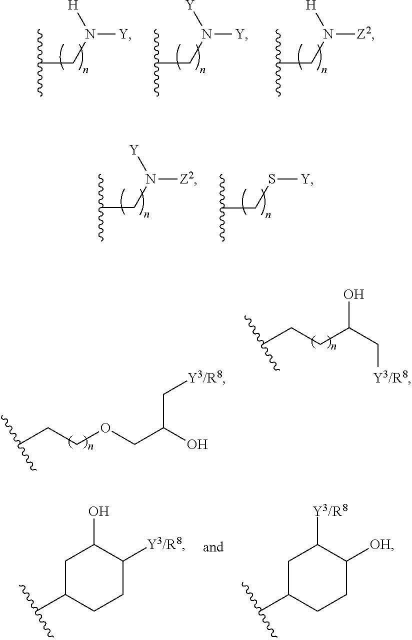

wherein n is an integer from 1 to 5;
Z² is selected from the group consisting of

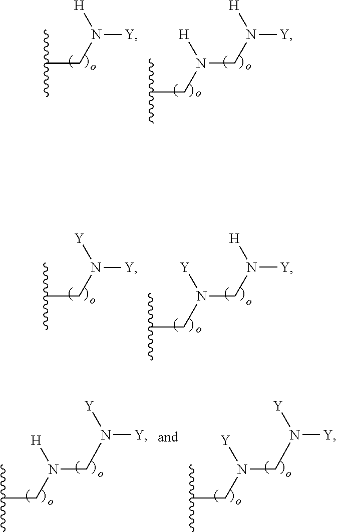

wherein o is an integer from 1 to 3;
Y is independently selected from the group consisting of Y¹, Y², —R^{4′}-L-Y², Y³ and Y⁴, wherein
Y¹ is selected from the group consisting of

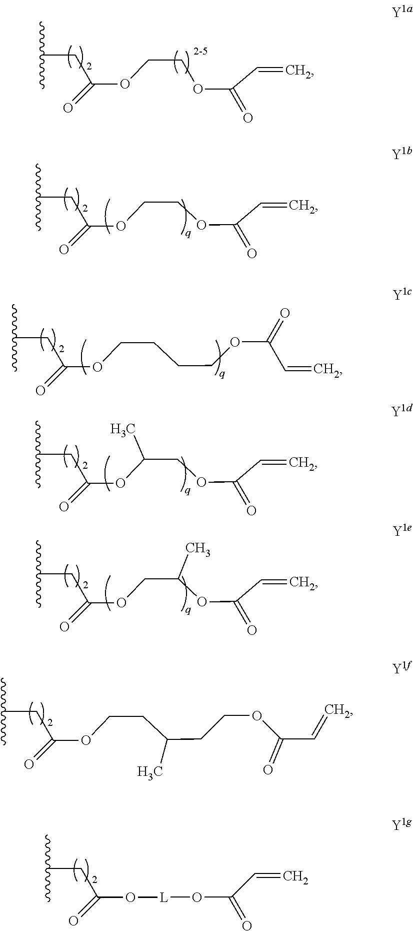

wherein q is an integer from 1 to 10,

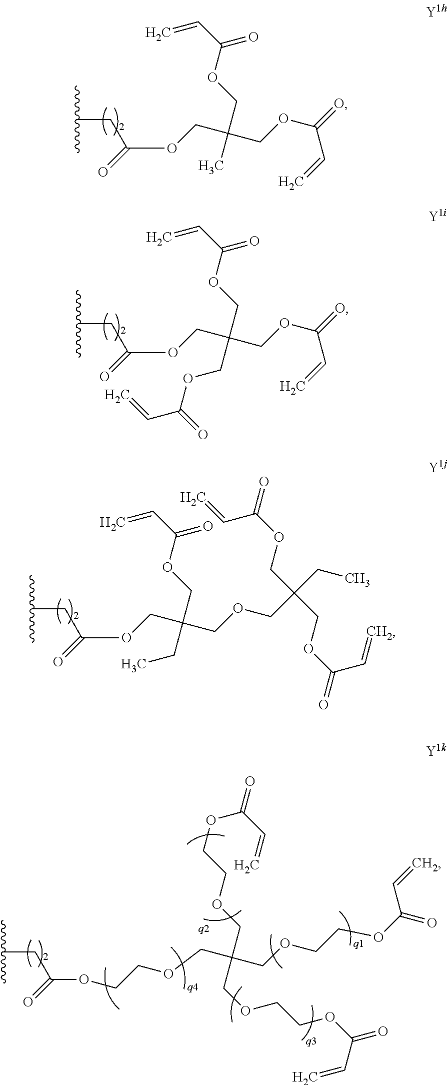

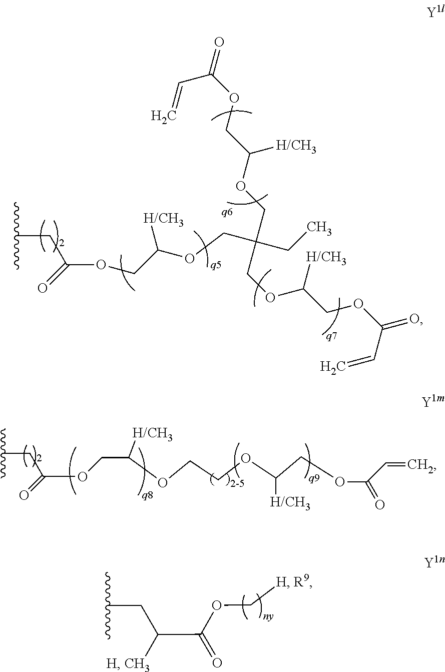

wherein ny is an integer from 0 to 4,

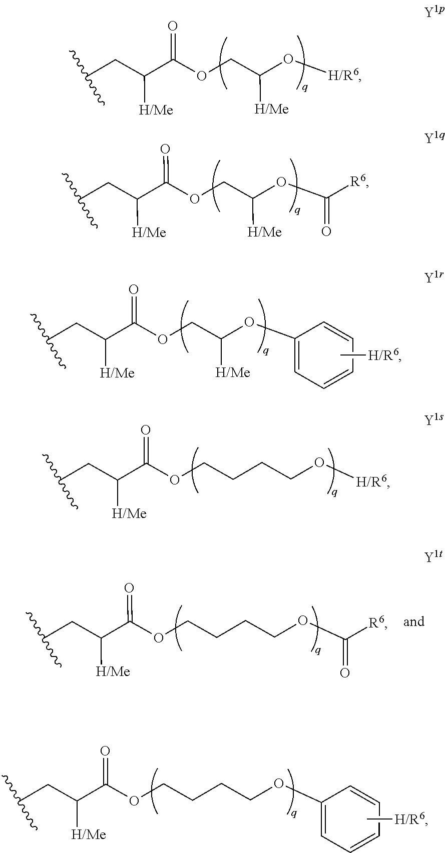

wherein q is as defined above,
wherein each of q1 to q4 are integers from 0 to 8 and the sum of (q1+q2+q3+q4) is from 4 to 8,
wherein each of q5 to q7 are integers from 0 to 24 and the sum of (q5+q6+q7) is from 3 to 24,
and wherein each of q8 and q9 are integers from 0 to 6 and the sum of (q8+q9) is from 2 to 6,
and
wherein R⁹ is selected from the group consisting of

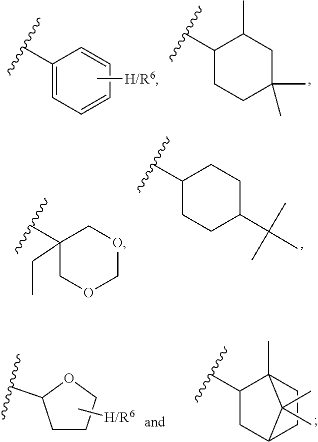

Y² is selected from the group consisting of

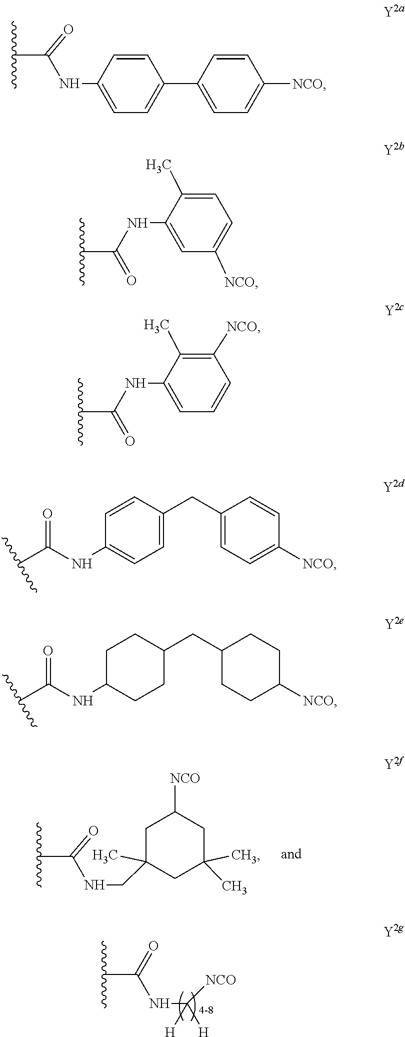

in monomeric, uretdione, biuret or tri-isocyanurate form;
Y³ is selected from the group consisting of

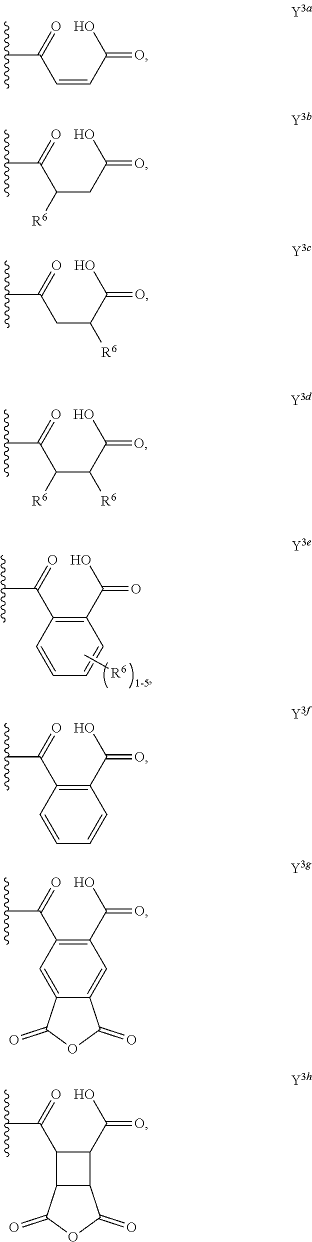

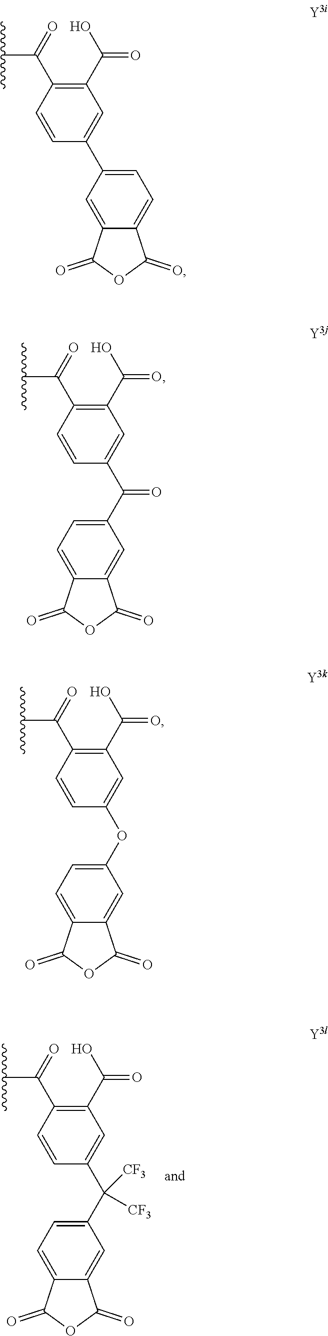 [SMILES: *C(=O)c1ccc(-c2ccc3c(c2)C(=O)OC3=O)cc1C(=O)O ; *C(=O)c1ccc(C(=O)c2ccc3c(c2)C(=O)OC3=O)cc1C(=O)O ; *C(=O)c1ccc(Oc2ccc3c(c2)C(=O)OC3=O)cc1C(=O)O ; *C(=O)c1ccc(C(c2ccc3c(c2)C(=O)OC3=O)(C(F)(F)F)C(F)(F)F)cc1C(=O)O]

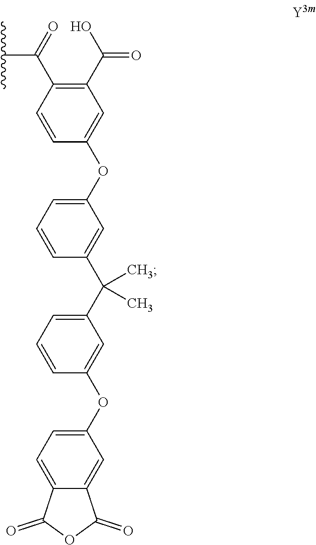 [SMILES: *C(=O)c1ccc(Oc2cccc(C(C)(C)c3cccc(Oc4ccc5c(c4)C(=O)OC5=O)c3)c2)cc1C(=O)O]

Y⁴ is selected from the group consisting of:

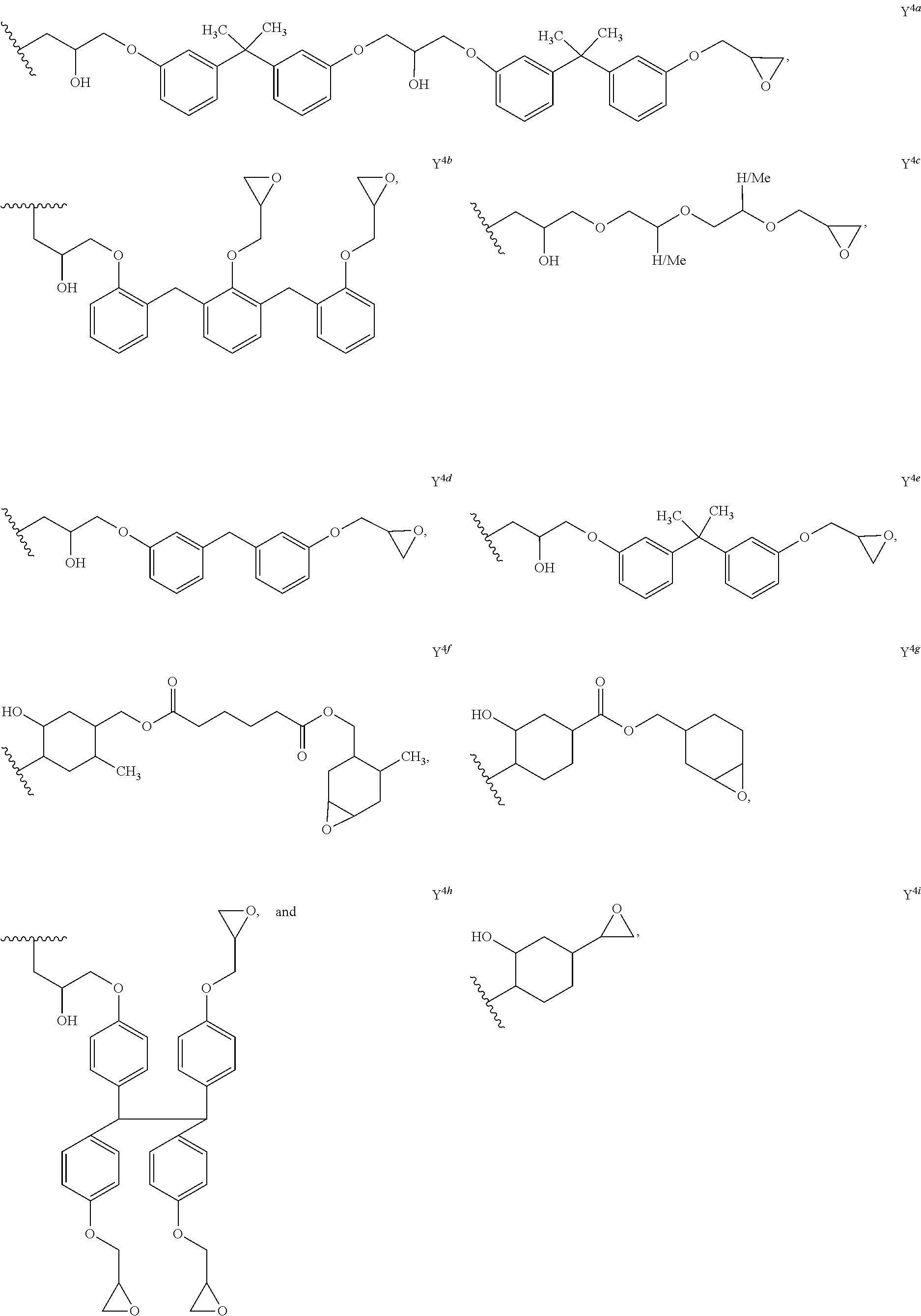

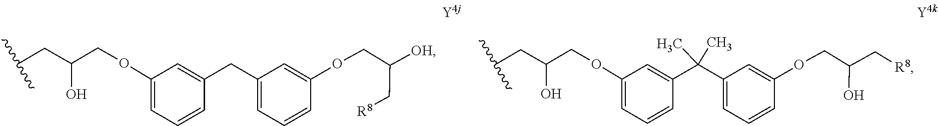

wherein r is an integer from 1 to 100, s is an integer from 1 to 15 and t is an integer from 1 to 10; and
R⁶ is selected from the group consisting of linear, branched or cyclic, substituted or non-substituted C₁₋₁₈ alkyl, C₂₋₁₈ alkenyl and C₂₋₁₈ alkynyl;
R⁸ is

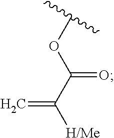

wherein
the degree of polymerization of the Q-type alkoxy-terminated moieties DP_{Q-type} is in the range of 1.3 to 2.7;
the degree of polymerization of the D-type alkoxy-terminated siloxane moieties DP_{D-type} is in the range of 1.0 to 1.9;
the degree of polymerization of the T-type alkoxy-terminated siloxane moieties DP_{T-type} is in the range of 1.1 to 2.7;
the total content of tri-organofunctional M-type siloxane moieties (iii) in the polysiloxane material does not exceed 5 mol-%, optionally does not exceed 5 mol-%;
the total content of di-organofunctional D-type siloxane moieties (iii) in the polysiloxane material does not exceed 5, 10, 20, 30, 35 or 50 mol-%;
the material has a viscosity in the range of about 5 to 100,000 cP, optionally about 25 to 50,000 cP, optionally about 5 to 1,000 cP;
the material comprises about 0.5 to 15 mol-% silanol groups (Si—OH);
the atomic ratio of T- to Q-species in the material is in the range of 0.01:1 to 1:1;
the atomic ratio of D- to Q-species in the material is in the range of 0.01:1 to 0.5:1;
0 mol-% or at least 1 mol-%, optionally at least 3 mol-%, optionally at least 5 mol-% optionally at least 7 mol-% of all R⁵ moieties in the material are R^{5S} moieties; and
0 mol-% or at most 2 mol-%, optionally at most 4 or 10 mol-% of all R¹ moieties in the material are R³ moieties.

Optionally, if 0 mol-% of all R⁵ moieties in the material are R^{5S} moieties, then at least 0.05 mol-%, then optionally at least 0.15 mol-%, optionally at least 0.4 mol-%, optionally at least 1 mol-% of all R¹ moieties in the material are R³ moieties, and/or at least 0.1 mol-%, optionally at least 0.3 mol-% of all R¹ moieties in the material are R^{1′} moieties.

It was surprisingly found that the material described herein provides a new class of multifunctional dendritic polymer precursors relevant for the polymer raw materials industry with tailorable chemistry, in particular, the combination of polysiloxane backbones with peripherally grafted Y functional polymer chemistries (Y¹=acrylates, Y²=isocyanates, Y³=anhydrides, Y⁴=epoxies) and the option to further graft R^{1′} polyols and R³ silane terminated polymers (STPs) which are coupled or catalyzed through R⁵ amine substituents. These materials represent a new class of raw materials which have utility, e.g., for use in coatings, adhesives, sealant and elastomers and the polymer processing industry, for example because they are polyfunctional dendritic macromonomers and offer a unique and tailorable spectrum of property enhancements in actual formulations.

The versatility in substitution of, e.g. through amine but also mercapto and glycidoxy residues, in the material described herein with specific and diverse functional groups has the effect that the polymeric liquid material can actively participate in a reactive formulation through more than one specific polymerization mechanism and optionally allow for compatibilization of polymer chemistries which up to date could not be successfully combined in a single system or formulation.

For example, the polymeric liquid polysiloxane material described herein for all aspects can be of a core-shell structure, wherein the core is composed of a majority of Q-type moieties and has a different composition than the shell, which is composed primarily of T- and/or D-type moieties, and optionally further comprises M-type moieties. Herein, the core is also referred to as the “precursor (material)”. Alternatively, the polymeric liquid material can also comprise a “core-only” material, meaning that there is no shell and that Q-, T- and/or D-type moieties are essentially randomly distributed within said core. The term “core-shell”, as used herein, is commonly understood in the art (see, e.g., Nanoscale, 2010, 2, 829-843 or Nanoscale, 2011, 3, 5120-5125). Concerning core-shell products, the interface between core and shell must be understood as a diffuse shell rather than a sharp boundary at which composition changes abruptly. This diffuse shell layer architecture, where the concentration of the functional shell species varies over a few bond lengths or Angströms, is a direct result of the condensation chemistry, that is, the grafting of a functional silane shell onto a preformed polysiloxane core. Because the outer arms of the dendritic polysiloxane core are highly permeable to smaller silane monomers and oligomers, it is clear that the extent of grafting of the shell is highest on the periphery but there is no sharp cutoff. Nevertheless, the term core-shell still applies as grafting in the center of the core is highly hindered for both, steric reasons and reduced availability of reactive alkoxy groups, because the average connectivity (number of bridging oxygen linkages (Si—O—Si bonds) per silicon center) in the center of the core is higher than at the core perimeter. Consequently, the term core-shell will be used in the context of polymeric liquid materials in the sense of a polysiloxane core with a diffuse shell as described herein.

For example, a typical material according to the present invention may also comprise Q-, T-, D- and/or M-type silane monomers (Q⁰, T⁰, D⁰, M⁰), e.g. in smaller molar quantities compared to the Qⁿ, Tⁿ, Dⁿ and Mⁿ, with n≥1, moieties, in other words, the total molar siloxane content must be higher than the total molar silane monomer content, excluding hexamethyldisiloxane (HMDSO) which may be present in any amounts, also as a monomer, e.g. also as a solvent or co-solvent in a material comprising the liquid polysiloxane material described herein. Similarly, a material comprising the liquid polysiloxane material described herein may optionally contain substantial fractions of smaller oligomers, for example a mixture of oligomers that spans a range from, e.g. dimer to pentamer polysiloxanes, optionally also featuring mixed Q-T and/or Q-D bonding modes.

The material of the present invention comprises at least one of (ii) di-organofunctional D-type siloxane moieties and (iv) mono-organofunctional T-type siloxane moieties, which means that the material can comprise (a) di-organofunctional D-type siloxane moieties but essentially no mono-organofunctional T-type siloxane moieties, (b) mono-organofunctional T-type siloxanes but essentially no di-organofunctional D-type siloxane moieties or (c) a combination of di-organofunctional D-type siloxane moieties and mono-organofunctional T-type siloxane moieties featuring unfunctionalized R^{5U} and/or functionalized R^{5S} residues. Comprising essentially no D- or T-type siloxane moieties means that the siloxane moieties cannot be detected by standard techniques (e.g. NMR, e.g. ²⁹Si-NMR) and/or that less than 1 mol-% of such siloxane moieties is present.

In a disclosure, the material of the present invention comprises mono-organofunctional T-type siloxane moieties and optionally di-organofunctional D-type siloxane moieties or no di-organofunctional D-type siloxane moieties.

The material of the present invention comprises 0.5 to 15 mol-%, silanol groups (Si—OH) this means that the OR¹ residues of Q-, T- or D-type Si atoms are —OH groups to this extent. Optionally, the material of the present invention comprises 0 to 15 mol-%, silanol groups (Si—OH).

All mol-% numbers described herein—unless specifically mentioned otherwise—are defined by the sum of all D-, M- or T-type silicon atoms, respectively, divided by the sum of all silicon atoms in the material, e.g. as measured by means of quantitative ²⁹Si-NMR.

The polymeric liquid polysiloxane material described herein is optionally R^{5S}-functionalized, i.e. 0 or at least 1 mol-%, optionally at least 3 mol-%, optionally at least 5 mol-% optionally at least 7 mol-% of all R⁵ moieties in the material are R^{5S} moieties, wherein R^{5S} is considered a functionalized moiety. The R^{5S}-functionalization may be introduced into the polysiloxane material by either selecting T- and/or D-type silane or siloxane moieties which are already R^{5S}-functionalized (i.e. are pre-R^{5S}-functionalized T⁰/D⁰ or T-/D-type oligomer precursors used for rearrangement grafting) for the manufacture of the polysiloxane material, i.e. T-/D-type monomer or oligomer compounds which comprise R^{5S} moieties, e.g. to the extent as defined herein, or alternatively to a lesser extent, i.e. less than 1 mol-%. If the T-/D-type siloxane or silane moieties in a material otherwise corresponding to that disclosed herein comprise no or less than 1 mol-% R^{5S} (relative to the total mole number of R⁵ T-/D-type substituents), the T-/D-type siloxane moieties can be R^{5S}-functionalized either by functionalizing R^{5U} on already grafted T-/D-type siloxane moieties or by grafting further, pre-R^{5S}-functionalized T-/D-type silane monomers or oligomers comprising R^{5S} moieties. The functionalization of R^{5U} moieties can be done by known chemical methods and is described in the context of the present method. It is noted that the R^{5S}-functionalization, as described herein, is a specific form of functionalization, whereas the general term “organofunctional (T- or D-type) silane or siloxane (moiety)” refers to a silane/siloxane (moiety) generally bearing an organic residue directly bound to the silicon atom via an Si—C bond. Optionally for all aspects and embodiments described herein, 0 mol-% of all R⁵ moieties in the material are R^{5S} moieties.

In analogy to R⁵, R¹ can be a functionalized residue which means that R¹ is selected from R^{1′} and R³. 0 mol-% or at most 2 mol-% of all R¹ moieties in the material are R³ moieties. Optionally, 0 mol-% or at most 50 mol-% of all R¹ moieties in the material are R^{1′} moieties. The explanations outlined above in the context of R⁵ apply mutatis mutandis to R¹ being R³ and optionally R^{1′}.

The functionalization of R⁵ and/or R¹ can be identified and quantified by known spectroscopic means, e.g. by nuclear magnetic resonance spectroscopy, e.g. by ¹H—, ¹³C—, and optionally ¹⁵N-NMR, optionally with isotope enrichment for analytical verification of these functionalization reactions. Specifically, during these types of organic reactions, e.g. addition or substitution reactions, proton and carbon signatures experience a shift in their NMR response due to the change in electronic structure and structural environment and its resulting impact on the magnetic couplings. Typically, a signature from a proton or group of protons or carbon(s) will disappear when such an organic reaction takes place and a new peak appears further up or downfield in the spectrum depending on how the functionalization reaction impacted the magnetic couplings of these species in question. Thus, both the disappearance of the old chemical signature and the appearance of the new signature can be followed quantitatively with NMR spectroscopy. Quantitative reaction monitoring of organic reactions by ¹H and ¹³C NMR is common general knowledge and does not need further description.

R^{1′} can be selected from polyols,
optionally low molecular linear or branched polyols, e.g. ethylene glycol, propylene glycol, butanediol, pentanediol, hexanediol, glycerol, pentaerythritol, or oligosaccharides;
polyether polyols, e.g. linear and (e.g. lightly) branched homo-, hetero- and also block copolymers of ethylene oxide, propylene oxide, butylene oxide (poly-THF) or ε-caprolactam with telechelic OH groups;
polyester polyols, e.g. polyols based on polyesters made from low molecular dicarboxylic acids, dicarboxylic acid chlorides or anhydrides and low molecular linear and branched polyols from the list above. Exemplary carboxylic diacids and anhydrides include, e.g., adipic acid, phthalic acid, maleic acid, terephthalic acid, isophthalic acid or other aliphatic and/or aromatic di-carboxylic acids. For example, these polyester polyols may be decorated with telechelic OH groups for example by terminal esterification with diols;
acrylic polyols, e.g. polyols based on copolymers of acrylates with styrene, copolymers of ethyl-, butyl-acrylate, acrylic acid, and hydroxyl-bearing acrylic monomers such as, e.g., 2-hydroxyethyl acrylates or 4-hydroxybutyl acrylates; or acrylate polyols obtainable by partial or complete esterification of acrylic acid end groups with low-molecular diols;
polycarbonate polyols, e.g. polyols made from the copolymerization of low molecular linear or branched aliphatic polyols with carbon dioxide, dimethyl carbonate or phosgene; cyclic variants thereof, e.g. when derived from oxiranes; or aromatic variants thereof, e.g. when derived from aromatic diols such as, e.g., bisphenol A or bisphenol F;
natural oil based polyols, e.g. castor oil, soy bean oil, peanut oil, canola oil or palm oil. Introduction of non-existing or additional —OH groups into these oils, e.g. to increase the functionality of the polyol may be done through postprocessing and the products thereof are encompassed for use in the present invention. For example, the double bond of a natural oil based polyol may be oxidized (e.g. with ozone, epoxidation) and then hydrolyzed with a base or esterified with low-molecular diols;

For R^{1′}, also combinations of the above noted polyols, polyether polyols, polyester polyols, acrylic polyols, polycarbonate polyols and natural oil based polyols can be selected. For example, polyether terminated polyesters can be selected, or block copolymers involving polyether terminated polyesters, polyamides, polycarbonates or the like. Furthermore, polyols for use herein may also feature specifically introduced carboxylic acid functionalities which provide other application advantages such as, e.g., adhesion improvement.

In the context of the material described herein, if R^{1′} is a polyol residue, said polyol is bonded to the siloxane moiety through an Si—O—C bond. This bonding mechanism is confirmed, e.g. through the release of the corresponding R¹ alcohol during its preparation (condensation of the polyol with the polyethoxysiloxane material). The skilled person is aware that the attachment of, e.g., a linear diol to the polysiloxane material will effectively lead to R^{1′} being a “mono-ol” residue because one of the alcohol functionalities forms the Si—O—C ether coupling bond. In other words, the term polyol as used herein in the context of R^{1′} also includes diol reactants that form a “mono-ol” residue once bound to the polysiloxane material. With multiple such groups being grafted onto a polymeric liquid polysiloxane material, still a multifunctional “dendritic” macro-polyol is obtained.

Also, in all aspects and embodiments disclosed herein, the material may comprise polyols, e.g. those described for the R^{1′} residue, and/or “silane terminated polymer” (STP) molecules, e.g. those described for R³, which are not covalently bonded to the polysiloxane material. For example, the material described herein may comprise STPs of which the terminal silane units are not covalently bonded through siloxane bonds which means that means that these STPs exist as “free” T⁰, D⁰ terminal STP molecules in the mixture, e.g. depending on the stoichiometry used during the preparation of the material described herein. The same argument applies to R^{1′} polyols in a mixture comprising a polymeric liquid material.

In the context of the present invention, the term “low molecular” is to be understood, e.g., as linear or branched polyols, polyether polyols, polyester polyols, acrylic polyols, polycarbonate polyols comprising 2 to 10, optionally 2 to 6 carbon atoms. Low molecular natural oil based polyols are optionally those with molecular weights between 200 and 2000 g/mol.

In the context of the present invention, 0 mol-% or at most 2 mol-% of all R¹ moieties in the material are R³ moieties. R³ moieties as defined herein are silane terminated polymers (STP), e.g. as defined in the structures of the R³ residues above, bonded to the siloxane network by means of Si—O—Si ether linkages between the polysiloxane backbone and the silane terminating Q-, T- and/or D-type unit chemically attached to the STP. This is shown in the definition of R³, wherein the waved bond at the silica atom shows the covalent bond to the oxygen depicted in the formulae of the Q-, D- and/or T-type moiety

STP are known in the art and to the skilled person and there are various known types of chemistries, morphologies and humidity curing silane end-groups. Depending, e.g. on the supplier, various linker chemistries are known to connect the polymer (polyether, polyurethane) backbone onto the alkyl spacer attached to the silane terminal silyl unit, namely direct coupling through an ether linkage, coupling via a single urethane bond or coupling with a diisocyanate through a urethane and a urea bond. All three variants can be coupled to the polysiloxane backbone through grafting in the presence of R^{5U} substituted T-type moieties which generally catalyze said grafting reaction.

In the context of the present invention, the notation of “co”, e.g. in -(L¹)ₘ₁-[(L¹)ₘ₂-R^{4′}]ₘ₃-co-[(L²)ₘ₂-R^{4′}]ₘ₄-co-[(L³)ₘ₂-R^{4′}-]ₘ₅-(L¹)ₘ₁-, and -(L²)ₘ₁-[(L¹)ₘ₂-R^{4′}]ₘ₃-co-[(L²)ₘ₂- R^{4′}]ₘ₄-co-[(L³)ₘ₂-R^{4′}-]ₘ₅-(L¹)^{m1}, is to be understood as defined in IUPAC nomenclature, meaning that the monomers within the square brackets (marked bold in the above) are randomly distributed within the polymer, i.e. there is an unspecified sequence of monomers in the polymer. Optionally, the distribution of the monomers can be alternating or statistical.

The term “in monomeric, uretdione, biuret or tri-isocyanurate form” means that the depicted chemical entities from which R^{4′} is chosen may be in their monomeric form, i.e. correspond to the entity depicted, in their uretdione form, i.e. in their dimerized form, in their biuret form, i.e. correspond to three or optionally up to five, of the depicted monomers coupled by the diamide formed from isocyanate functionalities, or in their tri-isocyanurate from, i.e. correspond to three of the depicted monomers coupled by a cyclic isocyanurate group formed from isocyanate functionalities.

Generally, the biuret form is as shown below:

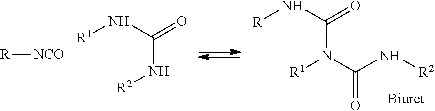

For example, the biuret form of the monomer

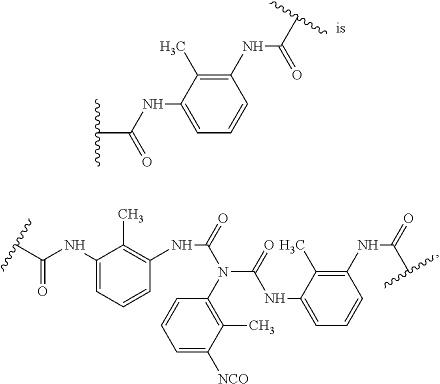

the uretdione form is

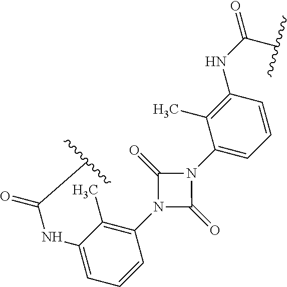 [SMILES: *C(=O)Nc1cccc(N2C(=O)N(c3cccc(NC(*)=O)c3C)C2=O)c1C]

and the corresponding tri-isocyanurate form is

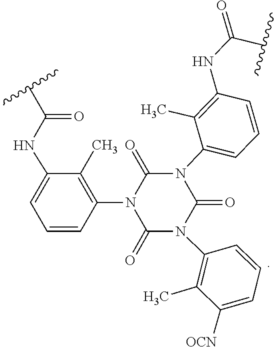

The same definition applies mutatis mutandis to Y².

In the material described herein, the carbonyl of R⁴ being

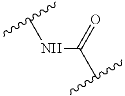 [SMILES: *NC(*)=O]

is attached to a terminal oxygen on the L moiety.

Optionally, in the case of Y^{1g} the integer I of the linker L is from 5 to 20.

The material of the present invention may further comprise at least one of four types of Y-functionalities which are introduced, e.g. by secondary organic modification of R⁵ amine-bearing substituents. Exemplary modification chemistries include but are not limited to:
acrylate modification through reaction with a diacrylate “reactive diluent” coupled by means of an aza-Michael addition (Y¹);
isocyanate modification through reaction with a diisocyanate, triisocyanate or triisocyanurate coupled by means of urea coupling chemistry (Y²);
carboxylic acid or carboxylic anhydride modification through reaction with a carboxylic anhydride coupled by means of amide coupling chemistry (Y³); and/or
epoxide modification through reaction with a di-epoxide or an epoxy-resin coupled by means of epoxide ring-opening chemistry (Y⁴).

Generally, Michael addition reactions are possible for mercapto-functional (—SH bearing) R⁵ groups. Mercapto bearing groups can also react with Y¹ (acrylate bearing) building blocks, e.g. through a thiol-ene reaction.

Another possible modification can be based on glycidoxy or related epoxy-functional R⁵ functional groups and is generally known as epoxy-vinylester chemistry. Specifically, epoxy-groups can be modified/ring-opened with acrylic or methacrylic acid to yield corresponding epoxy-vinylester functional products, bearing acrylate or methacrylate terminal groups.

It is understood that more than one, non-identical Y-functionality from the same or from different groups Y¹ though Y⁴ can be present in one and the same polymeric liquid material described herein, which choice and/or combination of functionalities can give rise to dual-cure or even multi-cure behavior of the material. This means that the polymeric liquid material can actively participate in a reactive formulation through more than one specific polymerization mechanism and optionally allow for compatibilization of polymer chemistries which up to date could not be successfully combined in a single system or formulation.

Grafted R³ STP groups are bonded through at least one siloxane bond to a Q-, T- and/or D-type siloxane in the material as per the definition of R³. These grafted R³ groups are typically introduced into the material by a standard rearrangement grafting protocol with D-type and/or D-type terminated STPs. It is within the purview of the invention that R³ STP groups can also be introduced during the synthesis of the STP material itself, e.g. if said synthesis is carried out in the presence of a majority of monomeric D- and/or T-type silane as well as a minor amount of R^{5U} bearing polymeric liquid material. R⁷ optionally constitutes a covalent bond to another Q-, D- and/or T-type moiety as defined herein in (i), (ii), (iii) and/or (iv). The skilled person understands that depending on the connectivity of R⁷ to the silica atom depicted in the definition of R³, R⁷ is either (a) constitutes an alkoxy group (for R⁷=methyl, ethyl and optionally propyl) or (b) constitutes a siloxane bond to another Q-, D- and/or T-type silicon atom/moiety as defined in (i), (ii), (iii) and/or (iv) and that both bonding modes can occur simultaneously and in any ratio in the material.

The term “non-substituted” or “non-functionalized” as used herein shall mean substituted only with hydrogen or, in the context of R^{5U} that the R^{5U} unit exists as free unsubstituted primary or secondary amine group. The term “substituted” as used herein, e.g. in the context of R⁶ means that any one or more hydrogens on the designated atom or group is replaced, independently, with an atom different from hydrogen, optionally by a halogen, optionally by fluorine, chlorine, bromine, iodine, a thiol, a carboxyl, an acrylato, a cyano, a nitro, an alkyl (optionally C₁-C₁₀), aryl (optionally phenyl, benzyl or benzoyl), an alkoxy group, a sulfonyl group, by a tertiary or quaternary amine or by a selection from the indicated substituents, provided that the designated atom's normal valence is not exceeded, and that the substitution results in a stable compound, i.e., a compound that can be isolated and characterized using conventional means. Optionally, the substitution occurs on the beta position or the omega of the hydrocarbon chain or optionally on the beta or gamma position of the hydrocarbon chain (next or next-next neighboring carbons from substituent attachment carbon). In the case of unsaturated hydrocarbons, the substitution occurs optionally on the beta or omega position of the hydrocarbon chain or optionally on the carbon being part of a double or triple bond or on its directly adjacent carbon.

In the context of R's, the term “substituted” or “functionalized” refers to the presence of at least one Y substituent in R⁵ as shown in the appended claims. Specifically, the bonding modes of substituted R^{5S} on the amine to the various Y families include aza-Michael addition products (Y′), polyurea bonds (Y²), amide bonds (Y³) and amine-epoxy ring opening products (Y⁴). The molar percentage of Y-functionalization referred to herein is defined as the number of effectively Y-functionalized groups divided by the total number of existing (—NH₂, —NH— amine) protons available in the corresponding R^{5U} material before functionalization. In the case of mercapto or glycidoxy R⁵, the quantification is simple as these groups are monofunctional i.e. can only be substituted exactly once for functional group.

In the context of the present invention it is understood that antecedent terms such as “linear or branched”, “substituted or non-substituted” indicate that each one of the subsequent terms is to be interpreted as being modified by said antecedent term. For example, the scope of the term “linear or branched, substituted or non-substituted alkyl, alkenyl, alkynyl” encompasses linear or branched, substituted or non-substituted alkyl; linear or branched, substituted or non-substituted alkenyl; and linear or branched, substituted or non-substituted alkynyl; linear or branched, substituted or non-substituted alkylidene. For example, the term “C₁₋₁₈ alkyl, C₂₋₁₈ alkenyl and C₂₋₁₈ alkynyl” indicates the group of compounds having 1 or 2 to 18 carbons and alkyl, alkenyl or alkynyl functionality.

The expression “alkyl” refers to a saturated, straight-chain or branched hydrocarbon group that contains the number of carbon items indicated, e.g. linear or branched “(C₁₋₁₈)alkyl” denotes a hydrocarbon residue containing from 1 to 18 carbon atoms, e.g. a methyl, ethyl, propyl, iso-propyl, n-butyl, iso-butyl, sec-butyl, tert-butyl, n-pentyl, iso-pentyl, n-hexyl, 2,2-dimethylbutyl, etc.

If an alkyl chain is characterized by a name that allows for linear or branched isomers, all linear or branched isomers are encompassed by that name. For example, “butyl” encompasses n-butyl, iso-butyl, sec-butyl and tert-butyl.

The expression “alkenyl” refers to an at least partially unsaturated, substituted or non-substituted straight-chain or branched hydrocarbon group that contains the number of carbon atoms indicated, e.g. “(C₂₋₁₈)alkenyl” denotes a hydrocarbon residue containing from 2 to 18 carbon atoms, for example an ethenyl (vinyl), propenyl (allyl), iso-propenyl, butenyl, iso-prenyl or hex-2-enyl group, or, for example, a hydrocarbon group comprising a methylene chain interrupted by one double bond as, for example, found in monounsaturated fatty acids or a hydrocarbon group comprising methylene-interrupted polyenes, e.g. hydrocarbon groups comprising two or more of the following structural unit —[CH═CH—CH₂]—, as, for example, found in polyunsaturated fatty acids.

The expression “alkynyl” refers to at least partially unsaturated, substituted or non-substituted straight-chain or branched hydrocarbon groups that may contain, e.g. from 2 to 18 carbon atoms, for example an ethinyl, propinyl, butinyl, acetylenyl, or propargyl group.

The notation

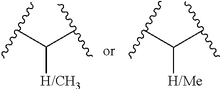

as used herein indicates that either a hydrogen or a methyl group may be attached to the carbon atom.

As used herein, a wording defining the limits of a range of length such as, e. g., “from 1 to 5” or “(C₁₋₅)” means any integer from 1 to 5, i.e. 1, 2, 3, 4 and 5. In other words, any range defined by two integers explicitly mentioned is meant to comprise and disclose any integer defining said limits and any integer comprised in said range.

The scope of the present invention includes those analogs of the compounds as described above and in the claims that feature the exchange of one or more carbon-bonded hydrogens, optionally one or more aromatic carbon-bonded hydrogens, with halogen atoms such as F, Cl, or Br, optionally F.

If a residue or group described herein is characterized in having two further residues of the same name, e.g. in Z² being

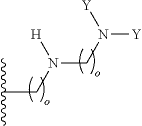

or in Y³ being

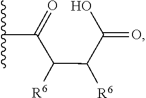

each of these further residues (in these examples Y and R⁶) can be independently selected from the definitions of this residue (in these examples Y and R⁶) given herein.

The skilled person is aware that any combination of residues for forming the material described herein, e.g. for R^{1′}, R³ or R^{5S}, must lead to a stable compound, i.e., a compound that can be isolated and characterized using conventional means. The skilled person can determine from his common general knowledge which compound is not stable and specifically which linker chemistries are possible and do not interfere with other chemical functionalities in the polymeric liquid material. Any combination of residues that would result in a not stable compound is excluded from the scope of the claims.

The degree of polymerization “DP” for any non-crystalline silicon oxide material (for the polysiloxane material and for the corresponding methods and uses described herein) is defined here as the ratio of bridging oxygens “BO” (# of Si—O—Si bonds) to the total number of metal atoms Siₜₒₜ in the system.

The term “alkoxy-terminated” for the Q-, T- and D-type siloxane moieties is understood to refer to the residual substituents of said moieties which are essentially alkoxy groups, because the polymeric liquid material is derived from alkoxy (ethoxy/methoxy/propoxy) containing silane precursors in monomeric or oligomeric form. This implies that for a Q⁰ monomer and Q¹, Q², Q³ and Q⁴ moiety, said “alkoxy termination” is comprised of 4, 3, 2, 1 and 0 alkoxy groups, respectively, and for a T° monomer and T¹, T² and T³ moiety, said “alkoxy termination” is comprised of 3, 2, 1 and 0 alkoxy groups, respectively. Analogously, for a D⁰ monomer and D¹ and D² moiety, said “alkoxy termination” is comprised of 2, 1 and 0 alkoxy groups, respectively.

DP_{Q-type}, DP_{T-type} and DP_{D-type} of the material can be directly obtained from quantitative ²⁹Si-NMR data according to:

$$D {P}_{Q - type} = Σ ( n {A}_{Q n} ) / Σ ( {A}_{Q n} ) = ( {A}_{Q 1} + 2 {A}_{Q 2} + 3 {A}_{Q 3} + 4 {A}_{Q 4} ) / ( {A}_{Q 0} + {A}_{Q 1} + {A}_{Q 2} + {A}_{Q 3} + {A}_{Q 4} ) ;$$

$$D {P}_{T - type} = Σ ( n {A}_{Tn} ) / Σ ( {A}_{T n} ) = ( {A}_{T 1} + 2 {A}_{T 2} + 3 {A}_{T 3} ) / ( {A}_{T 0} + {A}_{T 1} + {A}_{T 2} + {A}_{T 3} ) for general T - type silanes ;$$

$$and {DP}_{D - type} = Σ ( n {A}_{D n} ) / Σ ( {A}_{D n} ) = ( {A}_{D 1} + 2 {A}_{D 2} ) / ( {A}_{D 0} + {A}_{D 1} + {A}_{D 2} ) .$$

In the above equation for DP_{Q-type}, the terms A_{Qn} denote the quantitative ²⁹Si-NMR peak area related to that Qⁿ moiety (spectral signature), which is a Si atom coordinated by n siloxane bonds through bridging oxygen (BO) atoms, that connect it to its next-nearest-neighbor Si atoms and (4-n) non-bridging oxygen (NBO) atoms which are linked to terminal alkoxy groups Si—OR as defined herein. Analogously, A_{Tn} and A_{Dn} denote the ²⁹Si-NMR peak areas corresponding to the respective T-type and D-type moieties (spectral signatures).

For the above definition of DP, Q² and Q³ refer to all types of Q² and Q³ species, including linear and single ring as well as double ring species. During grafting of a Q-type precursor (see FIG. 5a), Q² and Q³-type tetrasiloxane ring species (Q^{2r}, Q^{3s}, Q^{3d}) are reduced which is an intrinsic feature of the rearrangement grafting mechanism (see FIG. 5b) and more linear species (Q^{2l}, Q^{3l}) are formed.

For organofunctional T type tri- and D-type di-alkoxysilanes, the ²⁹Si spectral fingerprint regions are shifted progressively further downfield allowing a clear separation of the different non-organofunctional Qⁿ from organofunctional T^{m} moieties as seen in FIG. 5b. FIG. 5b shows a ²⁹Si NMR spectrum of an R^{5U} T-type grafted material containing T and Q-Type moieties in one material with the respective labelling.

Optionally, the molar number of ethoxy terminating units (—OCH₂CH₃) in the material described herein is at least twice the number of methoxy terminating units (—OCH₃) and the material is essentially free of propoxy terminating units (—OCH₂CH₂CH₃), e.g. less than 3% of all alkoxy terminating units are propoxy terminating units.

Optionally, the molar number of methoxy terminating units (—OCH₃) in the material described herein is at least twice the number of ethoxy terminating units (—OCH₂CH₃) and the material is essentially free of propoxy terminating units (—OCH₂CH₂CH₃), e.g. less than 3% of all alkoxy terminating units are propoxy terminating units.

For any polymeric liquid material described herein, there exist different modes of interconnections, namely i) siloxane bonds with two Q-type partners (Q-Q homocondensation), ii) siloxane bonds with two T-type partners (T-T homocondensation), iii) siloxane bonds with two D-type partners (D-D homocondensation), and iii) Siloxane bonds with non-identical partners (Q-T, Q-D, T-D, Q-M, T-M, D-M heterocondensation).

The concept of heterocondensation applies to bonding states of both, statistical mixtures in core-only as well as in core-shell materials, respectively, and is exemplified in the equation below for Q-T-type siloxane bonding:

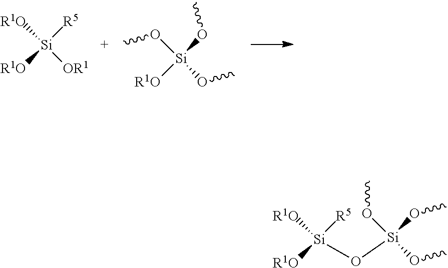

In the above example of a Q-T heterocondensation, the organofunctional trialkoxysilane is converted from T⁰ to T¹ while the Q-type alkoxysilane on the left-hand side of the reaction (symbolized by the three wavy siloxane bonds) from Q³ to Q⁴, illustrating that each siloxane bond formed simultaneously increases DP_{Q-type} and DP_{T-type}. There are obviously all sorts of other combinations of possible grafting reactions e.g. a T² species grafting onto a Q² yielding T³ and Q³, respectively, or T¹ species grafting onto a Q² yielding T² and Q³ and similar combinations involving D-Type dialkoxysiloxane moieties. Grafting reactions typically require a condensation reagent such as water (hydrolytic condensation) or for example acetic anhydride (non-hydrolytic condensation). Optionally grafting reactions are carried out in the absence of such a condensation reagent.

DP_{Q-type}, DP_{T-type} and DP_{D-type} are the primary parameters that define the polymeric liquid material described herein, together with the atomic ratio of T- and/or D-type to Q-type and, optionally, the total molar content of D-type species in the material. These parameters can all be determined from quantitative ²⁹Si-NMR spectroscopy data.

Generally, parameters that define the polymeric liquid material described herein can be measured using standard analytical tools: The content of hydroxy groups in the material can be determined, e.g., using ²⁹Si- and/or ¹H-NMR spectroscopy and Karl Fischer titration. The molar ratio of ethoxy and methoxy terminal alkoxy units in the material are directly accessible from ¹³C-NMR and independently from ²⁹Si-NMR data. The characterization of the reaction products in terms of viscosity is readily analyzed by means of standardized viscosity measurements such as a cylindrical rotation viscometer according to, e.g., ASTM E2975-15: “Standard Test Method for Calibration of Concentric Cylinder Rotational Viscometers”. Other viscosity test methods are also possible such as, e.g., Staudinger-type capillary viscometers or modern, dynamic viscometry methods. The sample preparation is generally relevant in determining the true viscosity of the polymeric liquid material as already low percentage amounts of monomers and/or solvent residues significantly impact the measured values. For this purpose, a viscosity measurement is typically done on a polymeric sample material, i.e. a material essentially consisting of a polymeric material, which has previously been purified. Purification can be done, e.g. by means of a thin film evaporator setup at, e.g. 150° C., with a vacuum, e.g. <10⁻¹ mbar, which separates monomers and low molecular oligomers from the polymeric liquid material itself (see Macromolecules 2006, 39, 5, 1701-1708).

In a disclosure, the polymeric liquid polysiloxane material of the present invention is one, wherein R⁵ is selected from R² for the di-organofunctional D-type siloxane moieties as described herein.

In a disclosure, the polymeric liquid polysiloxane material of the present invention is one, wherein Y¹ⁿ is

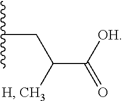

In an embodiment of said disclosure, a polysiloxane material comprises both

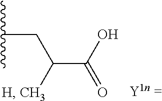

and R³ functionalization combined in one material.

In a disclosure, the polymeric liquid polysiloxane material of the present invention is one, wherein Y¹ is selected from the group consisting of

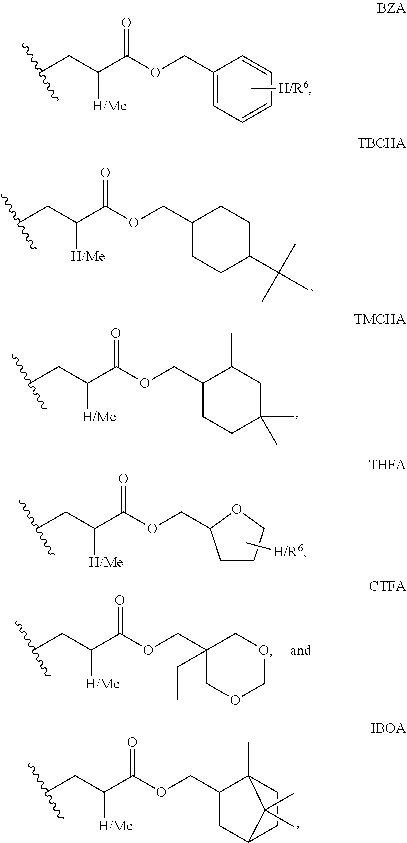

wherein R⁶ is selected from the group consisting of linear, branched or cyclic, substituted or non-substituted C₁₋₁₈ alkyl, C₂₋₁₈ alkenyl and C₂₋₁₈ alkynyl.

In another embodiment, the polymeric liquid polysiloxane material of the present invention is one, wherein
the polysiloxane material comprises less than 45, optionally less than 37, optionally less than 30 or less than 25 mol-% four-membered combined Q^{2r}-type and Q^{3s,d}-type siloxane ring species relative to the total Q-type siloxane species; and/or
the polysiloxane material comprises less than 70, optionally less than 63, optionally less than 56 or less than 50 mol-% four-membered combined Q^{3s,3d}-type siloxane ring species relative to all Q³-type siloxane species; and/or
the polysiloxane material comprises less than 4.5, optionally less than 4.0, optionally less than 3.5 or less than 3.0 mol-% double four-membered Q^{3d}-type siloxane ring species relative to the total Q-type siloxane species; and/or
the polysiloxane material comprises less than 25, optionally less than 20, optionally less than 17 or less than 14 mol-% double four-membered Q^{3d}-type siloxane ring species relative to all Q³-type siloxane species.

The polysiloxane materials described herein comprising low number of four-membered Q^{2r}-type and/or Q^{3s,d}-type siloxane ring species are highly dendritic linear and liquid species

The material described herein comprising low ring species content can be prepared, e.g. by using a rearrangement catalyst as described herein, without the need for any active condensation reagents such as acetic anhydride. The M-, D- and/or T-type silanes react with the Q-type precursor or core material in a nucleophilic substitution/condensation (“rearrangement”) reaction. Without wishing to be bound by theory, it is believed that one of the driving forces for this substitution reaction (also called “grafting”) results from the ring strain of four-membered Q^{2r}-type and/or Q^{3s,d}-type siloxane ring species in the Q-type precursor material used for preparing the polysiloxane materials described herein. The release of ring tension in the Q-type core material is sufficient for efficiently adding, i.e. grafting, M-, D- and/or T-type silanes onto the Q-type core material without the need for further chemical reagents such as acetic anhydride and, if the reaction time can be extended considerably, essentially also without the need for a rearrangement catalyst as defined herein. An exemplary structural formula (2D representation) of such a core material is shown in FIG. 2, where unspecified R¹ alkoxy ligands are shown and which will depend on the relative abundance of the monomer or oligomer Q-type starting materials (methoxy, ethoxy, propoxy) used in the respective precursor preparation. The precursor material shown in FIG. 2 was chosen to represent a general case and also comprises organofunctional T- and D-type moieties functionalities and some silanol groups.

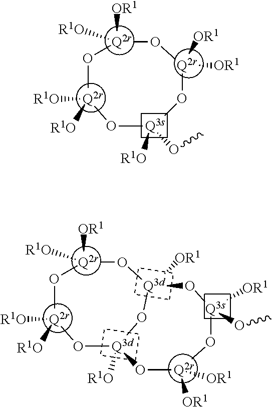

The term “four-membered” ring or polysiloxane ring or Q-type ring species as referred to herein always refers to an ensemble of all Q^{2r} and Q^{3s,d}-type moieties comprised in the material which are part of a four membered polysiloxane ring structure. Two representative examples of such typical configurations of moieties in single and double four-membered ring structures are shown in the above formulas. Q^{2r} ring moieties occur in both, “single” and “double” ring structures and comprise two siloxane bonds on each Q^{2r} which are both part of the ring structure and two alkoxy group (—OR¹) substituents. In the example on the left of a single four-membered siloxane ring, only Q^{2r} ring (circle) and “single ring” Q^{3s} (square) species are possible. In the second example of two connected four-membered siloxane rings (a bi-cyclic structure) shown on the right, in addition to Q^{2r} ring species (circle) and “single ring” Q^{3s} (square) species, also “double ring” Q^{3d} (rectangle, dashed line) moieties are possible, which are located at the bridge sites connecting the two rings. It is noted that in these Q^{3d} species, all siloxane bonds are part of the double ring network. Also, it is noted that the wiggly lines on the oxygen atoms connected to Q^{3s} moieties represent a siloxane bond to any other possible Qⁿ, Tⁿ, Dⁿ or Mⁿ moiety with n≥=1. It must further be understood, that in the above examples for typical configurations, moieties are of Q-type but that these are only examples for assisting the skilled person's understanding but in reality there is no restriction to Q-type moieties. In fact it is within the scope of this disclosure and very much expected that in such four-membered polysiloxane ring structures also T-type and/or D-type moieties will be present.

Herein, Q² species in any four membered siloxane ring structures are termed “Q^{2r}” and “Q³” species in single ring structures and in double ring structures are termed “Q^{3s}” and “Q^{3d}”, respectively.

For quantification purposes, there are different indicators that can be used to define or constrict the above mentioned four membered polysiloxane ring species. A first indicator is to be defined as the total number of Q^{2r} and Q^{3s,d} ring species over the total Q species in the material:

$$\begin{matrix}\% ( {Q}^{2 r} \& {Q}^{3 s , d} ) ring species = 100 \cdot Σ ( {A}_{Q 2 rings} + {A}_{Q 3 rings} ) / Σ ( {A}_{Q n} ) \\ = 100 \cdot ( {A}_{Q 2 r} + {A}_{Q 3 s} + {A}_{Q 3 r} ) / \\ ( {A}_{Q 0} + {A}_{Q 1} + {A}_{Q 2} + {A}_{Q 3} + {A}_{Q 4} )\end{matrix} ;$$

A second indicator is to be defined as the total number of Q^{3s,d} ring species over all Q³ species in the material:

$$\begin{matrix}\% ( {Q}^{3 s , d} ) ring species within {Q}^{3} = 100 \cdot Σ ( {A}_{Q 3 rings} ) / {A}_{Q 3} \\ = 100 \cdot ( {A}_{Q 3 s} + {A}_{Q 3 d} ) / {A}_{Q 3} = \\ 100 ( 1 - ( {A}_{Q 31} / {A}_{Q 3} ) )\end{matrix}$$

A third indicator is to be defined as the total number of Q^{3d} ring species over the total Q species in the material:

$$\begin{matrix}\% ( {Q}^{3 d} ) ring species = 100 \cdot {A}_{Q 3 d} / Σ ( {A}_{Q n} ) \\ = 100 \cdot {A}_{Q 3 d} / ( {A}_{Q 0} + {A}_{Q 1} + {A}_{Q 2} + {A}_{Q 3} + {A}_{Q 4} )\end{matrix} ;$$

A fourth indicator is to be defined as the total number of Q^{3d} ring species over all Q³ species in the material:

$$\% ( {Q}^{3 d} ) ring species within {Q}^{3} = 100 \cdot {A}_{Q 3 d} / {A}_{Q 3} ;$$

The variable A is the spectral peak area as defined further below.

The mol-% of four-membered Q²-type and/or Q³-type siloxane ring species relative to the total Q-type siloxane species can be determined by ²⁹Si-NMR analysis, as demonstrated below in the examples. The polysiloxane material described herein comprises less than the stated mol-% four-membered (Q^{2r}& Q^{3s,d}) and/or (Q^{2r}) and/or (Q^{3s} single) and/or (Q^{3d} double) ring species relative to the total Q-type siloxane species. This means that the material comprises either less than the stated mol-% four-membered Q^{2r}-type siloxane ring species, less than the stated mol-% four-membered Q^{3s,d}-type siloxane ring species and/or less than the stated mol-% four-membered Q^{2r}-type and Q^{3s,d}-type siloxane ring species, cumulatively. For all embodiments described herein, the four-membered Q^{3s,d}-type siloxane ring species includes Q^{3s,d}-type siloxane species, wherein one Q^{3s,d}-type siloxane is part of one or two four-membered rings.

The atomic ratio of T- and/or D-type to Q-type species in the material is the ratio between the silicon atoms of all T-type species (T⁰, T¹, T² and T³) and/or D-type species (D⁰, D¹ and D²) and the silicon atoms of all Q-type species (Q⁰, Q¹, Q², Q³ and Q⁴).

In a further embodiment, the polymeric liquid hyperbranched polysiloxane material according to the present invention is one, wherein (a) less than 15 mol-%, optionally less than 10, 7, 4 or 2 mol-% of all R¹ substituents are R^{1′} substituents and/or (b) the material only comprises mono-organofunctional T-type siloxanes and essentially no di-organofunctional D-type siloxanes.

In a further embodiment, the polymeric liquid hyperbranched polysiloxane material according to the present invention is one, wherein the material comprises about 0 or 0.5 to 7 or about 0.2 to 7 mol-% silanol groups (Si—OH).

In a further embodiment, the polymeric liquid hyperbranched polysiloxane material according to the present invention is one, wherein at least 1 mol-%, optionally at least 3 mol-%, optionally at least 5 mol-% optionally at least 7 mol-% of all R⁵ moieties in the material are R^{5S} moieties, wherein at least 0.05 mol-%, optionally at least 0.15 mol-%, optionally at least 0.4 mol-%, optionally at least 1 mol-% of all R¹ moieties in the material are R³ moieties, and/or wherein at least 0.1 mol-%, optionally at least 0.3 mol-% of all R¹ moieties in the material are R^{1′} moieties.

In a further embodiment, the polymeric liquid hyperbranched polysiloxane material according to the present invention is one, wherein
R¹ is methyl, ethyl, R^{1′} and R³;
R^{1′} is a polyol with at least one terminal —OH group, and optionally comprising one or more carboxyl groups,
   optionally R^{1′} is selected from the group consisting of
      ethylene glycol, propylene glycol, glycerol, pentaerythritol, trimethylolpropane;
      linear or branched polyethyleneglycol or poylpropylene glycol or poly(co-ethylene/propylene glycol) copolymer polyols with a molecular weight between 200 and 30,000 g/mol;
      linear polyamid polyols with a molecular weight between 500 and 10,000 g/mol, comprising diamine and/or triamine units having 7 or less carbon atoms and di-carboxylic acid units having 10 or less carbon atoms;
      linear polyester polyols with a molecular weight between 500 and 10,000 g/mol, comprising diol and/or triol units having 7 or less carbon atoms and di-carboxylic acid or anhydride units having of 10 or less carbon atoms;
      branched acrylic polyols with a molecular weight between 300 and 5,000 g/mol, comprising at least one of hydroxyethyl methacrylate, hydroxy butylacrylate, or hydroxyethyl acrylate units and optionally one or more styrene units;
      linear acrylic polyols with a molecular weight between 300 and 5,000 g/mol comprising acrylate and optionally styrene units;
      linear or branched polycarbonate polyols with a molecular weight between 500 and 50,000 g/mol comprising diol, triol and/or tetraol units having 13 or less carbon atoms; and
      natural oil-based polyols with a molecular weight between 200 and 2,000 g/mol;
R³ is selected from the group consisting of:

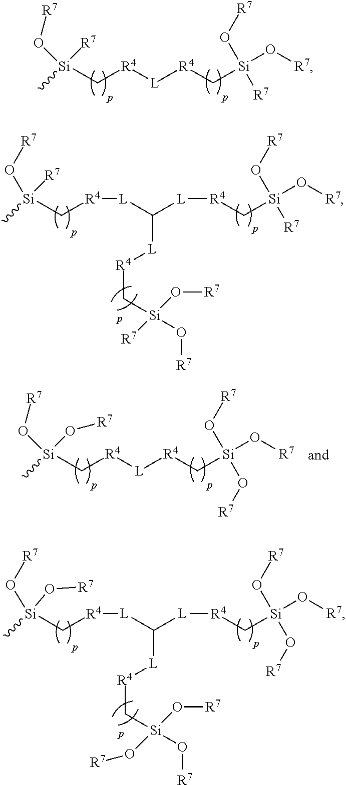

wherein p is an integer from 1 to 3;
R⁷ is methyl or ethyl;
L is selected from the group consisting of L′,

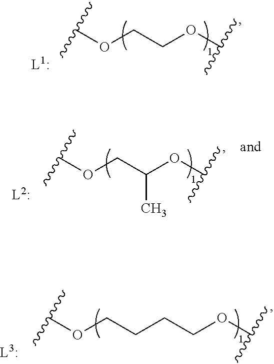

L′ is selected from the group consisting of
   -(L¹)ₘ₁-[(L¹)ₘ₂-R^{4′}]ₘ₃-co-[(L²)ₘ₂-R^{4′}]ₘ₄-co-[(L³)ₘ₂-R^{4′}-]ₘ₅-(L¹)ₘ₁-, and
   -(L²)ₘ₁-[(L¹)ₘ₂-R^{4′}]ₘ₃-co-[(L²)ₘ₂-R^{4′}]ₘ₄-co-[(L³)ₘ₂-R^{4′}-]ₘ₅-(L¹)ₘ₁-,
   wherein L′ is about or less than 30,000 g/mol, and
   wherein m1 is an integer from 0 to 10, m2 is an integer from 10 to 150, and m3, m4 and m5 are each independently integers from 0 to 6, with the proviso that at least one of m3 to m5 is not 0;
R^{4′} is selected from the group consisting of:

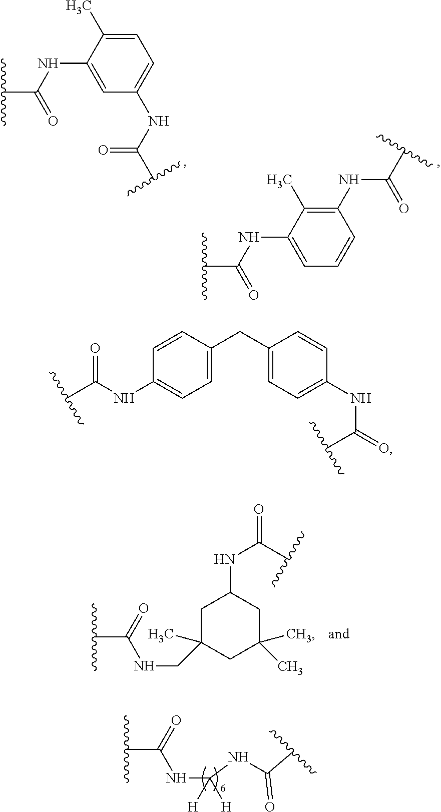

in monomeric, uretdione, biuret or tri-isocyanurate form;
R⁴ is absent, selected from a group defined for R^{4′} or

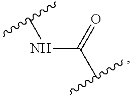 [SMILES: *NC(*)=O]

wherein the carbonyl is attached to the L moiety;
R^{5U} is

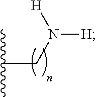

Z¹ is

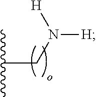

R^{5S} is selected from the group consisting of

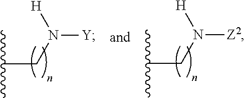

wherein n is an integer from 1 to 3;
Z² is selected from the group consisting of

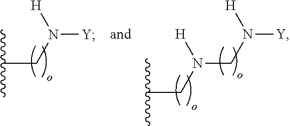

wherein o is an integer from 2 to 3; and
Y is independently selected from the group consisting of Y¹, Y², —R^{4′}-L-Y², Y³ and Y⁴, wherein
Y¹ is selected from the group consisting of

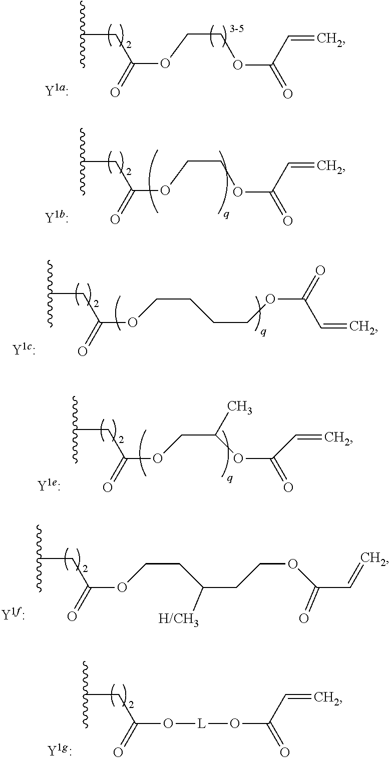

wherein L is L¹ or L², and q is an integer from 1 to 4,

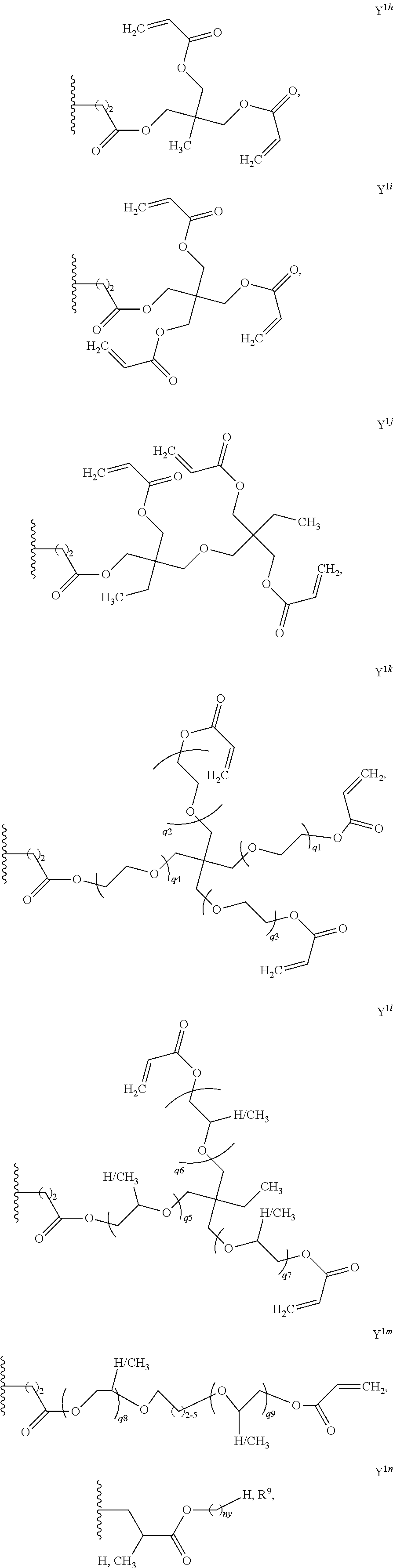

wherein ny is an integer from 0 to 4,

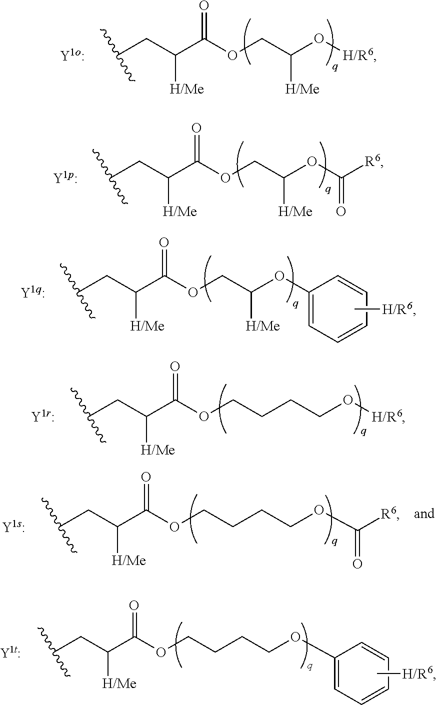

wherein R⁹ is selected from the group consisting of

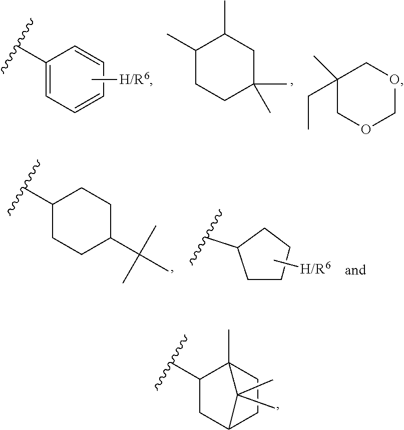

wherein each of q1 to q4 are integers from 0 to 8 and the sum of (q1+q2+q3+q4) is from 4 to 8,
wherein each of q5 to q7 are integers from 0 to 12 and the sum of (q5+q6+q7) is from 3 to 12, and
wherein each of q8 and q9 are integers from 0 to 4 and the sum of (q8+q9) is from 2 to 4,
optionally Y¹ is Y¹ⁿ and Y¹ⁿ is

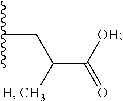

Y² is selected from the group consisting of

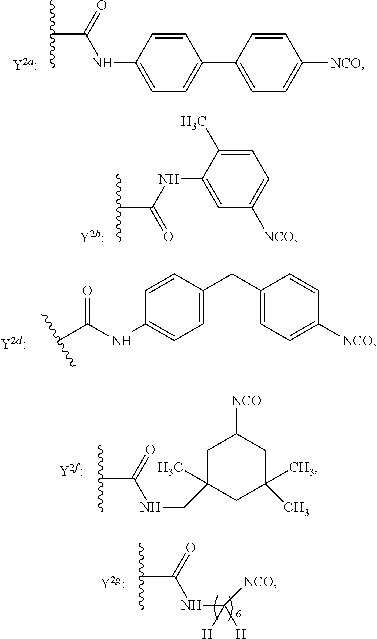

in monomeric, uretdione, biuret or tri-isocyanurate form;
Y³ is selected from the group consisting of

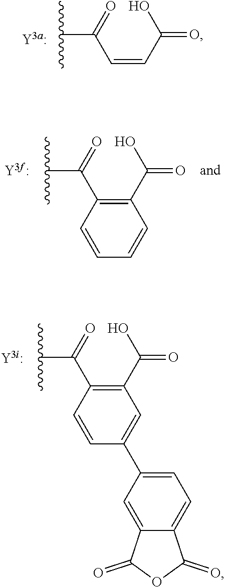 [SMILES: *C(=O)/C=C\C(=O)O ; *C(=O)c1ccccc1C(=O)O ; *C(=O)c1ccc(-c2ccc3c(c2)C(=O)OC3=O)cc1C(=O)O]

and
Y⁴ is selected from the group consisting of

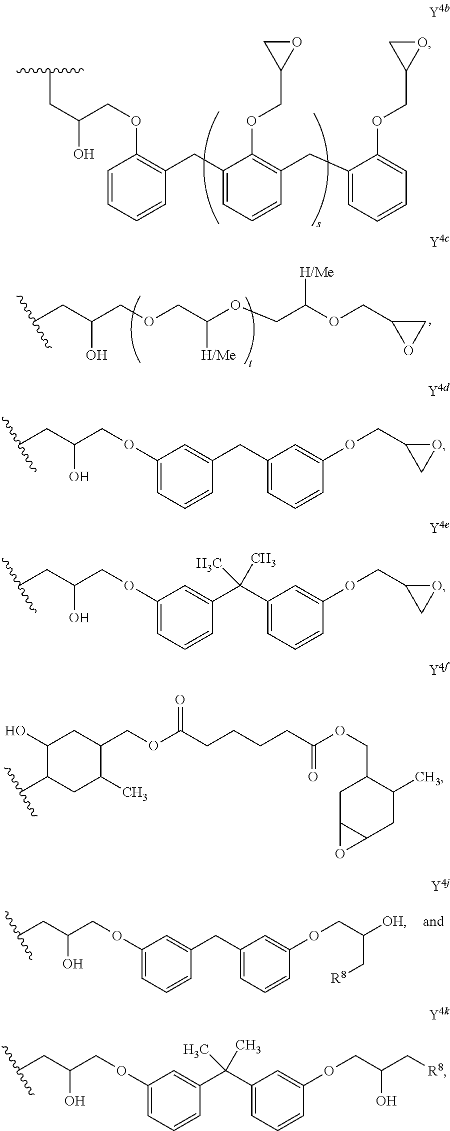

wherein s is an integer from 1 to 10 and t is an integer from 1 to 8.

The optional proviso that R⁴ is absent if L is L′, is disclosed for all embodiments described herein and means that if L in an R³ moiety is L′, then R⁴ is absent in that specific R³ moiety.

In the context of the present invention, R^{1′}-polyols, e.g. when chosen as R¹, are bonded through an Si—O—C bond.

In a further embodiment, the polymeric liquid hyperbranched polysiloxane material according to the present invention is one, wherein
R^{1′} is a polyol selected from the group consisting of:
   ethylene glycol, propylene glycol, glycerol, pentaerythritol, trimethylolpropane;
   linear or branched polyethyleneglycol or poylpropylene glycol or poly(co-ethylene/propylene glycol) copolymer polyols with a molecular weight between 200 and 30,000 g/mol;
   linear polyamid polyols with a molecular weight between 500 and 10,000 g/mol, comprising diamine and/or triamine units having 7 or less carbon atoms and di-carboxylic acid units having 10 or less carbon atoms;
   linear polyester polyols with a molecular weight between 500 and 10,000 g/mol, comprising diol and/or triol units having 7 or less carbon atoms and di-carboxylic acid or anhydride units having of 10 or less carbon atoms;
   branched acrylic polyols with a molecular weight between 300 and 5,000 g/mol, comprising at least one of hydroxyethyl methacrylate, hydroxybutyl acrylate, or hydroxyethyl acrylate units and optionally one or more styrene units;
   linear acrylic polyols with a molecular weight between 300 and 5,000 g/mol comprising acrylate and optionally styrene units;
   linear or branched polycarbonate polyols with a molecular weight between 500 and 50,000 g/mol comprising diol, triol and/or tetraol units having 13 or less carbon atoms; and
   natural oil-based polyols with a molecular weight between 200 and 2,000 g/mol; and
L is selected from the group consisting of

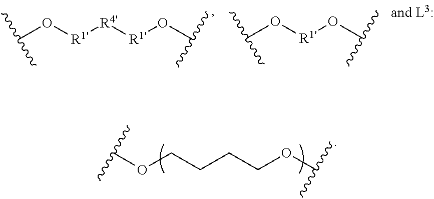

In another aspect, the present invention is directed to a UV-curable formulation comprising the polymeric liquid polysiloxane material described herein, optionally comprising at least one of 8a), 8b) and 8c):
8a) the polymeric liquid polysiloxane material described herein, wherein the material comprises T- and/or D-type siloxane moieties with R⁵ being R^{5U} and R^{5U} being

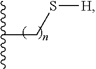

wherein optionally at least 5 mol-% optionally at least 15% mol-% of all R⁵ of the material are

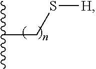

8b) the polymeric liquid polysiloxane material described herein, wherein the material comprises T- and/or D-type siloxane moieties with R⁵ being R^{5S} and Y being Y¹ and/or Y^{4j} and/or Y^{4k}, wherein optionally at least 5 mol-% optionally at least 15% mol-% of all R⁵ of the material are R^{5S} with Y being Y¹, and/or Y^{4j} and/or Y^{4k}
8c) the polymeric liquid polysiloxane material described herein, wherein the material comprises T- and/or D-type siloxane moieties with R⁵ being R^{5S} and wherein R^{5S} comprises at least one of

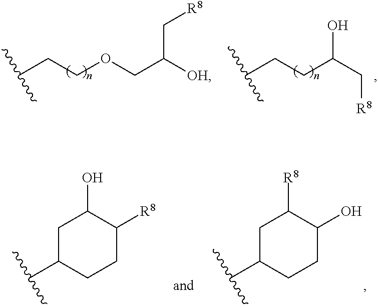

wherein the formulation optionally further comprises at least two components selected from the group consisting of a reactive diluent, optionally an acrylate-based reactive diluent, an acrylate resin, a photoinitiator and a stabilizer.

Typical UV polymerizable formulations contain radical polymerizable resins, typically based on acrylates or methacrylates, as well as reactive diluents to adjust viscosity and a photoinitiator as well as other additives. The liquid polysiloxane material with terminal Y¹ functionalities is used either as a low-viscosity acrylate resin, reactive diluent, as an adhesion promoter or as a multifunctional component. In a typical formulation, optionally at least two additional components selected from a reactive diluent, an acrylate resin, a photoinitiator a and a stabilizer can be used in combination with the polysiloxane material. For example, the content of the Y¹-functionalized polysiloxane polymeric liquid material is comprised to at least 1% and at most 50% by mass in the final formulation. Exemplary acrylate resins which may be used in such formulations are, e.g., polyester acrylates (e.g. RAHN Genomer 3000 series), urethane acrylates (e.g. Allnex EBECRYL 1200 series) or epoxy acrylates (e.g. Hexion EPON 8000 series). Exemplary reactive diluents include monomer acrylates such as ACMO: Acryloyl morpholine, CTFA: Cyclic trimethylolpropane formal acrylate, IDA: Isodecyl acrylate, IBOA: Isobornyl acrylate, DCPA: Di-cyclopentadienyl acrylate, and/or EOEOEA: 2-(2-Ethoxyethoxy)ethyl acrylate. Exemplary reactive dimer diluents include, e.g., BDDA: Butanediol diacrylate, HDDA: Hexanediol diacrylate, MPDDA: Methylpentanediol diacrylate, DPGDA: Di-propylene glycol diacrylate, TPGDA: Tri-propylene glycol diacrylate, and/or PEG-DA: Polyethyleneglycol diacrylate (with typical molecular weights of the PEG chain in the range of, e.g., 200-600 g/mol).

Additionally or alternatively, low molecular weight tri- and oligoacrylates can be used as reactive diluents, such as, e.g. TMPTA: Trimethylolpropane triacrylate, TMP (3EO)TA: Ethoxylated trimethylolpropane triacrylate, PETA: pentaerythritol-teraacrylate and/or DiTMPTA: Di-Trimethylolpropane tetraacrylate.

Additionally, photoinitiators may be comprised in the formulation described herein, e.g. to trigger the radical polymerization reaction with UV/blue light. Common photoinitiators are, e.g., organic benzophenones such as PBZ, DEAP or phosphine oxides such as BAPO, TPO etc. Also, synergists may be used to enhance the reactivity profile of the formulation. Such synergists are, for example, aromatic amine compounds.

Stabilizers may be added to the formulations described herein to provide light and oxidative stability of the cured polymers. Exemplary light/UV stabilizers are a combination of UV absorbers (e.g. BASF Tinuvin product family) and HALS (hindered amine light stabilizers), and antioxidants, e.g. selected from the group of substituted phenolic stabilizers known under the BASF tradenames Irganox and Irgafos.

In another aspect, the present invention is directed to a humidity curing formulation comprising the polymeric liquid polysiloxane material described herein, optionally a humidity curing formulation comprising the polymeric liquid polysiloxane material described herein, wherein the material comprises Q-type, T-type and/or D-type siloxane moieties with R¹ being R³, wherein optionally at least 0.1 mol %, or at least an amount between 0.1 to 3.0 mol-% of all R¹ of the material are R³, wherein the formulation optionally further comprises at least one of component selected from the group consisting of an aminosilane curing catalyst, an organometallic curing catalyst, an amine-based curing catalyst, a water scavenger, a plasticizer or softener, a filler, a stabilizer and a silane terminated polymer (STP) resin.

Typical amine curing catalysts for use in the present invention are C1-C8 aliphatic mono- or diamines, aromatic amines, di- or tricyclic aliphatic diamines such as DABCO, BDU, etc.

Also disclosed herein is a humidity curing formulation which comprises polymers covalently bonded to trialkoxysilyl and/or dialkoxysilyl terminal groups which hydrolyze and cure in the presence of humidity and optionally a catalyst.

Optionally, the content of the polymeric liquid polysiloxane material described above in such a humidity curing formulation is at least 1 phr (per hundred rubber), optionally at least 5 phr.

A functional ingredient in the humidity curing formulation described herein may be STP prepolymers of polyether-STPs or polyurethane STPs with linear and/or branched morphology and dialkoxysilyl or trialkoxysilyl hydrolysable groups grafted, often in a telechelic (terminal) chain position. Standard STP raw materials are readily commercially accessible, e.g. from major suppliers like Kaneka, Evonik, Wacker, Covestro and many others.

Fillers may also be used to decrease cost and increase tear resistance and mechanics. For example, coated precipitated calcium carbonate (e.g. Hakuenka CCR S10) may be used as a filler because of its low cost but other fillers are also possible in specialty formulations. For example, filler and STP make up at least 70% by mass of the total formulation.

For all aspects and embodiments described herein, exemplary fillers may be selected from the group consisting of: Fumed or precipitated silica (e.g. cab-o-sil, Aerosil, HDK brands of key suppliers Cabot, Evonik, Wacker); Glass powder, glass beads and glass fibers; Calcium carbonate; Barium sulfate; Carbon black; Clay minerals (e.g. Kaolin, Bentonite etc.) and other layered silicates (e.g. mica); Wollastonite; Alumina, magnesia, aluminum hydroxide, and magnesium hydroxide; Titanium dioxide, and Zinc oxide; and Iron oxide (e.g. Hematite/Magnetite). These materials may be used “neat” (uncoated) or in a coated/hydrophobic variety. Coated fillers—which incorporate better into organic polymer systems—typically are coated with, e.g., small molecules such as calcium stearate, stearic acid, maleic anhydride or also with hydrophobic silanes (e.g. hexamethyldisilazane—HMDZ or T-type monomeric silanes) or silicones. These fillers may be used in micron sized particles, however also “nanofillers” can be prepared from most of these materials and used as fillers, e.g. by flame spray synthesis, wet precipitation or sol-gel chemical methods.

To control rheology and application aspects, plasticizers/softeners may also be used, e.g. polyethers such as polypropylene glycol (PPG) with medium molecular weight (e.g. 1000-4000 g/mol) or long chain aliphatic esters of aromatic carboxylates such as DINCH (1,2-cyclohexane dicarboxylic acid diisononyl ester). For example, in addition to the above mentioned curing catalysts, aminosilanes such as APTMS (aminopropyltrimethoxysilane) and/or N-(2-Aminoethyl)-3-(trimethoxysilyl)propylamine may be used as curing catalysts or co-catalysts to accelerate the humidity curing reaction of the STP. Also, other T-silane monomers may be added to such a formulation, for example VTMS (vinyltrimethoxysilane) as a water scavenger and PhTMS (Phenyltrimethoxysilane) as an adhesion promoter and to improve temperature resistance. Exemplary stabilizers for UV and oxidation stabilization may also be added. These are comparable to the ones described above in the context of a UV-curable formulation.

In another aspect, the present invention is directed to a 1K curable isocyanate-based formulation comprising the polymeric liquid polysiloxane material described herein, wherein the material optionally comprises T- and/or D-type siloxane moieties with R⁵ being R^{5S} and Y being Y² and/or —R^{4′}-L-Y², wherein optionally at least 25 to 100 mol-% of all R⁵ of the material are R^{5S} with Y being Y² and/or —R^{4′}-L-Y².

The polysiloxane material for use in the 1K curable isocyanate-based formulation (1K PU) carries terminal Y² (isocyanato) functionalities which means that this material acts as a dendritic isocyanate prepolymer with tailorable functionality (e.g. by controlling R⁵ substitution degree and/or degree of Y² modification) and reactivity (e.g. by choice of the type of Y² isocyanate groups used). An exemplary 1K PU formulation comprises or consists of a polyurethane prepolymer, a plasticizer/softener, as well as a filler and optional catalysts depending on the type of isocyanate used and the speed required by the formulation. Typical plasticizers/softeners are, e.g., polyethers and more specifically polypropylene glycol (PPG) of medium molecular weight, e.g. in the range 1000-4000 g/mol. Exemplary fillers in 1K PU formulations are fumed silica, optionally hydrophobic fumed silica (e.g. Evonik Aerosil R 202), or hydrophobic precipitated silica etc. Exemplary polyurethane catalysts are compounds such as DABCO (1,4-diazabicyclo[2.2.2]octane), DMDPTA (N,N-Dimethyldipropylene triamine), DBU (Diazabicycloundecene) and other tertiary aliphatic amine compounds (e.g. BASF Lupragen N100-N700 product series) or DBTDL (Dibutyltin dilaurate) and related dialkyl-organotin compounds. Stabilizers may be selected from the group of typical light and oxidation stabilizers as described above.

In another aspect, the present invention is directed to a 2K curable isocyanate-based formulation, wherein the formulation comprises at least one resin, one hardener and at least one of the polysiloxanes (I.), (II.), (IV.) and (V.),
wherein the resin comprises:
(I.) a polysiloxane material according to any of claims 1 to 7, wherein 1 to 20 mol-%, optionally 3 to 20 mol-% or 1 to 10 mol-% of all R⁵ of the material are R^{5S} with Y being Y² and/or —R^{4′}-L-Y²;
(II.) a polysiloxane material according to any of claims 1 to 7, wherein at least 1 mol-% of all R¹ of the material are R^{1′}; and/or
(III.) a polyol and/or a polyamine;
   and the hardener is selected from:
(IV.) a polysiloxane material according to any of claims 1 to 7, wherein at least 50 mol-% of all R⁵ of the material are R^{5S} with Y being Y² or wherein optionally at least 80 mol-% of all R⁵ of the material are R^{5S} with Y being Y²,
(V.) a polysiloxane material according to any of claims 1 to 7, wherein at least 40 mol-% of all R⁵ of the material are R^{5S} with Y being R^{4′}-L-Y² or wherein optionally at least 75 mol-% of all R⁵ of the material are R^{5S} with Y being R^{4′}-L-Y²; and/or
(VI.) an isocyanate monomer, uretdione, biuret or triisocyanurate, or an isocyanate terminated prepolymer,
and the formulation optionally further comprises a catalyst, a filler and/or a stabilizer.

In an exemplary 2K curable isocyanate-based formulation described herein, the polysiloxane material carries terminal Y² (isocyanato) functionalities, again acting as a dendritic isocyanate prepolymer with tailorable functionality (e.g. by controlling R⁵ substitution degree and/or degree of Y² modification) and reactivity (e.g. by choice of the type of Y² isocyanate groups used). In such a 2K formulation the “hardener” component B can now be blended with additional isocyanate precursors, e.g. isocyanate bearing prepolymers or monomers/oligomers, in addition to the polymeric liquid material. The respective resin or polyol component A then contains, e.g. a polyol or polyol blend and typically also additives such as, e.g., fillers, catalyst, stabilizers and other additives. Optionally, the polyol blend may also contain R^{1′} functionalized polymeric liquid materials serving as “macro”-polyols. Optionally, the polyol blend may also contain reactive chain extenders such as amine terminated polyethers (e.g. Huntsmann Jeffamine product series). Fillers, catalysts and stabilizers are chosen from typical polyurethane formulation ingredients as described herein.

In another aspect, the present invention is directed to a 2K curable epoxy resin formulation comprising the polymeric liquid polysiloxane material described herein, wherein the material optionally comprises T- and/or D-type siloxane moieties with R⁵ being R^{5S} and Y being Y⁴ with the exception of Y^{4j} and Y^{4k}, wherein optionally at least 10, 30 or 50 mol-% of all R⁵ of the material are R^{5S} with Y being Y⁴ with the exception of Y^{4j} and Y^{4k}, and wherein the formulation further comprises at least one component selected from the group consisting of a an amine hardener, a mercapto hardener, an anhydride hardener, optionally a polymeric liquid polysiloxane material described herein, wherein the material optionally comprises T- and/or D-type siloxane moieties with R⁵ being R^{5U}, a catalyst, a filler, a stabilizer and an epoxy resin

Also disclosed herein is a 2K curable epoxy resin formulation comprising the polymeric liquid polysiloxane material described herein, wherein the material optionally comprises T- and/or D-type siloxane moieties with R⁵ being R^{5S} and Y being Y⁴, wherein optionally at least 10, 30 or 50 mol-% of all R⁵ of the material are R^{5S} with Y being Y⁴, and wherein the formulation further comprises at least one component selected from the group consisting of a an amine hardener, a mercapto hardener, an anhydride hardener, a catalyst, a filler, a stabilizer and an epoxy resin.

In the 2K curable epoxy resin formulation described herein, the polysiloxane material carries terminal Y⁴ (epoxy) functionality, again acting as a dendritic epoxy-bearing prepolymer with tailorable functionality (e.g. by controlling R5 substitution degree and/or degree of Y⁴ modification) and reactivity (e.g. by choice of the type of Y⁴ epoxy precursor used). In such a 2K formulation, the “resin” component A can be blended from epoxy resin or reactive diluents (e.g. BPADGE-bisphenol A diglycidyl ether) in addition to the polymeric liquid material. The respective “hardener” component B is then composed of, e.g., typical epoxy hardeners, that is either an amine hardener, a mercapto hardener, an anhydride hardener or a customized hardener blend. Optionally, the hardener may also comprise non-functionalized polysiloxane liquid material described herein, wherein all or substantially all of the R⁵ residues in the material are R^{5U} residues excluding epoxide groups or optionally R^{5U} and R^{5S} with functionalizations excluding epoxide groups. Fillers are selected from the group consisting of, e.g., clay minerals and titanium dioxide. For improved fracture toughness, epoxy formulations may also contain nanofillers such as fumed silica.

In another aspect, the present invention is directed to a formulation comprising
the polymeric liquid polysiloxane material as described herein, wherein the material optionally comprises T- and/or D-type siloxane moieties with R⁵ comprising aminic R^{5U} and/or R^{5S} and Y being Y³, wherein optionally at least 40 to 100 mol-% of all R⁵ of the material are aminic R^{5U} and/or R^{5S} with Y being Y³, and
at least one component selected from the following
   a polyimide, polyamid, polyester resin or prepolymer, a diamine, a polyamine or a polyol, and
   a catalyst and a filler, optionally at least one dianhydride.

In the context of the present formulation, the term “with R⁵ comprising aminic R^{5U} and/or R^{5S}” means that at least part of all R⁵, optionally at least one R⁵ is an aminic R^{5U} or R^{5S}. The term “aminic R^{5U} and R^{5S}”, as used herein, refers to the following R^{5U} and R^{5S} moieties comprising a nitrogen atom:

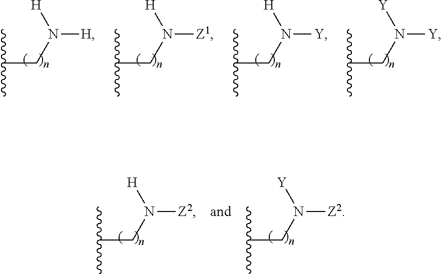

Typically, the above-described formulation will self-cure relatively quickly, but its speed can be controlled by the anhydride/amine stoichiometric ratio. In the presence of optional additional dianhydride, linear chain segments can be introduced which adds soft segments and hence elasticity to the cured formulation. Fillers and additives can be selected from the list described for epoxy materials. Such a formulation is optionally prepared in a solvent such as, e.g., DMAC (dimethylacetamide), DMSO (dimethylsulfoxide), NMP (N-methyl-pyrrolidone), acetone, and/or MEK (methyl-ethyl ketone). Such formulations can optionally be used to prepare new types of polyimide materials and polyimide-containing composites or as crosslinkers for polyester/polyamide resins.

In another aspect, the present invention is directed to a directly emulsifiable formulation comprising the polymeric liquid polysiloxane material described herein, optionally a formulation comprising at least one of
the polymeric liquid polysiloxane material described herein, wherein the material comprises T- and /or D-type siloxane moieties with R⁵ being R^{5S} and Y being Y³ and/or Y being H,

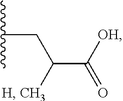

wherein optionally at least 40 to 100 mol-% of all R⁵ of the material are R^{5S} with Y being Y³ and/or Y being

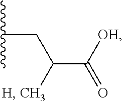

the polymeric liquid polysiloxane material described herein, wherein the material comprises Q-type, T-type and/or D-type siloxane moieties with R¹ being R³, wherein optionally at least 0.1 mol %, or at least an amount between 0.1 to 3.0 mol-% of all R¹ of the material are R³, and
an oil, a co-emulsifier, a stabilizer, a surfactant.

In the context of the present invention, a directly emulsifiable formulation is a formulation which can be converted into an emulsion by diluting into/mixing with water and optional stirring/homogenization without the need for a (further/external) solvent. Optionally an organic solvent can be added as cosolvent if needed.

The oil for use in the directly umulsifiable formulation can be a natural oil or a synthetic oil such as, e.g., a silicone oil based on polydimethoxysiloxane, an oil based on hydrocarbons or petroleum products such as, e.g., a mineral oil, and/or fatty acids, specifically fatty acid triglycerides such as, e.g., soybean oil, canola oil, tripalmitin, avocado oil, sunflower oil, coconut oil, safflower oil etc.

The co-emulsifier for use in the directly emulsifiable formulation can be any emulsifier or surfactant active on its own, specifically ionic surfactants such as saponified fatty acids (e.g. sodium linoleate, potassium palmitate etc.), long chain hydrocarbon trialkylammonium salts (quats) such as cetyltrimethylammonium bromide, potassium cetyl phosphate and also non-ionic surfactants such as polyethylene/polypropylene oxide polymers and block copolymers (e.g. BASF Pluronic product series) and also natural emulsifiers based on glycol(phospho)lipids which are commonly used in the food industry such as soy Lecithin, glycerin monostearate, sodium stearoyl lactylate, sodium stearoyl glutamate, glycerol triacetate, polyglycerol polyricinoleate, sorbitan stearate, poly-ethylyleneglycol (PEG) sorbates and -stearates. The same definitions and examples apply to the emulsifier for use in the present invention.

In another aspect, the present invention is directed to a glass fiber sizing formulation comprising the polymeric liquid polysiloxane material described herein, optionally a formulation comprising
the polymeric liquid polysiloxane material described herein, wherein the material comprises T- and /or D-type siloxane moieties with R⁵ being R^{5U} and wherein the material optionally comprises Q-type, T-type and/or D-type siloxane moieties with R¹ being R³, wherein optionally at least 0.1 mol %, or at least an amount between 0.1 to 3.0 mol-% of all R¹ of the material are R³, and
at least one component selected from the group consisting of a silane in monomer or hydrolysed form, a lubricant, a biopolymer, an oil, a film former, a surfactant and an emulsifier.

In the context of the glass fiber sizing formulation, exemplary silanes are amino, glycidoxy, mercapto and vinyl functional T-type silanes. Specific examples include, e.g., 3-aminopropyl-triethoxysilane, 3-aminopropyl-trimethoxysilane, 3-glycidoxypropyl-triethoxysilane, 3-glycidoxypropyl-trimethoxysilane, 3-mercaptopropyl-triethoxysilane, 3-mercaptopropyl-trimethoxysilane, vinyltriethoxysilane, and vinyltrimethoxysilane. Exemplary lubricants include polymer dispersions, (microcrystalline) wax dispersions, polyelectrolyte polymer dispersions, specifically quaternary ammonium salts based on alkoxylated and/or epoxidized amines such as lauryl amine, dodecyl amine, oleyl amine, cottonseed oil amine, and palmityl amine, and other natural fatty acid amine analogues. Exemplary biopolymers include sugars, oligosaccharides, starch, pectin, chitosan, alginate, cellulose, and lignin. Exemplary film formers include polymers such as polyvinyl acetate, polyester resin, polyamide, polyvinyl chloride, polyolefins (e.g. polypropylene), polycarbonate, epoxy resin, polyurethane, etc, typically and for example in the form of polymer dispersions. For exemplary oils, surfactants and emulsifiers, reference is made to the explanations and examples given herein, e.g. in the context of hydrolysis and/or emulsification products.

In another aspect, the present invention is directed to a radical curable formulation comprising the polymeric liquid polysiloxane material described herein, optionally a formulation comprising
the polymeric liquid polysiloxane material described herein,
wherein the material comprises T- and/or D-type siloxane moieties with R⁵ being R^{5U} and R^{5U} being vinyl and/or

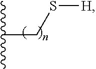

and/or T- and/or D-type siloxane moieties with R⁵ being R^{5S} and R^{5S} comprising at least one of

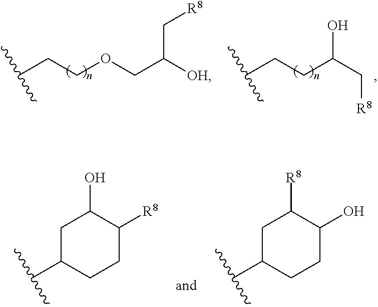

or R^{5S} with Y being Y³, Y^{4j} and/or Y^{4k}, wherein optionally at least 20 to 100 mol-% of all R⁵ of the material are R^{5S} with Y being Y³, Y^{4j}, Y^{4k},

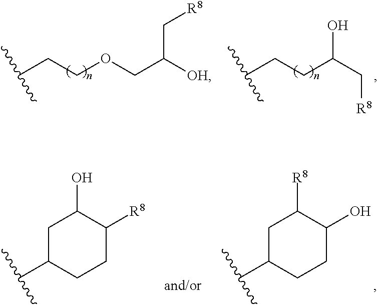

and optionally at least 20 to 100 mol-% of all R⁵ of the material are R^{5U} and R^{5U} being vinyl and/or

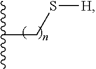

and
at least one component selected from the group consisting of a filler, a radical initiator optionally an organic radical initiator, an unsaturated monomer or oligomer, a film former and a stabilizer.

Exemplary radical initators include inorganic radical generators such as the examples given below, as well as preferably organic peroxide or azo-compounds such as dibenzoyl peroxide, dicumyl peroxide, di-isobutyl peroxide, acetone peroxide, azo-isobutyronitrile (AIBN). Exemplary unsaturated monomers or oligomers include ethylene, butadiene, styrene, maleic anhydrides, divinylbenzene, acrolein, acrylamide, vinyl chloride, acrylic acid, N-vinylpyrrolidone, (di-) cyclopentadiene, methacrylic acid, alkyl acrylates and methacrylates but also fatty acids and naturally occurring unsaturated small molecule compounds such as terpenes etc. Exemplary unsaturated oligomers are homo or copolymers obtainable from such monomers or also naturally occurring unsaturated compounds with intermediate molecular weight such as Diels-Alder reaction products of polyunsaturated fatty acids. For exemplary fillers, polymer resins and stabilizers reference is made to the explanations and examples given herein in the context of other aspects.

In another aspect, the present invention is directed to a binder, adhesive, sealant, elastomer or coating comprising the polymeric liquid polysiloxane material described herein, and/or at least one of the formulations described herein, optionally comprising more than one type of Y-, R³ and/or R^{1′}-functionality in the same formulation.

In another aspect, the present invention is directed to a solvent-based 2K polyurethane clearcoat formulation comprising the polymeric liquid polysiloxane material described herein, and/or at least one of the formulations described herein, optionally, the humidity curing formulation described above, optionally the radically curing formulation described above.

In another aspect, the present invention is directed to a binder, adhesive, sealant, elastomer, clearcoat, polymer, coating or formulation obtained or obtainable by at least partial curing and/or thermal treatment of the formulation described herein.

Optionally, the formulations described herein, optionally except for the 1K curable isocyanate-based formation, further comprise a monomeric T-type silane, optionally comprising R^{5U} or R^{5S}.

In another aspect, the present invention is directed to a polymer dispersion obtained or obtainable by combining two formulations described herein and emulsifying the resulting mixture in water or a water/solvent mixture and polymerizing said mixture, optionally at a temperature between 4° and 90° C., optionally in the presence of a radical initiator, optionally in the presence of an inorganic peroxo-type radical initiator.

Exemplary inorganic peroxo-type or superoxide-type radical imitators include sodium persulfate, hydrogen peroxide, sodium percarbonate, potassium superoxide etc.

In another aspect, the present invention is directed to a cosmetics or personal care formulation comprising the polymeric liquid polysiloxane material described herein, and/or at least one of the formulations described herein, optionally the directly emulsifiable formulation described herein.

The term “T- and/or D-type” or “T-/D-” as used herein in the context of siloxane or silane moieties means that either T- and/or D-type moieties are concerned, optionally, as used herein only T-type moieties are concerned.

In a disclosure, the polymeric liquid polysiloxane material described herein is one, wherein
(i) the degree of polymerization of the Q-type alkoxy-terminated moieties DP_{Q-type} is in the range of 1.5 to 2.5;
(ii) the degree of polymerization of the D-type alkoxy-terminated siloxane moieties DP_{D-type} is in the range of 1.25 to 1.75; and/or
(iii) the degree of polymerization of the T-type alkoxy-terminated siloxane moieties DP_{T-type} is in the range of 1.3 to 2.2.

In a disclosure, the polymeric liquid polysiloxane material described herein is one, wherein the total content of di-organofunctional D-type siloxane and/or the total content tri-organofunctional M-type siloxane moieties is zero.

In a disclosure, the polymeric liquid polysiloxane material described herein is one, wherein the relative atomic ratio of T- to Q-species is in the range of 0.02:1 to 0.75:1, optionally in the range of 0.03:1 to 0.5:1, and/or the relative atomic ratio of D- to Q-species is in the range of 0.02:1 to 0.25:1, optionally in the range of 0.03:1 to 0.20:1.

Also disclosed herein is a hydrolysis product obtainable by reacting at least one polymeric liquid material as described herein with a predetermined amount of water or with a predetermined amount of a water-solvent mixture, optionally in the presence of at least one surfactant.

The predetermined amount of water or water-solvent mixture for hydrolysis or for emulsifying is determined, e.g. by the molar amount of water to total molar amount of Si in the system confined in typical formulations by upper and lower bound limits. A lower bound value defining the water to total Si molar ratio can be 0.02:1, optionally 0.1:1 or 0.5:1. An upper bound value defining the water to total Si molar ratio can be 5,000:1, optionally 500:1 or 50:1. The amount of cosolvent can be chosen independently and technically without limitation imposed by the water to Si molar ratios.

For example, solvents for hydrolysis can be selected from the group consisting of water-soluble organic solvents such as low-molecular weight alcohols, ethers, carboxylic acids, e.g.:
alcohols of formula Rₓ—OH with Rₓ being selected from the group consisting of —CH₃, —C₂H₅, —C₃H₇, —C₄H₉, —C₅H₁₁, and —C₆H₁₃;
ketones of formula Rₓ,R_{y}—(C═O) with Rₓ,R_{y} independently selected from the group consisting of —CH₃, —C₂H₅, and —C₃H₇;
carboxylic acids of formula Rₓ-COOH with Rₓ being selected from the group consisting of —CH₃, —C₂H₅, —C₃H₇, —C₄H₉, —C₅Hu, and —C₆H₁₃;
low-molecular weight organic esters such as ethyl acetate, methyl acetate or ethyl formate, methyl formate; and/or
ethers of formula Rₓ—O—R_{y} with Rₓ,R_{y} being independently selected from the group consisting of —CH₃, —C₂H₅, and —C₃H₇ or cyclic ethers such as tetrahydrofuran.

Together with the solvent, also an acid or a base can be used as a hydrolysis/condensation catalyst. Typical acids to be used are mineral inorganic acids and low-molecular organic carboxylic acids. Typical bases are alkali hydroxides, ammonia or aliphatic/aromatic primary, secondary or tertiary amines.

For example, surfactants for hydrolysis and/or emulsification can be selected from the group consisting of
non-ionic surfactants such as polyethylene-oxide/polypropylene oxide block copolymers or similar polyether block copolymer surfactants;
carboxylic acid based ionic surfactants, particularly fatty acids and related saturated or unsaturated linear and or branched aliphatic hydrocarbon-carboxylates such as lauric acid, stearic acid, oleic acid etc. and their corresponding alkali salts;
sulfonic acid or phosphonic acid based ionic surfactants, particularly saturated or unsaturated linear and or branched aliphatic hydrocarbon-sulfonates such as dodecylsulfonic acid (SDS) and their corresponding alkali salts; and/or
trialkylammonium salt based ionic surfactants such as cetyltrimethylammonium bromide (CTAB) or cetyltrimethylammonium chloride (CTAC).

Also disclosed herein is an emulsion obtainable by emulsifying a polymeric liquid material as described herein with a predetermined amount of water, optionally in the presence of at least one surfactant.

Also disclosed herein is a method for preparing a polymeric liquid material as described herein, comprising the following steps:
A: providing a polymeric liquid material as described herein, wherein at least 1 mol-%, optionally at least 3 mol-%, optionally at least 5 mol-%, optionally at least 10 mol-% optionally at least 20 mol-% of all R⁵ moieties in the material are R^{5U} moieties;
B: functionalizing the R^{5U} residues of the polymeric liquid material to obtain at least 1 mol-%, optionally at least 3 mol-%, optionally at least 5 mol-% optionally at least 7 mol-% R^{5S} residues relative to all R⁵ residues;
C: optionally modifying the polysiloxane material of A and/or B to include R^{1′} and/or R³ moieties under mixing and thermal treatment, optionally in the presence of an organometallic curing catalyst different from a rearrangement catalyst and optionally under vacuum;
D: retrieving, optionally isolating and optionally purifying the polymeric liquid material.

The term modifying or R^{5S}-functionalizing as used herein for obtaining R^{5S} residues means that a chemical reaction is performed which is suitable for converting an R^{5U} residue into an R^{5S} residue. The suitable chemical reactions are known to the skilled person and are routinely chosen to obtain the desired R^{5S} residue.

The skilled person knows which type of reactions and/or reaction conditions for Y¹ through Y⁴ functionalizations are compatible with the presence of (small amounts) water, methanol, ethanol propanol, silanol and/or residual free amino groups. The skilled person will choose a suitable protocol for carrying out the individual synthesis steps in order to minimized undesired side reactions with water, methanol, ethanol propanol, silanol and/or residual free amino groups. R^{5S}-functionalization reactions that are not compatible with the presence of water and/or silanol groups and must be carried out in their presence are optionally excluded from the scope of the present invention. In some cases, such side reactions may be desirable or be part of the synthetic strategy and the intended resulting final chemical state of the system. An exemplary protocol for R^{5S}-functionalization reactions that are sensitive to water and/or silanol groups includes to first carrying out the functionalization on a T⁰ monomer followed by grafting of the T⁰ monomer onto the siloxane core, thus circumventing reactions in the presence of water and/or silanol groups by temporal separation of the R^{5S}-functionalization.

The polymeric liquid polysiloxane material prepared by the method described herein is optionally R^{5S}-functionalized, i.e. at least 1 mol-%, optionally at least 3 mol-%, optionally at least 5 mol-% optionally at least 7 mol-% of all R⁵ moieties in the material are R^{5S} moieties, wherein R^{5S} is considered a R^{5S}-functionalized moiety. The starting material for the method may be non-R^{5S}-functionalized (essentially 100 mol-% of all R⁵ moieties in the material are R^{5U} moieties) or partly R^{5S}-functionalized (at least 3 mol-% of all R⁵ moieties in the material are R^{5U} moieties). R^{5S}-functionalization of the starting material may be done by functionalizing R^{5U} of grafted T- and/or D-type siloxane moieties or optionally by grafting further, pre-R^{5S}-functionalized T- and/or D-type silanes comprising R^{5S} moieties. The R^{5S}-functionalization of R^{5U} moieties can be done by known chemical methods. Retrieving, optionally isolating and optionally purifying the polymeric liquid material can be done as outlined in the context of step (g) of the method below.

In analogy to R⁵, R¹ can be a functionalized residue which means that R¹ is selected from R^{1′} and R³. 0 mol-% or at most 2 mol-% of all R¹ moieties in the material are R³ moieties. Optionally, 0 mol-% or at most 50 mol-% of all R¹ moieties in the material are R^{1′} moieties. The explanations outlined above in the context of R⁵ apply mutatis mutandis to R¹ being R³ and optionally R^{1′}.

Also disclosed herein is a method for preparing a polymeric liquid material as described herein, comprising the following steps:
(a) providing a Q-type polymethoxy, polyethoxy, polypropoxy or mixed poly(methoxy/ethoxy/propoxy) polysiloxane precursor,
   optionally comprising
      (a1) di-organofunctional D-type siloxane moieties, wherein R⁵ is selected from R^{5U} and optionally R^{5S} and R¹ is selected from methyl, ethyl, propyl and optionally R³ and R^{1′}, and/or
      (a2) mono-organofunctional T-type siloxane moieties, wherein R⁵ is selected from R^{5U} and optionally R^{5S} and wherein R¹ is selected from methyl, ethyl, propyl and optionally R³ and R^{1′}; and/or
      (a3) monoorganofunctional M-type siloxane moieties;
      optionally comprising less than 12 mol-% of (a1) and (a2) combined relative to the total amount of all Q-type species;
   optionally further comprising a rearrangement catalyst;
   and
   wherein degree of polymerization of the Q-type polysiloxane DP_{Q-type} is in the range of 1.5 to 2.7, optionally 1.5 to 2.5, optionally 1.7 to 2.5;
(b) adding at least one of a
   (b1) tri-organofunctional M-type silane selected from the group consisting of Si(R¹)(Me)₃, hexamethyldisiloxane (HMDSO), hexamethyldisilazane (HMDZ) and trimethylsilyl chloride (TMCS); and/or
   (b2) di-organofunctional D-type silane Si(OR¹)₂(R²)(R⁵); and/or
   (b3) mono-organofunctional T-type silane Si(OR¹)₃(R⁵), wherein R¹ and R² are as defined herein and R⁵ is selected from R^{5U} and optionally R^{5S};
   in mono- or oligomeric form to the polysiloxane of (a), wherein R¹ for the precursors in (b1) to (b3) is selected from methyl, ethyl, and propyl;
(c) optionally adding a rearrangement catalyst to the mixture of step (b);
(d) heating the mixture of (c) optionally in the absence of water:
(e) optionally repeating steps (b) to (d) at least once;
(f) optionally functionalizing the R^{5U} residues of the polymeric liquid material to obtain at least 1 mol-%, optionally at least 3 mol-%, optionally at least 5 mol-% optionally at least 7 mol-% R^{5S} residues relative to all R^{5U} residues; optionally modifying the R¹ residues of the polymeric liquid material to obtain at least 0.05 mol-%, optionally at least 0.15 mol-%, optionally at least 0.4 mol-%, optionally at least 1 mol-% R³ residues relative to all R¹ residues; and/or optionally modifying the R¹ residues of the polymeric liquid material to obtain 0.5 to 25 mol-%, optionally 1 to 20 mol-% R^{1′} residues relative to all R¹ residues;
(g) retrieving, optionally isolating and optionally purifying the polymeric liquid material;
with the optional proviso that at least one of steps (a2) or (b3) is carried out, and
with the optional proviso that a rearrangement catalyst is present in at least one of steps (a) or (c).

Optionally, the material of step (a) is one, wherein the precursor optionally comprises at least 28, optionally at least 35, optionally at least 42 mol-% four-membered combined Q^{2r}-type and Q^{3s,d}-type siloxane ring species relative to the total Q-type siloxane species; and/or
wherein the precursor optionally comprises at least 60%, optionally at least 67%, optionally at least 75% four-membered combined Q^{3s,3d}-type siloxane ring species relative to all Q³-type siloxane species.

The Q-type polymethoxy, polyethoxy, polypropoxy or mixed poly(methoxy/ethoxy/propoxy) polysiloxane precursor of step (a) can be any, e.g. commercially available, Q-type polymethoxy, polyethoxy, polypropoxy or mixed poly(methoxy/ethoxy/propoxy) polysiloxane as long as it comprises the non-organofunctional Q¹- to Q⁴-type siloxane moieties defined for the polysiloxane material herein, optionally wherein at least 28, optionally at least 35, optionally at least 42 mol-% of all Q-type species are part of four-membered Q²-type and Q³-type siloxane ring species (including single and double rings), and/or wherein at least 60%, optionally at least 67%, optionally at least 75% of all Q³-type species are part of four-membered Q^{3s,3d}-type siloxane rings, and as long as the degree of polymerization of the Q-type polysiloxane DP_{Q-type} is in the range of 1.5 to 2.5, optionally 1.5 to 2.7, optionally 1.7 to 2.4. In the context of the present method, the four-membered Q³-type siloxane ring species are those Q³-type siloxane species which are part of one or two four-membered rings, respectively. The term “all Q-type species” in the context of the present method includes all Q¹ to Q⁴ siloxane species as well as Q⁰ silane monomer(s).

The Q-type polymethoxy, polyethoxy, polypropoxy or mixed poly(methoxy/ethoxy/propoxy) polysiloxane of step (a) constitutes the precursor material as described herein. If a core-shell architecture is targeted, typically a pure Q-type precursor material is used as the core. A typical two-dimensional structural representation formula of two such a model precursor comprising T-Type moieties, D-Type moieties as well as some silanol groups is shown in FIG. 2.

For example, the following Q-type polymethoxy, polyethoxy or mixed poly(methoxy/ethoxy) polysiloxane can be used in step (a): commercial oligomers of TEOS or TMOS, e.g. ethylsilicates with 40% by mass of total SiO₂ equivalent content such as Dynasylan 40 (Evonik Industries), Wacker Silicate TES 40 WN (Wacker), TEOS-40 (Momentive) or simply “ethylsilicate-40” as referred to by many non-branded Asian suppliers. Also, oligomers with higher silicate content such as Dynasylan Silbond 50 or equivalent products with up to 50% equivalent SiO₂ solids content can be used. The same holds for TMOS oligomers such as “Tetramethoxysilane, oligomeric hydrolysate” (Gelest Inc.) or “MKC silicate” (Mitsubishi Chemicals) which exist in variations with up to 59% SiO₂ equivalent content can be used as a source for methylsilicates. Comparable propoxy-silicates, if available commercially, can also be used.

Alternatively, the Q-type polymethoxy, polyethoxy, polypropoxy or mixed poly(methoxy/ethoxy/propoxy) polysiloxane of step (a) can be synthesized according to known protocols in the art, including hydrolytic and non-hydrolytic methods, e.g. as described in the examples below, in WO 2019/234062 A1, EP1576035 B1, Macromolecules 2006, 39, 5, 1701-1708, Macromol. Chem. Phys. 2003, 204(7), 1014-1026, or Doklady Chem., Vol. 349, 1996, 190-19.

The definitions of chemical substituents the di-organofunctional D-type siloxane moieties and the mono-organofunctional T-type siloxane moieties in the context of the present method correspond to the definitions given in the context of the polysiloxane material described herein.

The term “in mono- or oligomeric form”, as used herein, means that the M-, D- and T-type silanes are not highly polymerized when used as a precursor, i.e. are either monomers or small oligomers of, e.g., common mixtures with less than ten monomer units, optionally less than five monomer units, in a typical oligomer.

The rearrangement catalyst for use in the present method can be any catalyst that accelerates the grafting of T-, D- and M-type monomers or oligomers a nucleophilic substitution mechanism leading to the polymeric liquid material described herein. Catalyst concentrations are generally in the range from 0.01 mol-% to 1.5 mol-% based on the total molar silicon content in the prepared material. The catalyst may be present in step (a) or (c), or both with the proviso that it is present in at least one of steps (a) or (c).

Main group or transition metal salts or organometallic compounds or organic (e.g. aliphatic amine- or aminosilane-) or inorganic bases can be used as rearrangement catalysts.

The rearrangement catalyst, as used herein can be positively identified for example by following the protocol of Example 5 below. Any catalyst that elicits at least 75% grafting of T⁰ (less than 25% residual T⁰ monomer) for the MTES model compound defined in the protocol of Example 27 is a rearrangement catalyst for use in the present invention.

The catalyst for use in the present method can be selected from a group of compounds with the sum formulae

| | |
|---|---|
| M(II)L₁L₂ | for metal ions in the oxidation |
| | state +2 such as Zn⁺² or Fe⁺² |
| M(III)L₁L₂L₃ or O═M(III)L₁ | for metal ions in the oxidation |
| | state +3 such as Ce⁺³ or Fe⁺³ |
| M(IV)L₁L₂L₃L₄ or O═M(IV)L₁L₂ | for metal ions in the oxidation |
| | state +4 such as Ti⁺⁴ or Hf⁺⁴ |
| M(V)L₁L₂L₃L₄L₅ or O═M(V)L₁L₂L₃ | for metal ions in the oxidation |
| | state +5 such as V⁺⁵ or Nb⁺⁵ |

wherein M(II, III, IV, IV) is a main group or transition metal ion in an oxidation state +2 to +5 and bonded by covalent, ionic or coordination bonds or a combination thereof to identical or non-identical coordinating counterions and/or ligands L₁ to L₅, where at least one of these ligands is selected from the group of halides (e.g. F⁻, Cl⁻, Br⁻, I⁻), pseudohalides (e.g. SCN⁻, N₃⁻, CN⁻), chalcogenides, mineral acid counterions, organic carboxylates, organic alcoholates, acetylacetonates, organic sulfonic or phosphonic acid counterions, where preferably the main group or transition metal ion is selected from the group of elements Fe, Al, Sc, Y, Ti, Zr, Hf, V, Nb, Ta, Zn, Ce, Co, Fe and Mn in their naturally occurring oxidation states.

“In the absence of water” as noted in step d) optionally does not apply to reactions, e.g. grafting and/or rearrangement reactions, with tri-organofunctional M-type silanes as defined in the present method. In the present method, the reaction step with tri-organofunctional M-type silanes may be performed in the presence of water, e.g. in the presence of an aqueous acid/co-solvent mixture (e.g. EtOH, water, ketones etc.) as commonly used in the art. Optionally the M-type silane grafting is temporally separated from D-Type and/or T-type grafting, either being carried out before or after.

In order to allow sufficiently fast kinetics to yield reasonable reaction times, the use of elevated temperature in conjunction with a catalyst are typically required at least in step (d), optionally in steps (b) to (e) as described herein.

Each reaction step may be carried out for, e.g. half an hour to several hours or several days, depending on the rearrangement catalyst type and concentration used. Alternatively, if a radiofrequency-assisted heating method is used, the reaction times may be shortened significantly.

All of steps (b) to (f) are optionally carried out under stirring or mixing. Optionally stirring is continued in steps d) and/or (f) for at least 30 minutes after the M-, D- or T-type silane was added.

For example, during step (d) and/or (f), the total degree of polymerization remains essentially constant if the reaction is carried out in the absence of water. As noted herein, the total degree of polymerization always refers to that of the liquid polysiloxane material.

Optionally, in step (d) and/or (f), low-molecular reaction products and/or residual starting materials in the reaction mixture can be removed by vacuum distillation, e.g. through gradually lowering the pressure inside the reaction vessel and holding a final pressure in the range of, e.g. about 5 to 250 mbar for a period of time between, e.g. 2 and 60 minutes, optionally using a thin film evaporator setup. Optionally, residual volatile organic compounds, solvent residues and/or low molecular starting products (VOC) can be further removed at any stage in the workup procedure by bubbling a purge gas through the preferably still warm or hot reaction mixture.

For example, each of steps (a) through (e) of the present method are carried out essentially in the absence of any chemical reagent and/or any chemical reagent to promote the polymerization other than the rearrangement catalyst for the grafting reaction. For example, all of steps (a) through (e) are carried out essentially in the absence of acetic anhydride, acetic acid or other anhydrides or alphatic or aromatic carboxylic acids or water optionally in the absence of chlorosilanes, chlorosiloxanes, acetoxysilanes or acetoxysiloxanes. “Essentially in the absence” means that there may be traces or catalytic amounts of the aforementioned substances present, however, “essentially in the absence” means that the amounts are not sufficient to promote a detectable or significant polymerization reaction by means of these substances.

Optionally, also no rearrangement catalyst as defined herein is necessary if the reaction temperature and duration is adjusted accordingly. As can be seen from ²⁹Si NMR analysis, the mol-% of ring species in the material of step (a) is significantly reduced in the product according to the present preparation method. As an example of a typical grafting reaction, FIG. 5b (middle) shows the reaction product after rearrangement of a typical example using a polyeythoxysiloxane Q-type precursor (FIG. 5a (top)) and APTMS as the T-type silane. By direct comparison one notices that the grafted product features a significant reduction in both Q^{2r} and also Q^{3s}, Q^{3d} tetrasiloxane ring species as well as an increase in Q⁰ monomer which most likely results from a partial Q-type depolymerisation. At the same time, the fraction of linear Q-type moieties (Q^{2l} and Q^{3l}) has increased significantly. FIG. 5c shows a ²⁹Si NMR spectrum of the APTMS grafted R^{5U} material from the above case (FIG. 5b) after functionalization of the amine groups with 3-methylpentyldiol diacrylate (MPDDA) to produce the corresponding Y¹—R^{5s} material. Note that the grafting does not give rise to any noticeable spectral changes in the ²⁹Si NMR, aside from a slight peak broadening of the T⁰ (monomer impurity) and possibly the T¹ signatures.

The optional proviso that at least one of steps (a2) or (b3) is carried out means that at the product of the present method is a polymeric liquid polysiloxane material as described herein comprising T- and/or D-type siloxane moieties as described herein, hence, the T- and/or D-type silanes must be added in monomeric or oligomeric form in at least one step of the present method. This is synonymous with saying that the product must contain T- and/or D-type moieties.

When step (e) is optionally performed, the repetition of step (b) encompasses that the materials added during that or a further repetition step are not necessarily the same materials compared to the previously performed step. For example, if for the first performance of step (b3), R^{5U} is chosen for R⁵, then R^{5U}, R^{5S} or any combination thereof can be chosen for R⁵ when repeating step (b3). The same applies to all other repeated steps.

For the T- and/or D-type siloxane moieties and silanes of step (a2) and (b3), R⁵ is selected from R^{5U} and R^{5S} and R¹ is selected from methyl, ethyl, propyl and optionally R³ and R^{1′}. This means that the T- and/or D-type siloxane moieties/silanes may be non-R^{5S}-functionalized and/or R¹ may be a residue other than R^{1′} and/or R³ (essentially 100 mol-% of all R⁵ and/or R¹ moieties of all T- and/or D-type siloxane moieties/silanes in the material are R^{5U} for R⁵ or methyl, ethyl, or propyl moieties for R¹), fully R^{5S}-functionalized (essentially 100 mol-% of all R⁵ moieties of all T- and/or D-type siloxane moieties/silanes in the material are R^{5S} moieties) or partly R^{5S}-functionalized or a part of the R¹ residues are R³ residues. Optionally, R⁵ of the mono-organofunctional T- and/or D-type siloxane moieties in step (a2) of the present method is R^{5U} and/or R¹ is selected from methyl, ethyl, propyl.

Step (f) is optional to the extent that no functionalization of the R^{5U} residues is mandatory if the T- and/or D-type siloxane moieties and silanes of step (a2) and/or (b3) are chosen such that in the product of the method at least 1 mol-%, optionally at least 3 mol-%, optionally at least 5 mol-% optionally at least 7 mol-% of all R⁵ moieties of a given siloxane type (T or M) are R^{5S} moieties in the absence of step (f). Alternatively, step (f) is optional if the material comprises 0 mol-% R^{5S} and/or 0 mol-% R^{1′} and/or R³ moieties. Of course, step (f) can be carried out even if the T-type siloxane moieties and silanes of step (a2) and/or (b3) already lead to a product comprising R^{5S}, R^{1′} and/or R³ residues, e.g. to increase the molar percentage of functionalized R⁵ and/or R¹ residues.

Optionally, step (f) can also be performed between steps (d) and (e) and the sequence of steps (e) and (f) are optionally interchangeable.

In a disclosure, the method described herein is one, wherein
in step (a), the R⁵ of the T- and/or D-type siloxane moiety is R^{5U};
in step (b), the R⁵ of the T- and/or D-type silane is R^{5U}; and
the method comprises the step (f) of functionalizing the R^{5U} residues of the polymeric liquid material to obtain at least 1 mol-%, optionally at least 3 mol-%, optionally at least 5 mol-% optionally at least 7 mol-% R^{5S} residues relative to all R⁵ residues.

In a disclosure, the method according described herein is one, wherein
in step (a), the R¹ of the D- and/or T-type siloxane moiety is methyl, ethyl, propyl, R³ or R^{1′};
in step (b), the R¹ of the D- and/or T-type siloxane moiety is methyl, ethyl, or propyl; and
the method comprises the step (f) of modifying the R¹ residues of the polymeric liquid material to obtain at least 0.05 mol-%, optionally at least 0.15 mol-%, optionally at least 0.4 mol-%, optionally at least 1 mol-% R³ residues relative to all R¹ residues and/or modifying the R¹ residues of the polymeric liquid material to obtain 0.5 to 25 mol-%, optionally 1 to 20 mol-% R^{1′} residues relative to all R¹ residues.

In a disclosure, the method according described herein is one, wherein
in step (a), the R⁵ of the T- and/or D-type siloxane moiety is R^{5U};
in step (b), the R⁵ of the T- and/or D-type silane is R^{5S}; and
the method does not comprise the step (f).

In a disclosure, the method according described herein is one, wherein
in step (a), the R⁵ of the T- and/or D-type siloxane moiety is R^{5U};
in step (b), the T- and/or D-type silane comprises both R^{5S} and R^{5U}; and
the method comprises the step (f) of modifying the R^{5U} residues of the polymeric liquid material to obtain at least 1 mol-%, optionally at least 3 mol-%, optionally at least 5 mol-% optionally at least 7 mol-% R^{5S} residues relative to all R^{5U} residues.

The choice of R^{5S}-functionalized or non-R^{5S}-functionalized T- and/or D-type siloxane moieties and silanes of step (a2) and (b3) can be any choice that, together with optional steps (e) and (f), leads to a polymeric liquid material, wherein at least 1 mol-%, optionally at least 3 mol-%, optionally at least 5 mol-% optionally at least 7 mol-% of all R⁵ moieties of a given siloxane type (T or M) are R^{5S} moieties. It is within the purview of the skilled person to routinely implement any permutations in the choice of starting materials and further functionalization reaction in the context of R⁵ moieties.

The concept of the chemical R^{5S}, R^{1′} and R³-functionalization protocol variability is illustrated here for illustrative purposes by showing different structural variations thereof in the form of chemical 2D representation formulas:
i) The case of R^{5S} chemical modification on R⁵-amine substituents is shown for a Y^{1f} acrylate Q-T type material comprising only ethoxy/methoxy R¹ substituents (FIG. 3a)
ii) The case of R^{5S} chemical modification on R⁵-amine substituents is shown for a combined (Y^{2g}/R⁴-L-Y^{2g}) isocyanate and iso-prepolymer chemistry For a Q-type, T-type, D-type and M-type mixed material shown in a general form with unspecified R¹ substituents (FIG. 3b)
iii) The case of R^{5U} unmodified material with free R⁵-amine substituents but R^{1′} polyol modification is shown for Q-T type material with ethoxy R¹ substituents (FIG. 4a)
iv) The case of R^{5S} chemical modification on R⁵-amine substituents with Y³ anhydride modification chemistry is shown for a material featuring multiple amine moiety types (two T-type (3-aminopoyltrialkoxysilyl), (N-(2-aminoethyl)-3-aminopropyltrialkoxysilyl) and one D-type (N-(2-aminoethyl)-3-aminopropylmethyldialkoxysilyl)) with mixed ethoxy and methoxy R¹ ligands as well as R³ (STP) modification.

Spectral analysis of the grafting is done by example of the MPDDA diacrylate grafting on an R^{5U} (APTMS) T-type aminosiloxane material. ¹H NMR analysis shows the spectra of the MPDDA reference material (FIG. 6a, top), the T-type amino-bearing R^{5U} material before the reaction and (FIG. 6b, middle) and finally the Micheal addition reaction product, that is the Y¹—R^{5S} functionalized liquid polysiloxane material (FIG. 6c), demonstrating successful functionalization.

Analogously, ¹³C NMR spectra of the MPDDA acrylate raw material (FIG. 7a, top), the R^{5U} T-type aminosiloxane material (FIG. 7b, top) and the Y¹—R^{5S} functionalized liquid polysiloxane material (FIG. 7c) are also shown.

The product of the present method is retrieved in step (g) by collection of the material from the reaction vessel. The product may optionally be isolated and purified by standard methods known in the art, e.g. by distillation, optionally using a thin film evaporator, VOC removal by stripping with a purge gas etc.

In a disclosure, the method according described herein is one, wherein after step (d) or (e), the method further comprises the step of adding a tri-organofunctional M-type silane Si(OR¹)(Me)₃ or M-type siloxane (Me)₃Si—O—Si(Me)₃ and optionally a di-organofunctional D-type silane in mono- or oligomeric form as described in step (b2) in the presence of water and a suitable co-solvent and an acid catalyst, followed by heating the mixture, optionally to reflux.

If the addition takes place before step (b), water is removed before step (b) is initiated.

For example, solvents for adding a tri-organofunctional M-type silane and/or optionally a di-organofunctional D-type siloxane can be selected from the group consisting of ethanol, methanol, n-propanol, isopropanol, acetone, methyl-ethyl ketone, dimethyl ether, methyl-ethyl ether, diethyl ether.

For example, an acid catalyst can be selected from strong acids with a negative pKa value, e.g. selected from the group consisting of hydrochloric acid, nitric acid, sulfuric acid, methanesulfonic acid, benzene sulfonic acid, hydrobromic and hydroiodic acid.

In a disclosure, the reaction temperature for steps (c) through (e) of the method described herein is in the range from 30 to 170, optionally 50 to 150 or 70° C. to 120° C., and the pressure during steps (c) through (e) is in the range of 0.1 bar to 2 bar, optionally in the range of 0.5 bar to 1.4 bar or in the range of 0.6 bar to 1.2 bar.

The step of optionally functionalizing (f) is not necessarily performed at elevated temperatures, even if the step is performed before step (e). It is common general knowledge which reaction temperatures are necessary for which type of R^{5S}-functionalization reaction in step (f).

In a further disclosure, the rearrangement catalyst for use in the present method is selected from the group consisting of
Ti(IV)(OR¹³)₄ and Zr(IV)(OR¹³)₄;
Ti(IV)X₄ and Zr(IV)X₄;
O=Ti(IV)X₂ and O=Zr(IV)X₂);
Ti(IV)X₂(OR¹³)₂ and Zr(IV)X₂(OR¹³)₂;
Ti(IV)X₂(OAcAc)₂ and Zr(IV)X₂(OAcAc)₂;
Ti(IV)(OSi(CH₃)₃)₄ and Zr(IV)(OSi(CH₃)₃)₄;
(R¹³O)₂Ti(IV)(OAcAc)₂ and (R¹³O)₂Zr(IV)(OAcAc)₂;
O=Ti(IV)(OAcAc)₂ and O=Zr(IV)(OAcAc)₂;
Ti(IV)(OAc)₄ and Zr(IV)(OAc)₄;
Ti(IV)(OAc)₂(OR¹³)₂ and Zr(IV)(OAc)₂(OR¹³)₂; and
O=Ti(IV)(OAc)₂ and O=Zr(IV)(OAc)₂;
   wherein R¹³ is selected from the group consisting of —CH₃, —CH₂CH₃, —CH(CH₃)₂, —CH₂CH₂CH₃, —C(CH₃)₃, —CH₂CH₂CH₂CH₃ and CH₂CH₂CH(CH₃)₂ and wherein X is a halide, a pseudohalide, nitrate, chlorate or perchlorate anion, and wherein the catalyst amount in each of steps (a) or (c) is optionally between 0.01 and 5 mol-%, optionally between 0.05 or 0.1 to 3 mol-%, based on the total molar silicon content present in said step.

Also disclosed herein is a product obtainable by the method described herein, wherein optionally T⁰ and/or D⁰ monomers are added after the production of the material to the total amount of 0 to 30 mol % with respect to the total number of Si atoms in the material each, respectively.

In another aspect, the present invention is directed to a product obtained or obtainable by any of the methods described herein.

The following Figures and Examples serve to illustrate the invention and are not intended to limit the scope of the invention as described in the appended claims.

### FIGURES

FIG. 1(a) shows an exemplary 2D molecular structure representations of a typical R^{5U} unfunctionalized material with T-type moieties only and ethoxy/methoxy R¹ residues. (b) shows an exemplary 2D molecular structure representations of a typical R^{5U} unfunctionalized material with T-type, D-type and M-type moieties with in its general form with unspecified R¹ residues.

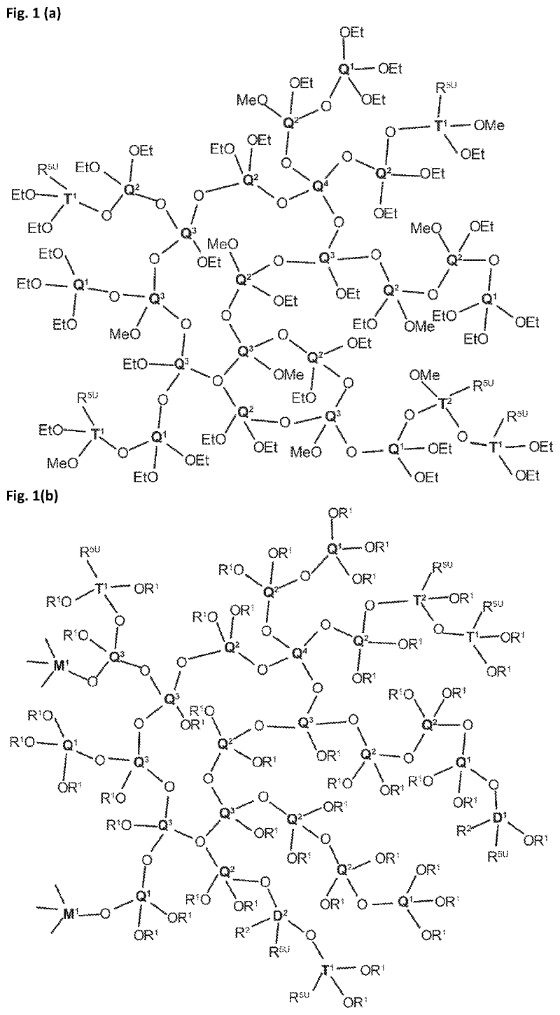

FIG. 2 shows an exemplary 2D molecular structure representation of a typical pure Q-type precursor material or core in a general case featuring T and D-type siloxane moieties and some silanol groups.

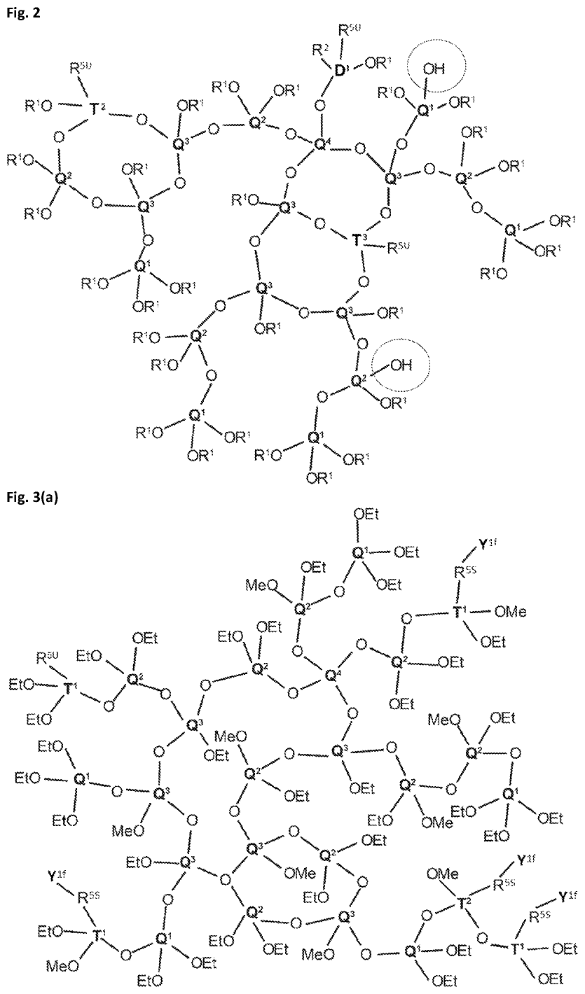

FIG. 3(a) shows an exemplary 2D molecular structure representation of a partially Y^{1f} (acrylate) R^{5S} functionalized material with T-type moieties only and ethoxy/methoxy R¹ residues. The functionalization bonding is shown schematically. (b) shows an exemplary 2D molecular structure representation of a completely Y^{2g} and R⁴-L-Y^{2g} (isocyanate and isocyanate terminated prepolymer) R^{5S} functionalized material with T-type, D-type and M-type moieties in its general form with unspecified R¹ substituents. The functionalization bonding is shown schematically.

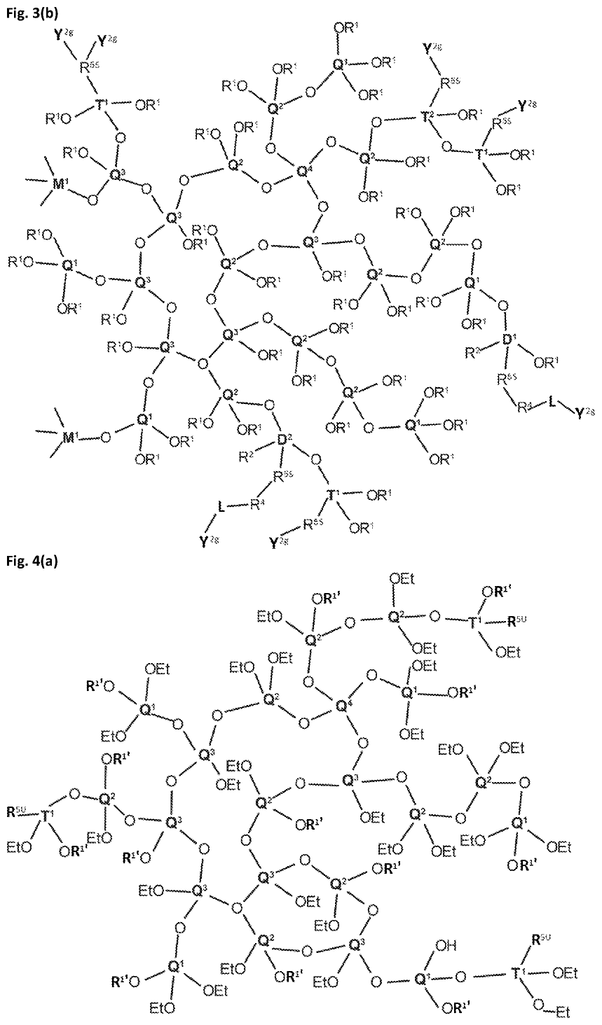

FIG. 4 (a) shows an exemplary 2D molecular structure representation of an R^{5S} unfunctionalized material with T-type moieties only and ethoxy R¹ residues comprising also R^{1′} polyol functionalization. (b) shows an exemplary 2D molecular structure representation of a Y^{3f} (anhydride) R^{5S} functionalized material featuring two T-type (3-aminopoyltrialkoxysilyl), (N-(2-aminoethyl)-3-aminopropyltrialkoxysilyl) and one D-type (N-(2-aminoethyl)-3-aminopropylmethyldialkoxysilyl) moieties including full bonding details of the R^{5S} amine groups. The exemplary material further comprises mixed ethoxy and methoxy R¹ residues as well as R³ (STP) modification. (c) shows an exemplary 2D molecular structure representation of a material comprising two types of R^{5S} functionalizations using the same reactant acrylic acid which took place on two non-identical R^{5U} substituents, namely a first (Michael addition) of acrylic acid on a 3-aminopoyldialkoxysilyl T-type substituent and R⁸=acrylic acid modification on a 3-glycidoxypropylalkoxysilyl substituent. The material further comprises R³ (STP) modification.

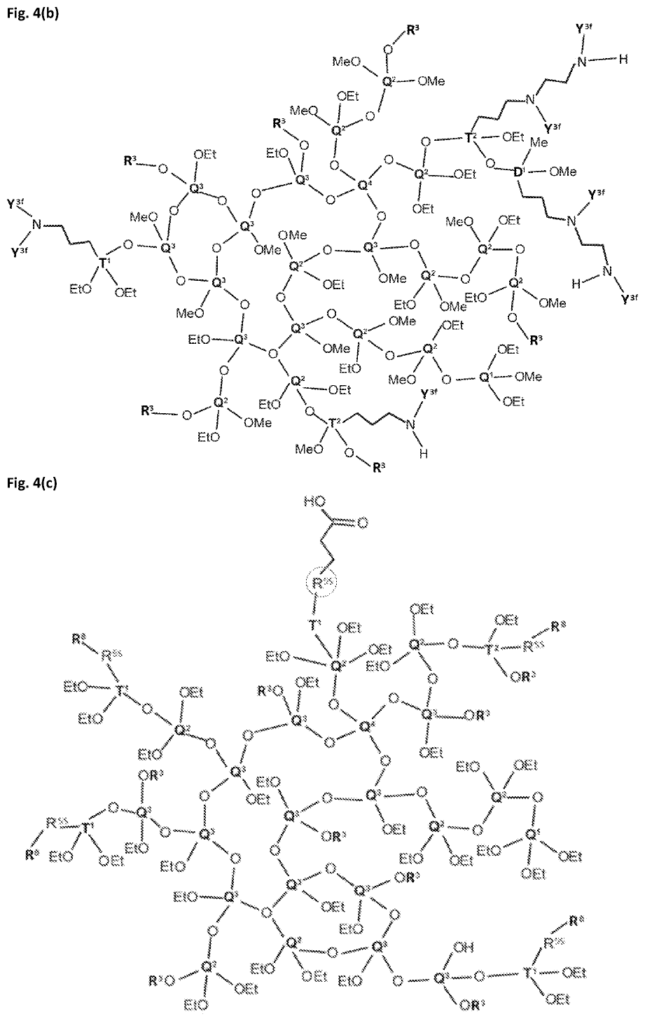

FIG. 5 shows ²⁹Si NMR analysis of a material according to Example 2e, detailing the Q-type polysiloxane precursor (FIG. 5(a)), the R^{5U} T-type bearing polysiloxane material (FIG. 5(b)) and the Y¹—R^{5S} functionalized reaction product (FIG. 5(c)).

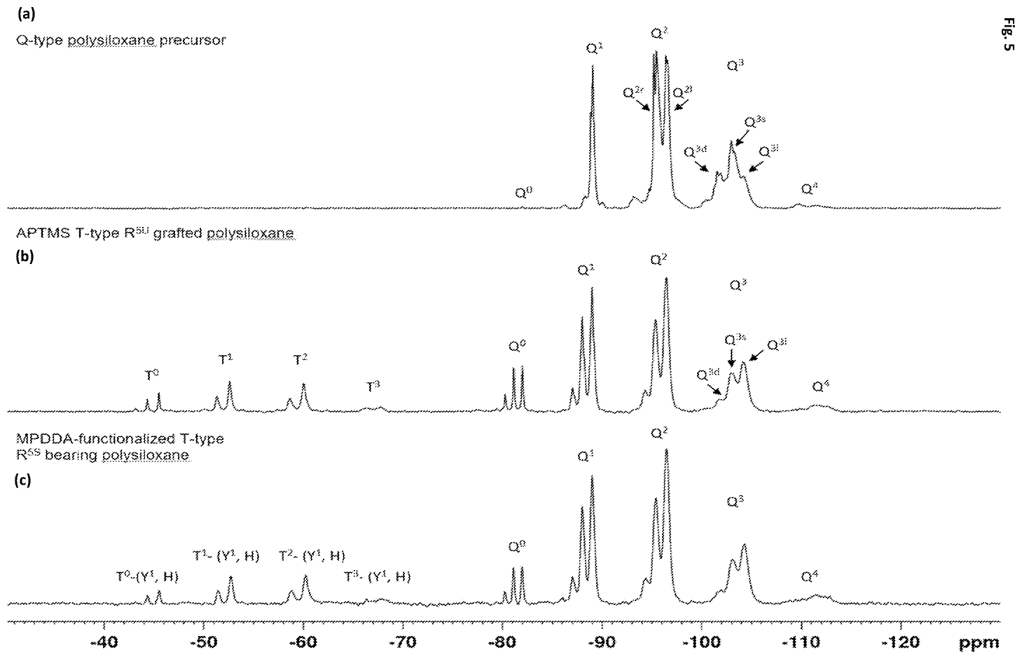

FIG. 6 shows ¹H NMR analysis of a material according to Example 2e, detailing the MPDDA acrylate reference material (FIG. 6(a)), the R^{5U} T-type bearing polysiloxane material (FIG. 6(b)) and the Y¹—R^{5S} functionalized reaction product (FIG. 6(c)).

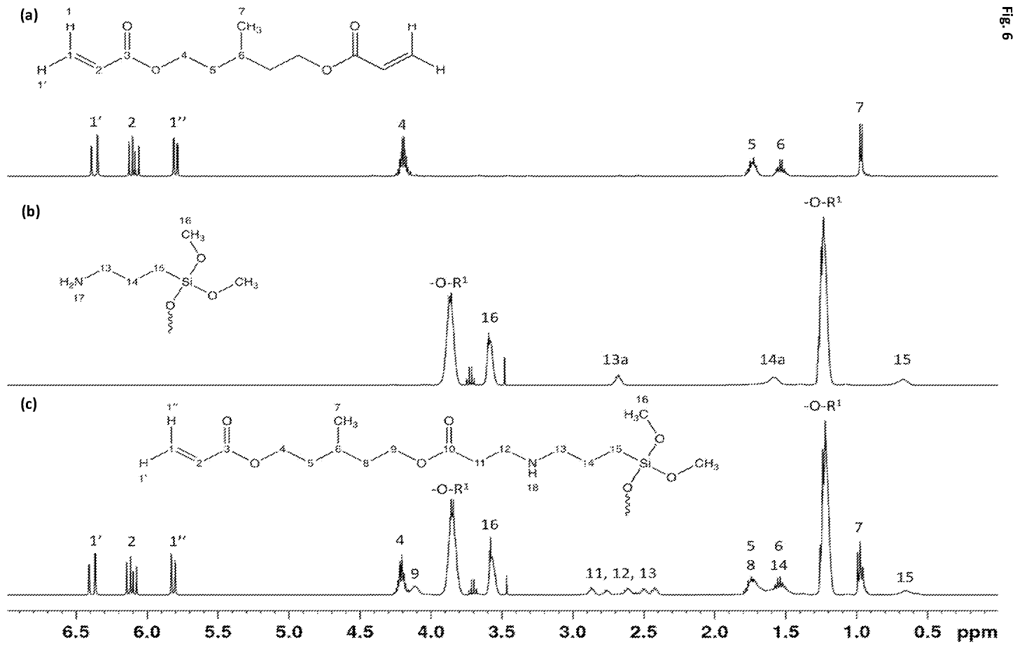

FIG. 7 shows ¹³C NMR analysis of a material according to Example 2e, detailing the MPDDA acrylate reference material (FIG. 7(a)), the R^{5U} T-type bearing polysiloxane material (FIG. 7(b)) and the Y¹—R^{5S} functionalized reaction product (FIG. 7(c)).

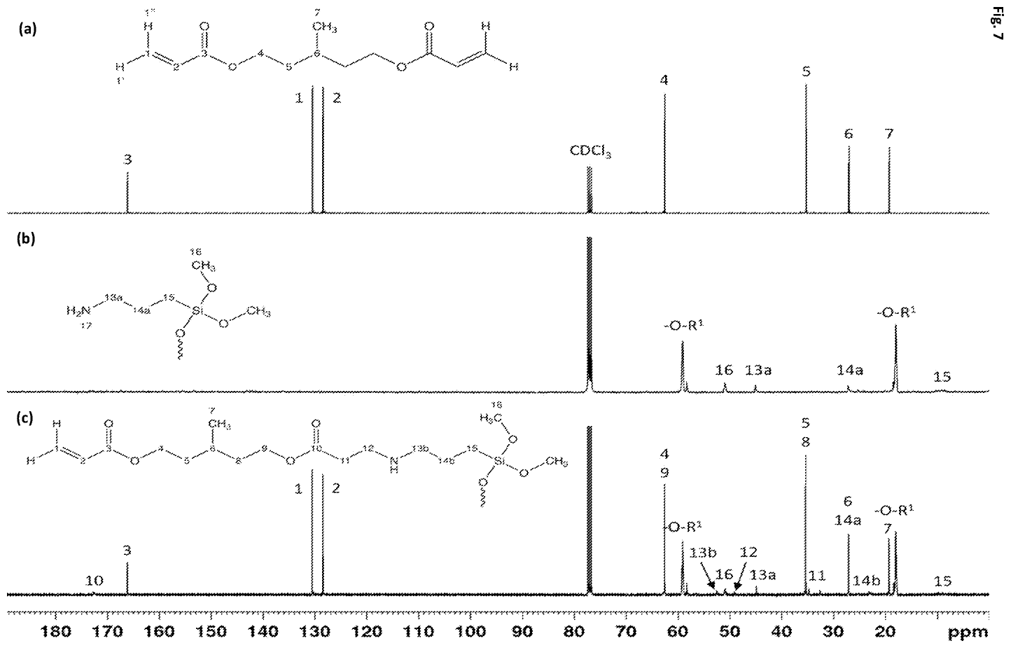

### EXAMPLES

In all examples, the mol-percentage of (tetrasiloxane) ring species refers to the sum of all Q² and Q³ ring species relative to the total number of Q species also referred herein as % (Q^{2r}&Q^{3s,d}) ring species unless specifically mentioned otherwise. Examples are structured as follows:

### Example 1a: Synthesis of an R⁵-Unfunctionalized D-50/APTES Polycondensate Material with n_{Q-type}:n_{T-type}=1:0.08

784.9 g/6.14 mol Si equivalent of a commercial ethylsilicate Q-type precursor “Dynasylan Silbond 50 (D-50)” (Evonik Industries) or equivalent was placed inside a 2 L stirred glass reactor with refluxing column in an oil bath together with 108.7 g/0.49 mol of a monomeric T-type precursor 3-Aminopropyltriethoxysilane (APTES). The mixture was heated to a temperature of 120° C. at which point a rearrangement catalyst Tetrakis(trimethylsiloxy)titanium(IV) was added to the hot mixture. The mixture was kept stirring for a period of 18 hours. Residual volatiles were then removed by replacing the reflux condenser by a distillation bridge and distilling it off. ²⁹Si NMR analysis confirmed that the product contained less than 11% T⁰-monomer measured by the total amount of T-type and moieties, respectively as well as less than 19.1% of Q-type tetrasiloxane ring species.

### Example 1b: Synthesis of an R⁵-Unfunctionalized D-50/ABTES Polycondensate Material with n_{Q-type}:n_{T-type}=1:0.22

The same procedure shown in the above Example 1s used with the difference that 4-aminobutyltriethoxysilane was used as the T-type precursor the amount added was accordingly 318 g/1.35 mol. The reaction temperature and time were adjusted to 105° C. and 26 hours and Zr(IV)-oxynitrate was used as the rearrangement catalyst. ²⁹Si NMR analysis confirmed that the product contained less than 15% T⁰-monomer measured by the total amount of T-type and moieties, respectively as well as less than 22.7% of Q-type tetrasiloxane ring species.

### Example 1c: Synthesis of an R⁵-Unfunctionalized TEOS/(APTMS) Polycondensate Material with n_{Q-type}:n_{T-type}=1:0.15

720 g of a Q-type precursor with a DP_Q_{type} of 2.16 and 43.2% ring species prepared by nonhydrolytic condensation of tetraethoxysilane (TEOS) with acetic anhydride in the presence of a Titanium(IV) isopropoxide rearrangement catalyst were placed inside a 1 L Pyrex glass bottle with cap and then 159.4 g/0.92 mol of a monomeric T-type precursor 3-Aminopropylrimethoxysilane (APTMS) was mixed in without further rearrangement catalyst addition. The flask was then capped and placed inside a heating cabinet set at 105° C. and kept there for a period of 36 hours. Residual volatiles were removed bubbling dry nitrogen through the product for a period of 24 hours at a temperature of 60° C. ²⁹Si NMR analysis confirmed that the product contained less than 8.8% of total T⁰-monomer measured by the total amount of T-type moieties, respectively as well as less than 22% of Q-type tetrasiloxane ring species.

### Example 1d: Alternative Synthesis of an R⁵-Unfunctionalized D-40/(APTMS) Polycondensate Material with n_{Q-type}:n_{T-type}=1:0.12

The exact same synthesis procedure as in Example 1c above was used to prepare the material, with the difference that the Q-type precursor had been prepared by acid catalyzed hydrolytic condensation of a commercial ethylsilicate Q-type precursor “Dynasylan 40 (D-40)” (Evonik Industries) and had a DP_{Qtype} of 1.95 and 46.7% ring species. The amount of the T-type precursor 3-Aminopropylrimethoxysilane (APTMS) was adjusted accordingly to account for the lower n_{Q-type}:n_{T-type}=1:0.12 ratio (127.5 g/0.74 mol of APTMS added) and Tetrakis(trimethylsiloxy)titanium(IV) was added as a rearrangement catalyst. ²⁹Si NMR analysis confirmed that the product contained less than 5.6% of total T⁰-monomer measured by the total amount of T-type moieties, respectively as well as less than 21.4% of Q-type tetrasiloxane ring species.

### Example 1e: Alternative Synthesis of an R⁵-Unfunctionalized TEOS/(APTMS:APMDCS) Polycondensate Material with n_{Q-type}:(n_{T-type}:n_{D-type})=1:(0.05:0.04)

The exact same synthesis procedure as in Example 1d above was used to prepare the material, with the main difference that Q-type precursor already contained some D-type grafted siloxane units introduced via a D-type monomer 3-Aminopropylmethyldichlorosilane (APMDCS) with n_{Q-type}:n_{D-type}=1:0.04 during its preparation and that additional Fe(III)chloride was added as a rearrangement catalyst. ²⁹Si NMR analysis confirmed that the product contained less contained less than 9% T⁰-monomer and less than 8% of D⁰-monomer measured by the total amount of T-type and D-type moieties, respectively, as well as less than 24.2% of Q-type tetrasiloxane ring species.

### Example 1f: Synthesis of an R⁵-unfunctionalized TMOS/(APTMS:APMDES) polycondensate material with n_{Q-type}:(n_{T-type}:n_{D-type})=1:(0.05:0.10)

An amount containing 3.25 mol Si equivalent of a Q-type precursor prepared by controlled hydrolysis of TMOS and a DP_{Qtype} value of 1.81 and 41.9% ring species of was placed inside a hermetically sealed stirred glass reactor (Büchi versoclave, 11) set to a temperature of 125° C. Next, 29.1 g/0.16 mol of a T-type monomer precursor, respectively, were added to the hot autoclave together with a 47.8 g/0.32 mol of a D-type precursor 3-Aminopropylmethyldimethoxysilane (APMDES) and Titanium(IV)-propoxide as a catalyst. The mixture was kept at temperature with stirring for 9.5 hours and then removed from the heating source and allowed to cool to room temperature. ²⁹Si NMR analysis confirmed that the product contained less than 13% T⁰-monomer and less than 12% of D⁰-monomer measured by the total amount of T-type and D-type moieties, respectively, as well as less than 23.8% of Q-type tetrasiloxane ring species.

### Example 1g: Synthesis of an R⁵-Unfunctionalized TMOS/APMDES Polycondensate Material with n_{Q-type}:n_{D-type}=1:0.10

A procedure similar to Example 1f above was used to prepare the material, with the main difference that only a D-type precursor was used for rearrangement grafting. ²⁹Si NMR analysis confirmed that the product contained less than 14.5% of total D⁰-monomer measured by the total amount of D-type moieties, respectively as well as less than 24.0% of Q-type tetrasiloxane ring species and less than 47.2% of % (Q^{3s,d})/Q³ ring species.

### Example 1h: Synthesis of an R⁵-Unfunctionalized TMOS/Ethylsilicate-40/TPOS/(AEAPTMS:APMDMS) Polycondensate Material with n_{Q-type}:(n_{T-type}:n_{D-type})=1 (0.20:0.03)

2.15 mol Si equivalent of a Q-type precursor was prepared by controlled hydrolysis of a TMOS, ethylsilicate (Wacker TES 40 WN) and TPOS mixture in a molar ratio of 0.2:0.7:0.1. A first rearrangement pre-grafting step was carried out by mixing said precursor with 10.5 g/0.065 mol of a D-type precursor 3-Aminopropylmethyldimethoxysilane (APMDMS) in the presence of bis-acetylacetonato-titanium(IV)-diisopropoxide as the rearrangement catalyst. The mixture was then heated in a stirred steel reactor vessel to a temperature of 110° C. and kept for 3 hours. For the second grafting step, 95.6 g/0.43 mol of a T-Type precursor N-(2-Aminoethyl)-3-aminopropyltrimethoxysilane (AEAPTMS) was added and the reaction was again carried out for an additional 22 hours in the same reactor. The finished reaction product was isolated and residual volatiles removed by means of a thin film evaporator setup. ²⁹Si NMR analysis confirmed that the product contained less than 15% of T⁰-monomer and less than 13% D⁰-monomers measured by the total amount of T-type and D-type moieties, respectively, and less than 23.6% of Q-type tetrasiloxane ring species.

### Example 1i: Synthesis of an R⁵-Unfunctionalized Ethylsilicate-40/(3-MPTMS/APMDMS) Polycondensate Material with n_{Q-type}:(n_{T-type}:n_{D-type})=1:(0.08:0.08)

The exact same procedure as in Example 1h was used with the difference that O=Zr(IV)(NO₃)₂ was used as rearrangement catalyst and that the Q-type precursor (2.15 mol Si equivalent) was made from Ethylsilicate-40 (Chinese commercial supplier) only. Also the T-type silane type (3-mercaptopropyltrimethoxysilane (3-MPTMS)) as well as the molar amounts of grafted T- and D-type moieties were different. ²⁹Si NMR analysis confirmed that the product contained less than 9.5% of total T⁰-monomer and less than 13.1% of total D⁰-monomer measured by the total amount of T-type and D-type moieties, respectively, measured by the total amount of T-type moieties and less than 22.9% of Q-type tetrasiloxane ring species.

### Example 1j: Synthesis of an R⁵-Unfunctionalized TEOS/APTES+AHAPTMS/AEAiBMDMS Polycondensate Material with n_{Q-type}:(n_{T-type}:n_{D-type})=1:(0.08+0.05:0.05)

A Q-type precursor was prepared from TEOS (2.15 mol, 447.2 g) by non-hydrolytic acetic anhydride condensation in the presence of Ti(IV)butoxide with a DP_{Qtype} value of 2.38. Next, two T-type precursors aminopropyltriethoxysilane (APTES, 38.1 g, 0.17 mol) and N-(6-Aminohexyl) aminopropyl-trimethoxysilane (AHAPTMS, 30.0 g, 0.11 mol) as well as a D-type precursor N-(2-Aminoethyl)-3-aminoisobutylmethyldimethoxysilane (AEAiBMDMS) in an amount of 105.7 g/0.48 mol were added. All reagents were combined and heated to 85° C. in a closed and sealed plastic vessel and allowed to react for 48 hours. ²⁹Si NMR analysis of the isolated rearrangement product confirmed that it contained less than 12% T⁰-monomer and less than 13% of D⁰-monomer measured by the total amount of T-type and D-type moieties, respectively, as well as less than 20.7% of Q-type tetrasiloxane ring species.

### Example 1k: Synthesis of an R⁵-Unfunctionalized SiCl₄/AEDMMSP-EDA Polycondensate Material with n_{Q-type}:n_{D-type}=1:0.04

In a gastight glass reactor, an amount of a 1:12 water/ethanol (molar ratio) mixture was placed with stirring and cooled to 0° C. in an ice bath then, an amount of 5.2 mol of silicon tetrachloride was added dropwise over the course of 90 minutes. The amount of the water ethanol solution was chosen as to yield a theoretical degree of polymerization of the precursor DP_{Qtype} value of 2.19. During the reaction, HCl gas was continuously removed from the mixture by a constant stream of nitrogen. After the addition of SiCl₄ was complete, the reaction mixture was allowed to stir for an additional 4 hours with continuing nitrogen flow. Residual HCl was removed by vacuum and in the end, again nitrogen purging of the Q-type precursor reaction product. The Q-type precursor had a DP_{Qtype} value of 2.08 as determined by ²⁹Si NMR analysis.

To the Q-type precursor prepared in this way an amount of D-type precursor N-(2-Aminoethyl)-N′-[3-(dimethoxymethylsilyl)propyl]-1,2-ethanediamine (AEDMMSP-EDA) was then added (90.8 g/0.36 mol) together with a rearrangement catalyst ZrIV) isopropoxide. The mixture was then heated to a temperature of 110° C. and kept stirring for a period of 25 hours. After completion of the reaction, ²⁹Si NMR analysis confirmed that the product contained less than 12.7% of total D⁰-monomer measured by the total amount of D-type moieties and less than 21.7% of Q-type tetrasiloxane ring species.

### Example 1l: Synthesis of an R⁵-Unfunctionalized SiCl₄/Oligo-APTMS Polycondensate Material with n_{Q-type}:n_{T-type}=1:0.27

1.09 mol Si equivalent of a Q-type precursor prepared according to Example 1j was placed inside a 11 round bottom flask and heated to 97° C. with stirring. Next, 43.8 g/0.29 mol of aminopropyltrimethoxysilane oligomer (oligo-APTMS) was added together with Hf(NO₃)₄ as s rearrangement catalyst. ²⁹Si NMR analysis confirmed that the product contained less than 6.2% of total T⁰-monomer measured by the total amount of T-type moieties, respectively, and less than 19.0% of Q-type tetrasiloxane ring species.

### Example 1m: Synthesis of an R⁵-Unfunctionalized Ethylsilicate-40/APTMS Polycondensate Material with n_{Q-type}:n_{T-type}=1:0.08

3.1 mol Si equivalent of a Q-type precursor with a DP_{Qtype} value of 2.31 was prepared by controlled hydrolysis of Wacker Silicate TES40 WN (Wacker) at 110° C. and inside a stirred glass reactor. Next, 33.1 g/0.18 mol of aminopropyltrimethoxysilane was added together with Ti-isopropoxide as a rearrangement catalyst with stirring. The reaction mixture was kept at temperature for 22 hours under nitrogen. ²⁹Si NMR analysis confirmed that the product contained less than 9.6% of total T⁰-monomer measured by the total amount of T-type moieties, respectively, and less than 22.9% of Q-type tetrasiloxane ring species.

### Example 1n: Synthesis of an R⁵-Unfunctionalized Ethylsilicate-40/GPTMS Polycondensate Material with n_{Q-type}:n_{T-type}=1:0.12

5.5 mol Si equivalent of a Q-type precursor with a DP_{Qtype} value of 2.06 was prepared from ethylsilicate and placed inside a stirred batch reactor. Next, 156.0 g/0.66 mol of 3-glycidoxypropyl-trimethoxysilane was added together with Ti(IV)-isobutoxide as a rearrangement catalyst under vigorous stirring. The reaction mixture was then heated to 103° C. and kept stirring at temperature for 29.5 hours under inert atmosphere. ²⁹Si NMR analysis confirmed that the product contained less than 11.0% of total T⁰-monomer measured by the total amount of T-type moieties, respectively, and less than 21.6% of Q-type tetrasiloxane ring species.

### Example 1o: Synthesis of an R⁵-Unfunctionalized TEOS/3-MPTES Polycondensate Material with n_{Q-type}:n_{T-type}=1:0.04

13.8 mol Si equivalent of a Q-type precursor with a DP_{Qtype} value of 1.88 was prepared by nonhydrolytic condensation of tetraethoxysilane (TEOS, Dynasylan A, Evonik Industries) with acetic anhydride in the presence of a Titanium(IV) isopropoxide rearrangement catalyst at 125° C. inside a glass lined steel reactor. Next, 108.4 g/0.55 mol of 3-mercaptopropyltrimethoxysilane (3-MPTMS, Dynasylan MTMO, Evonik Industries) was added with stirring. The reaction mixture was kept at temperature for 19 hours under nitrogen. ²⁹Si NMR analysis confirmed that the product contained less than 12.3% of total T⁰-monomer measured by the total amount of T-type moieties, respectively, and less than 23.7% of Q-type tetrasiloxane ring species.

### Example 2

First, the general functionalization protocol for both variants “on polysiloxane” or by means of the prior R^{5S} functionalized “T⁰ grafting” or “D⁰ grafting” are described hereafter. Then selected examples of preparing R^{5S} functionalized materials are summarized in the table below. The effectively used stoichiometry of the Y groups to total R^{5U} functional groups in the synthesis protocol is of importance for defining the final state of the material and is denoted Y/R^{5U} ratio. In the following examples, this ratio is defined as the molar ratio of Y divided by the total number of moles functional unreacted T- and D-type moieties R^{5U} in the polysiloxane material before functionalization.

Organic R^{5S}-Functionalisations with Y¹ Through Y⁴ Functionalities Employing a “on Polysiloxane” Protocol
In a typical experiment, the a polycondensate material according to the above examples comprising a polymeric liquid polysiloxane material as described herein is either used neat or dissolved in a solvent if so desired. The Y-functionalization is then carried out by mixing the two compounds or solutions in a desired Y/A stoichiometric ratio and reacting them at a given reaction temperature for a (experimentally determined) reaction time (TR). If a solvent is used, the solvent is typically removed by distillation or may be left in if used in a formulation of which it can be a part of. As a general rule of thumb, the material which is the stoichiometrically limiting component is the one being dosed to the component which is present in excess. The reaction is then kept at a desired reaction temperature with stirring for a desired reaction time (TR), if needed in the presence of a suitable catalyst. Depending on the type of reaction, a workup and purification step may be necessary.
Organic R⁵-Functionalisations with Y¹ Through Y⁴ Functionalities Employing a “T⁰ Grafting” Protocol

In a typical experiment, an unfunctionalized R^{5U} bearing T⁰ monomer (or oligomer) is first functionalized using the following protocol:

The “R^{5U} T⁰ monomer” is preferably used neat but can also be dissolved in a solvent. It is then reacted with a suitable organic substrate that introduces the Y-function, specifically with Y¹ (diacrylates), Y² (di/triisocyanates), Y³ (anhydrides) and Y⁴ (epoxides). Typically, the molar ratio of Y/A is adjusted in such a way that there is a significant excess of Y functionality and is calculated separately for this step. The aminosilane dosed to the component which is present in excess, and if desired dissolved in a solvent [SO]. The reaction is then kept at a desired reaction temperature with stirring for a desired reaction time (TR), if needed in the presence of a suitable catalyst. Depending on the type of reaction, a workup and purification step may be necessary. The resulting R^{5S} functionalized T⁰ monomer can then be used for rearrangement grafting. The polysiloxane which the R^{5S} functionalized T⁰ monomer is grafted onto is described in the column “R5U unmodifed/Q-type precursor from example #”. In the following table, an example number followed by “precursor only” means that the rearrangement grafting is done onto a Q_Type precursor analogue only (without the R^{5U} aminosilane grafting step being performed) used in the corresponding example 1 case. Accordingly, an example number followed by “R^{5U} material” means that it is grafted onto a previously prepared Q-(T,D) R^{5U} polysiloxane as it is obtained by following the corresponding Example preparation until the end.

| | | R^{5U} | | | | | | | |
|---|---|---|---|---|---|---|---|---|---|
| | | unmodifed | | | | | | | |
| | | material/ | | | | | | | |
| | | precursor | | | | Y/ | | Reaction | |
| Example | Amine functional units | from | Organic | Y family | Y type | R^{5U} Ratio | Solvent | time | |
| # | [R5 monomer name(s)] | example # | modification | [Y1-Y4] | [formula #] | [Y/A] | [SO] | [TR] | Temp. |
| 2a | APTMS:APMDES | 1f | On Polysiloxane | Y2 | Y2a | 1:5 | acetone | 4 h | 25° C. |
| 2b | ABTES | 1b | On Polysiloxane | Y2 | HDI (2g, | 1.5:1 | | 2.75 h | −20° C. |
| | | | | | C6H12) | | | | |
| 2c | APTMS | 1c | On Polysiloxane | Y1 | Y1d, | 1:2 | | 16 h | r.t. |
| | | | | | q = 2 | | | | |
| 2d | AEAPTMS:APMDMS | 1h | On Polysiloxane | Y2 | Y2f | 5:1 | | 1 h | r.t. |
| | | | | | uretdione | | | | |
| 2e | APTMS | 1d | On Polysiloxane | Y1 | Y1f | 2.7:1 | | 22 h | r.t. |
| 2f | oligo-APTMS | 1\| | On Polysiloxane | Y4 | Y4d | 6.8:1 | | 12 h | 80° C. |
| 2g | APTMS:APMDCS | 1e | On Polysiloxane | Y3 | Y3g | 1.6:1 | MEK | 0.5 h | r.t. |
| 2h | APMDES | 1g | On Polysiloxane | Y3 | Y3c, R6 = | 0.8:1 | | 4 h | 40° C. |
| | | | | | —CH3 | | | | |
| 2i | AEAPTMS:APMDMS | 1h | On Polysiloxane | Y4 | Y4g | 3:1 | | 9 h | 65° C. |
| 2j | APTES | 1a | On Polysiloxane | Y1 | Y1n, (AA)* | 1:3.3 | | 24 h | r.t. |
| 2k | APTMS:APMDES | 1f | On Polysiloxane | Y4 | Y4a, r = 5 | 6.2:1 | | 20 h | 55° C. |
| 2l | AEDMMSP-EDA | 1k | On Polysiloxane | Y2 | Y2e | 7:1 | | 3.5 h | 0° C. |
| 2m | APTES + | 1j | On Polysiloxane | Y4 | Y4e | 8.5:1 | | 12 h | 75° C. |
| | AHAPTMS:AEAiBMDMS | | | | | | | | |
| 2n | AEDMMSP-EDA:(APTMS- | 2p | On Polysiloxane | Y3 | Y3f | 0.75:1 | | 2 h | 35° C. |
| 2n | Y3) | | | | | | | | |
| 2o | (APMDCS):AHAPTMS- | Precursor | T⁰ grafting | Y3 | Y3a | 1:9 | | 36 h | 85° C. |
| | Y3 | only, 1e | | | | | | | |
| 2p | (AEDMMSP- | R5U | T⁰ grafting | Y3 | Y3h | 1:13 | | 22 h | 100° C. |
| 2p | EDA):APTMS-Y3 | material, 1k | | | | | | | |
| 2q | APTMS-Y4 | Precursor | T⁰ grafting | Y4 | Y4b, | 3:1 | | 16 h | 105° C. |
| | | only, 1c | | | s = 10 | | | | |
| 2r | APMDES -Y4 | Precursor | T⁰ grafting | Y4 | Y4f | 1:2.7 | | 9 h | 115° C. |
| | | only, 1j | | | | | | | |
| 2s | AEAPTMS -Y3 | Precursor | T⁰ grafting | Y3 | Y3g | 1:1 | DMF | 48 h | 90° C. |
| | | only, 1\| | | | | | | | |
| 2t | APMDMS-Y3 | Precursor | T⁰ grafting | Y3 | Y3h | 1:3.5 | | 48 h | 90° C. |
| | | only, 1\| | | | | | | | |
| 2u | APTMS-Y3 | R5U | T⁰ grafting | Y3 | Y3d, R6 = | 2:1 | | 32 h | 100° C. |
| | | material, 1d | | | —CH2CH3 | | | | |
| 2v | AHAPTMS-Y4 | Precursor | T⁰ grafting | Y4 | Y4d | 1:1 | Ethanol | 72 h | 80° C. |
| | | only, 1a | | | | | | | |
| 2w | GPTMS -Y3 | 1n | On Polysiloxane | Y3 | Y3g | 1.2:1 | | 12 h | 85° C. |
| 2x | GPTMS -Y1 | 1n | On Polysiloxane | Y1 | Y1n (AA)* | 1:1 | | 6 h | 100° C. |
| 2y | (3-MPTMS-/ | 1i | On Polysiloxane | Y1 | Y1h | 2.7:1 | | 48 h | 25° C. |
| 2y | APMDMS)-Y1 | | | | | | | | |
| 2z | 3-MPTMS-Y4 | 1o | On Polysiloxane | Y4 | Y4d | 3.7:1 | | 9 h | 95° C. |
| 2za | 3-MPTMS-Y2 | 1o | On Polysiloxane | Y2 | Y2g (HDI) | 1.5:1 | Butyl | 6 h | 22° C. |
| | | | | | | | acetate | | |
| 2zb | 3-MPTMS-Y3 | 1o | On Polysiloxane | Y4 | Y4j | 5.9:1 | Acetone | 16 h | 50° C. |
| 2zc | (3-MPTMS/ | 1n | On Polysiloxane | R^{4′}-L-Y2 | Y2b, | 2.4:1 | Butyl | 24 h | 35° C. |
| 2zc | APMDMS)-Y3 | | | | L = PPG** | | acetate | | |
| 2zd | GPTMS-Y3 | R5U | T0 grafting | Y4 | Y3i | 1.6:1 | | 7 h | 125° C. |
| 2zd | | material, 1d | | | | | | | |
| 2ze | APTMS-Y4 & GPTMS-Y1 | Precursor | T0 grafting | Y4/Y1 | Y4d/Y1n | 1:1/1:1 | | 48 h | 85° C. |
| 2ze | | only, 1a | | | (MAA)*** | | | | |
| 2zf | 3-MPTMS-Y2/GPTMS-Y1 | Precursor | T0 grafting | Y2/Y1 | Y2f/Y1n | 1.5:1/1:1 | Butyl | 14 h | 90° C. |
| 2zf | | only, 1\| | | | (AA)* | | acetate | | |
| 2zg | APTMS-Y1/ | Precursor | T0 grafting | Y1/Y3 | Y1f/Y3e | 2.6:1/1.1:1 | | 26 h | 90° C. |
| 2zg | 3-MPTMS-Y3 | only, 1b | | | | | | | |

*AA = acrylic acid
**PPG = polypropylene glycol
***MAA = Methacrylic acid

Note that example 2n represents a model example for carrying out multiple consecutive functionalisations, that is first a material 2p was prepared by T⁰ grafting of a APDMS-Y³ functionalized monomer onto a material which already contains non-functionalised AEDMMSP-EDA R^{5U} D-type moieties which are then later functionalized by means of reaction with a further anhydride Y³ (Y^{3f}). These types of dual or even multiple subsequent modification strategies can be employed to combined multiple amino and Y functionalities in a material.

### Example 3

The modification of polyol (R^{1′}) and STP (R³) modification is described herein.

### Example 3a: Preparation of an R^{1′} Modified Macro-Polyol Material

90 g Albodur 904 polyol and 10 g of reaction product from Example 1l were placed inside a round bottom flask with heater and reflux condenser. The mixture was then heated with stirring to a temperature of about 110° C. After a short time, alcohol evolution/bubbling started. The reaction was kept for 7 hours, during which time, approximately 2.5 g of alcohol condensate was distilled off and the viscosity continuously increased. A viscous liquid was retrieved as the reaction product.

### Example 3b: Preparation of an Alternative R^{1′} Modified Macro-Polyol Material

A protocol identical to the one described above was used, but as a polyol, 250 g of a polypropylene glycol (PPG) diol with 2500 Dalton molecular weight prepared by DMC catalyzed synthesis was combined with 18 g of a reaction product from Example 1j. The reaction was carried out over a period of 9 hours and 4.2 g of distillate was retrieved.

### Example 3c: Preparation of an R³ Modified Poysiloxane-STP Hybrid Material

A STP material was prepared by first preparing an isocyanate terminated prepolymer from combining a PPG diol with 8,000 molecular weight prepared by DMC catalyzed synthesis with a 0.95 mol equivalent (based on OH number) of a Desmodur VK5 with 0.1% DABCO as a catalyst and placing the mixture inside a heating cabinet at 75° C. for 12 h. The iso-prepolymer was then converted into the STP by reacting it slowly with a 1:1 equimolar amount of aminoproplytrimethoxysilane (APTMS) which was added dropwise to the prepolymer with stirring. The STP was then combined in equal parts (by weight) with a reaction product from Example 1c, mixed and kept again inside the heating cabinet at 80° C. for a period of 30 hours. A clear homogeneous viscous liquid was obtained in this way.

### Example 3d: Alternative Preparation of an R³ Poysiloxane-STP Hybrid Material

60 g of a commercial STP material Geniosil STP-E30 (Wacker) was combined with 35 g of a reaction product from Example 1f, homogenized and placed inside a heating cabinet at 80° C. for a period of 24 hours. A clear homogeneous viscous liquid was obtained in this way.

### Example 3e: Alternative Preparation of an R3 Poysiloxane-STP Hybrid Material

90 g of a pre-commercial STP material Si-PolyU XP 5013 (PolyU GmbH, Oberhausen) was mixed with 20 g of a reaction product from Example 11 and 15 g of a reaction product from Example 1k by means of a planetary mixer and placed inside a heating cabinet at 90° C. for a period of 20 hours. A clear homogeneous viscous liquid was obtained in this way.

### Example 4

Herein, various formulations comprising polymeric liquid materials are described. Unless otherwise noted, percentages indicated are always mass percentage.
Examples 4a, b, c, d refer to UV curable formulations as described herein.
Examples 4e, f, g refer to humidity curing formulations as described herein.
Examples 4g, h refer to 1K curable isocyanate formulations as described herein.
Examples 4i, j refer to 2K curable isocyanate formulations as described herein.
Examples 4k, I refer to 2K curable epoxy formulations as described herein.
Examples 4m, n refer to anhydride/Amide containing polymer resin formulations as described herein.
Examples 4o, p refer to concentrate-based emulsion/hydrolysate formulations as described herein.
Examples 4q, r refer to glass fiber sizing formulations as described herein.
Examples 4s, t refer to radical curable formulations as described herein.
Examples 4u, v refer to binder, adhesives, sealant, elastomer or coating formulations as described herein.
Examples 4w, x refer to solvent based 2K polyurethane clearcoat formulations as described herein.
Examples 4y, z refer to cosmetics or personal care formulations as described herein.

### Example 4a: UV Curable Formulation

A formulation was prepared with the following composition:
17% of a material prepared according to Example 2j
48% of a urethane acrylate resin Allnex Ebecryl 8808
10% of a reactive diluent trimer Trimethylolpropane Triacrylate (TMPTA)
22% of a reactive diluent monomer ACMO
1.5% of an Allnex Ebecryl 350 silicone acrylate surface finish enhancer
1.5% of a photoinitiator Allnex Ebecryl P 39

The formulation was prepared and cured with a mercury vapor lamp. By comparison with the reference system (not containing any material from example 2c, but instead 65% of Ebecryl 8808 urethane acrylate resin), the example here cured>30% faster and gave an improved surface finish quality as well as reduced stickiness prior to postcuring.

### Example 4b: UV Curable Formulation for Resin SLA 3D Printing

A formulation was prepared with the following composition:
10% of a material prepared according to Example 2y
30% of a Allnex Ebecryl 8210 resin
40% of Sartomer SR 494 LM tetraacrylate
20% of a reactive diluent trimer RAHN Genomer 1122
0.4% of Esstech TPO+photoinitiator
0.2% of Mayzo OB+UV blocker/absorber

The formulation was prepared and curing tests with a commercial 3D printer (Formlabs Form 3) were performed. Compared to the reference resin, where 40% Allnex Ebecryl resin were used instead of 30% and 10% polysiloxane-acrylate material from Example 2c, this formulation gave significant printing speed increase (ca. 25% shorter printing time) and sharper contour resolution of printed replicates.

### Example 4c: Alternative UV Curable Formulation for Resin SLA 3D Printing

A formulation was prepared with the following composition:
8% of a material prepared according to Example 2e
58% RAHN Genomer 4259 urethane acrylate resin
32% RAHN Genomer 1122 reactive diluent
2% RAHN Genocure TPO photoinitiator

The formulation was also printed on a commercial 3D printer (Anycubic Photon S) and produced a significantly softer and more flexible printed replica. Shore A hardness was 90 compared to the 99 value of a printed standard formulation (Example 2c compound replaced by urethane acrylate resin). Also the viscosity of the formulation which included the siloxane acrylate component (Example 2c) was significantly lower.

### Example 4d: UV Curable Formulation for Flexo-Ink Printing

A formulation was prepared with the following composition:
2% of a material prepared according to Example 1o
10% of a material prepared according to Example 2x
48% RAHN Genomer 2235 epoxy acrylate resin
40% MIWON Miramer M360 reactive diluent TMP(EO3)TA
4% RAHN Genocure TPO photoinitiator

The formulation was cast as a 30 um wet film onto a glass substrate and cured with a 385 nm LED. Compared to the reference material without polysiloxanes according to examples 1o & 2x, surface cure was much improved. Also the cured coating showed improved scratch resistance.

### Example 4d: A Humidity Curing Formulation Based on Urea/Urethane Coupled STP

A formulation was prepared with the following composition:
35 g polysiloxane-STP hybrid material to example 3c
20 g of pre-commercial STP material Si-PolyU XP 2550-1 (18,000 PPG basis)
5 g of an APTMS (3-aminopropyltrimethoxysilane) aminosilane curing catalyst
3 g of a vinyltrimethoxyilane water scavenger
12.5 g of a Hexamoll DINCH (BASF) plasticizer/softener
60 g of a Aktifit PF111 filler (Hoffmann Minerals)

The adhesive formulation cures rather quickly, about 150% elongation at break, very high yield strength

### Example 4e: A Humidity Curing Formulation Based on Urethane Coupled STP

A formulation was prepared with the following composition:
15 g polysiloxane-STP hybrid material to example 3d
55 g of STP material Geniosil STP-E30 (Wacker)
4 g of an APTMS (3-aminopropyltrimethoxysilane) aminosilane curing catalyst
2 g of a vinyltrimethoxyilane water scavenger
3 g of phenyltrimethoxysilane
0.5 g of dioctyl-tin dilaurate catalyst
15 g of a Jayflex DIUP (Exxon Mobil) plasticizer/softener
80 g of a Ca-stearate coated calcium carbonate filler
10 g of Titanium dioxide

The adhesive formulation cures quickly at room temperature; fully cured it shows good lap shear strength (>1.5N/mm2)

### Example 4f: A Minimal Polysiloxane-STP Hybrid Humidity Curing Formulation

A formulation was prepared with the following composition:
20 g of a polysiloxane STP hybrid material according to Example 3e
0.5 g of a APTMS (3-aminopropyltrimethoxysilane) aminosilane curing catalyst
1 g of a a vinyltrimethoxyilane water scavenger

The formulation was mixed and applied onto a polypropylene sheet in a 1 mm thick layer. The film was tack free on the surface after 2-3 minutes under ambient conditions (22° C., 45% R.H.). After approximately 40 Minutes, the film had cured completely, yielding a transparent, elastic rubbery material with approximately 200-250% elongation at break.

### Example 4g: A 1K Curable Isocyanate Formulation

First, an isocyanate terminated prepolymer was prepared in the same manner as described in Example 3e, but using a 4,000 molecular weight PEG/PPG/PEG block copolymer polyol as a starting material. The prepolymer was referred to as PPG-4000-VK5 iso-prepolymer.

A formulation was then prepared with the following composition:
40 g PPG-4000-VK5 iso-prepolymer
15 g of a material from Example 2b
6 g of a fumed silica filler Aerosil R-200 (Evonik industries), previously dried at 200° C. in vacuum for 6 h
0.07 g DBTDL and 0.1 DABCO catalysts

### Example 4h: A Low-Solvent 1K Curable Isocyanate Formulation

A formulation was prepared with the following composition:
75 g of a material from Example 21
16 g of Vencorex X-Flo 100 HDI prepolymer
15 g solvent (Xylene/Butyl acetate mixture)
30 g Titanium dioxide (filler)
10 g Talcum powder (filler)
10 g Mica powder (filler)
0.2 g DBTDL catalyst
0.35 g UV Absorber Irganox 1010

The formulation was applied as a films and cured under ambient condition within less than 2 hours, exhibiting good stability in outdoor use.

### Example 4i: A 2K Curable Isocyanate Formulation

A formulation was prepared with the following composition:
Component A (resin)
   19.3 g R^{1′} modified macro-polyol from Example 3a
   0.05 g DABCO catalyst
Component B (hardener)
   10 g Desmodur VK5 (Covestro)—

The formulation was mixed and cured for 48 h at 60° C. The resulting rubbery polymer had a Shore A hardness of 49. This is significantly lower than the corresponding reference specimens prepared where Component A was replaced by either 19.3 g of native Albodur 904 polyol (Shore A=68) and that of the physical mixture of 18.2 g Albodur 904+1.1 g R^{5U} reaction product from Example 11 (Shore A=63) and 0.05 g DABCO catalyst.

### Example 4j: A 2K Curable Isocyanate Formulation

A formulation was prepared with the following composition:
Component A (resin)
   13.5 g R^{1′} modified macro-polyol from example 3b
   44.8 g of a Radia 7285 Polyester Polyol (Oleon)
   33 g of a Aktifit PF111 filler (Hoffmann Minerals)
   7.5 of Cab-O-Sil TS-610 hydrophobic pyrogenic silica (Cabot)
   0.05 g DABCO and 0.03 g of Lupragen 201 (BASF) catalysts
Component B (hardener)
   45 g of a Tolonate X-Flo 100 IPDI prepolymer (Vencorex)
   7.2 g of a material from Example 2d

Both components were independently mixed in a vacuum planetary mixer. Both components were then combined and a rapidly curing rubbery product was obtained with very high strength and good tear resistance.

### Example 4k: A Minimal 2K Curable Isocyanate Formulation

First, an isocyanate terminated prepolymer was prepared in the same manner as described in Example 3e, but using a 12,000 molecular weight PPG polyol as a starting material. The prepolymer was referred to as PPG-12000-VK5 iso-prepolymer.

A formulation was prepared with the following composition:
Component A (resin)
   41 g PPG-12000-VK5 iso-prepolymer
Component B (hardener)
   10 g of a Material prepared according to Example 1j

Upon combining, the mixture reacts spontaneously. Sample was placed inside a eating cabinet at 80° C., system was fully cured after less than 5 minutes, yielding a slightly sticky polymeric product. Further aging in the heating cabinet does not seem to lead to further hardening/polymerization.

### Example 4l: An Amide Containing Formulation

A formulation was prepared with the following composition:
38 g of a material from example 2n
25 g of Calofort SV filler (Specialty Minerals)
48 g g of alkali lignin (hydroxyl content 3.5 mmol/g)

### Example 4m: An Anhydride/Amide Containing Gel Formulation

A formulation was prepared using the following protocol:
34 g 4,4′-oxidianiline (ODA)
43 g of Biphenyl-3,3′,4,4′-tetracarboxylic dianydride (BPDA)
158 g of N-methylpyrrollidone (NMP) solvent

Were combined at room temperature and stirred for 30 minutes. Next,
4.5 g acetic anhydride
16 g of a material from Example 2g

was added to the solution with stirring.

The formulation was quickly cast as a thin film. The film was then converted to a crosslinked polyimide material by thermal imidization.

### Example 4o: A Concentrate-Based Emulsion/Hydrolysate Formulations

A formulation was prepared using the following protocol:
4.5 g of a material from example in
1.5 g of a material from example 2j
0.1 g methanesulfonic acid
   were combined at room temperature and stirred for 5 minutes.

The formulation was has a shelf-life>6 months. The formulation can be readily diluted into water without the need for prehydrolysis and directly forms a stable hydrolysate.

### Example 4p: An Alternative Concentrate-Based Emulsion/Hydrolysate Formulations

A formulation was prepared using the following protocol:
15.0 g of a material from example 3e
2.8 g of a material from example 2j
1.4 g methanesulfonic acid
   were combined at room temperature and stirred for 5 minutes.

The formulation was has a shelf-life>6 months, although being opaque. The formulation can be readily diluted into water without the need for prehydrolysis and directly forms a stable STP emulsion. Applying such an emulsion to a substrate and allowing it to dry produces a high-quality surface protective coating.

### Example 4q: A Glass Fiber Sizing Coating Formulation

A formulation was prepared using the following protocol:
7.8 g of a material from example 4o
3.5 g of a material from example in
2.2 g of a material from example 2j
1.1 g of a material from example 2z
0.5 g acetic acid (98%)
73 g of a Hydrosize PU dispersion U5-02 film former (Michelmann)
   were combined at room temperature and emulsified into water and adjusted to a targeted solids content.

### Example 4r: A comparative glass fiber sizing coating formulation

A formulation was prepared using the following protocol:
15.0 g of a 3-aminopropyl-trimethoxsilane hydrolysate
11.5 g of a 3-glycidoxypropyl-trimethoxsilane hydrolysate
73 g of a Hydrosize PU dispersion U5-02 film former (Michelmann)
   were combined at room temperature and emulsified into water and adjusted to a targeted solids content.

The comparative example contained no polysiloxane compounds according to any of the claims presented here. Glass fibers coated in an in-line process with both sizing formulations showed significant differences in surface properties and mechanical performance of the respective glass-fiber epoxy (bisphenol A resin, bis (p-aminocyclohexyl) methane hardener) resin test composites. The sizing prepared according to example 4q showed better film/former glass interfacial strength and roughly 20% higher 3-point bending strength. Furthermore, the glass fibber sizing surface presented significantly lower surface roughness when analyzed by AFM (6.5+/−2.2 nm RMS versus 10.2+/−3.8 nm RMS roughness for the comparative example).

### Example 4s: A Radical Curable Formulation

A UV curable formulation was prepared using the following protocol:
70.5 g of an unsaturated polyester resin (UPE)
22.5 g of a material according to example 2y
1.3 g Cyclohexanone peroxide paste
0.8 g of a 1% Co(II) naphtenate solution in white spirit

### Example 4t: An Alternative Radical Curable Formulation

A UV curable formulation was prepared using the following protocol:
44.5 g of a Epoxy vinylester resin Derakane 470 HT
22.5 g of a material according to example 2x
15.6 g of oleic acid
10.5 g of methacrylated bisphenol A diglycidyl ether
1.35 g of Trigonox 239A
   Both formulations show excellent ambient cure and adhesion properties on a variety of substrates with excellent UV, thermal and chemical resistance compared to their reference formulations (polymeric liquid materials according to this invention replaced by reactive diluents).

### Example 4u: A Coating Formulation

A coating formulation was prepared using the following protocol:
3 g of a material from Example 3b
2 g of a Storelite HS-M luminescent pigment (RC Tritec)

The formulation was mixed well to ensure the pigment particles were well dispersed in the binder. A 100 micrometer thick film was then applied using a coating device (Proceq ZAA 2300). The film cured within 3-5 minutes at ambient condition. The formulation can be used to prepare rapid curing, solvent free, luminescent coatings with good scratch resistance.

### Example 4v: An Adhesive/Sealant Formulation

An adhesive coating formulation was prepared using the following protocol:
15 g of a material from Example 3b
80 g of a STP material with TMS functionality, silane terminated PPG basis, 18 k molecular weight
40 g DINCH
2 g Vinyltrimethoxyilane (VTMO)
4 g Aminopropyltrimethoxysilane (APTMS)
2 g Dibutyltindilaurate (DBTDL)
40 g Actifit PF111 filler
80 g OMYA BLH coated calcium carbonate filler
   The formulation was mixed in a speedmixer and applied to wood test specimens. The formulation cured approximately 20% faster than the reference (no material from example 3b, instead 95 g of STP material used). The shear lap strength was >1.7 N/mm².

### Example 4w: A Solvent Based 2K Polyurethane Clearcoat Formulation

A formulation was prepared with the following composition:
Component A (resin)
   62.5 g WorléeCryl A 1320 (Worlée)
   6.0 g Cellulose Acetate Butyrate—CAB-551-0.2 (Eastman)
   2.25 g Acematt TS 100
   2.0 g Xylene
   17.25 2 g Butyl acetate
   0.3 g K-Kat XK 661 (King industries)
   1.0 g of a material from Example 1m
Component B (hardener)
   9.5 g Tolonate HDB 75 B (Vencorex)
   10 g Xylene
      The clearcoat lacquer components A and B were mixed and applied as a 100 um wet film on glass. Drying speed of the clearcoat was improved significantly while the temporal viscosity increase was lower compared to the reference sample where the polysiloxane additive “Example 1m” was omitted. Furthermore, improved early onset pendulum hardness was observed for this formulation.

### Example 4x: An Alternative Solvent Based 2K Polyurethane Clearcoat Formulation

A formulation was prepared with the following composition:
Component A (resin)
   77.5 g WorleeCryl A 2445 (Worlée)
   7.0 g Methoxypropylacetate
   10.0 g Solvesso 100
   5.5 g Butyl acetate
   0.3 g K-Kat XK 635 (King industries)
   1.0 g of a material from Example 1m
Component B (hardener)
   31.4 g Tolonate HDB 75 (Vencorex)
   6.0 g Solvesso 100
   12.5 g Butyl acetate

The clearcoat lacquer components A and B were mixed and applied as a 100 um wet film on glass. Dust dry time was significantly reduced (10 minutes) compared to the reference sample (16 minutes) where the polysiloxane additive “Example 1m” was omitted. Furthermore, improved pendulum hardness development at 60° C. accelerated drying (heating cabinet) was observed for this formulation. Both these effects could not be obtained by higher dosing with the conventional K-Kat catalyst.

### Example 4y: A Cosmetics Formulation

A cosmetics formulation (cream base) was prepared using the following protocol:
22 g canola oil
8.5 g octyl-polysiloxane siloxene XenSlick 035
1.5 g of a material according to example 2j
3.5 g glycerin
150 mg of sodium stearoyl glutamate
48 g water into which 250 mg Xanthan gum had previously been dispersed

The mixture is emulsified with minimal shear. The addition of the material from example 2j allows for smooth emulsification and cold-processing, produces a silky smooth sensation on the skin without the use of silicones/dimethicone. The emulsions passes standardized 40° C./3° C. storage tests.

### Example 4z: A Personal Care Formulation

A personal care waterproof mascara base formulation was prepared using the following protocol:
2.5 g of Solagum AX
13.5 g of AQ55S (polyester-5)
2.5 g of a material according to example 3d
7.8 g of beeswax
2.0 g of Carnuba wax
3.0 g of microcrystalline wax
4.7 g of stearic acid
0.75 g of a material from example 3b
2.2 g of caprylic acid triglyceride
1.6 g of Eutanol G
8.0 g of black iron oxide
0.2 g of mica powder
49 g of water
   The formulation was homogenized. In a high speed mixer/homogenizer at 70° C. without the mica until homogeneous and then the mica was added and the mixture homogenized further. Addition of materials according to examples 3d and 3b, respectively improve film forming/application and volume of the mascara formulation.

### Example 5: Efficiency Testing for Potential Rearrangement Catalysts

A protocol was devised to test various model catalysts for their efficiency to catalyze grafting of a T- and/or D-type. Briefly, commercial Dynasylan Silbond 50 was used as Q-type precursor. A molar ratio n_{Q-type}:n_{T-type} of 1:0.15 was used and 30 ml aliquots of a premixed solution containing said Q-type and T-type silane precursor were filled into 50 ml glass bottles with lid. To each bottle, 1% by weight of model rearrangement catalyst was added and a blank sample was further included in the study. All glass bottles were simultaneously placed inside a heating cabinet which was kept at 100° C. and the samples were left there for a 24 h incubation period. After that, they were removed from the cabinet and allowed to cool to room temperature and analyzed by means of ²⁹Si NMR spectroscopy. The same protocol applies to D-type grafting.

| | | | % | % (Q^{2r} & | % (Q^{3s,d})/ | |
|---|---|---|---|---|---|---|
| Catalyst: | DP_{Q-Type} | DP_{T-Type} | T⁰ | Q^{3s,d})/Qₜₒₜ | Q³ | Rearrangement |
| No cat. | 2.12 | 0.56 | 51.6 | 48.9 | 80.8 | — |
| Zr(IV)-acetate | 2.18 | 1.41 | 5.6 | 33.8 | 0.65 | Yes |
| Ti(IV)- | 2.08 | 1.65 | 5.8 | 24.6 | 52.0 | Yes |
| ethoxide | | | | | | |
| O═Zr(AcAc)₂ | 2.19 | 0.64 | 41.2 | 50.9 | 81.3 | No |
| Hf(NO₃)₄ | 2.16 | 1.84 | 4.4 | 25.3 | 51.6 | Yes |

Following the spectral NMR analysis, one can evaluate the performance and suitability of a catalyst in terms of its ability to graft T⁰ or D⁰ monomers (DP_{T-Type} and % T⁰ indicators) as well as the percentage of residual tetrasiloxane ring species after the grafting step (% (Q^{2r}&Q^{3s,d})/Qₜₒₜ and % (Q^{3s,d})/Q³ indicators.

### Example 6: Hydrolysis of a Polymeric Liquid Material

40 g of Ethanol and 29.3 g of a crude reaction product from Example 5b were mixed and heated to 40° C. in an Erlenmeyer flask with stirring. Once the temperature had equilibrated, 4 ml of a 0.1 M methanesulfonic acid solution was added followed by 3 ml of distilled water. After a brief mixing step (magnetic stirrer), the solution was transferred into a glass bottles with hermetically sealing cap and kept in an oven at 40° C. for 16 hours. The final hydrolysis product was then filtered and stored in the refrigerator.

### Example 7: Preparation of a Water in Oil Emulsion

67.5 g of a sample of a material sample of Example 2p was mixed with 29.2 ml of distilled water and 5 g of a surfactant (Pluronic F127) were added. The two-phase system was then vigorously stirred using a mechanical impeller stirrer at 35° C. for 1 h. The resulting emulsion was a somewhat viscous creamy paste with a shelf life of several weeks without noticeable settling effects.

### Example 8: Preparation of an Oil in Water Emulsion

16.6 g of a sample of a material sample of Example 2i was mixed with 43.9 ml distilled water and 4.8 g of cetyl trimethyl ammonium chloride (CTAC). The two-phase system was then homogenized using a high-rpm mechanical homogenizer (Ultra Turrrax, IKA). The resulting emulsion was a low-viscous stable emulsion, which had a shelf life of several weeks when kept in a tightly sealed container.

1. A polymeric liquid polysiloxane material comprising:
(i) non-organofunctional Q-type siloxane moieties selected from the group consisting of: 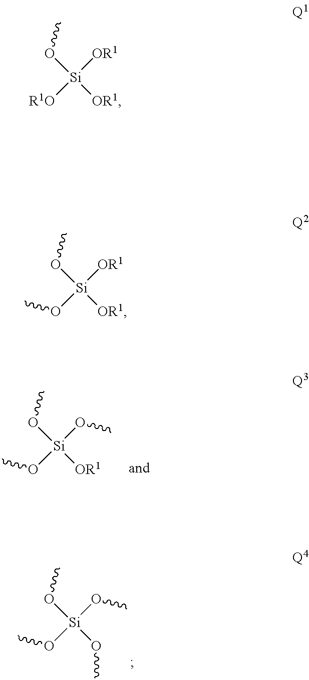
and at least one of
(iii) di-organofunctional D-type siloxane moieties selected from the group consisting of: 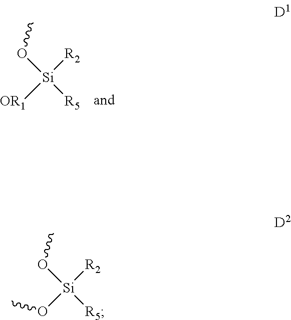
(iv) mono-organofunctional T-type siloxane moieties selected from the group consisting of: 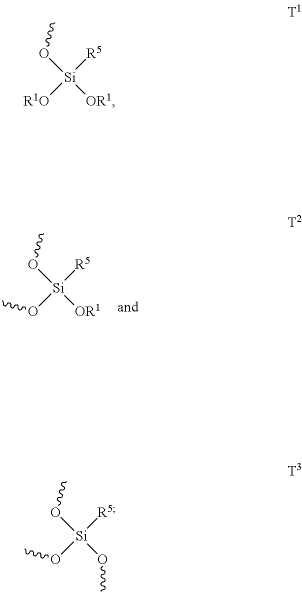
or
(v) a combination thereof,
wherein [symbol]
indicates a covalent siloxane bond to a silicon atom of another Q-type siloxane moiety, D-type siloxane moiety, or T-type siloxane moiety;
R¹ is selected from the group consisting of methyl, ethyl, propyl, R^{1′}, and R³,
R^{1′} is;
R² are each independently methyl, phenyl, or vinyl;
R³ is selected from the group consisting of 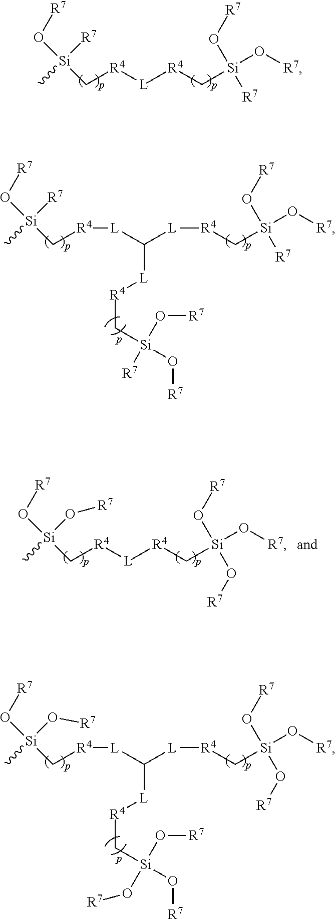
wherein p is an integer from 1 to 4;
R⁷ is methyl, ethyl, propyl, or a silicon atom of another Q-type siloxane moiety, D-type siloxane moiety, or T-type siloxane moiety;
L is selected from the group consisting of: 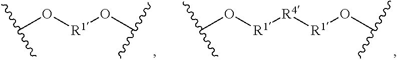
and L′;
L′ is
-(L)ₘ₁-[(L)ₘ₂-R⁴]ₘ₃-co-[(L)ₘ₂-R^{4′}]ₘ₄-co-(L)ₘ₂-R^{4′}-ₘ₅-(L)ₘ₁-,
wherein
L′ is about or less than 40,000 g/mol,
m1 is an integer from 0 to 15,
m2 is an integer from 3 to 200, and
m3, m4 and m5 are each independently integers from 0 to 10, with the proviso that at least one of m3 to m5 is not 0;
R^{4′} is absent or selected from the group consisting of 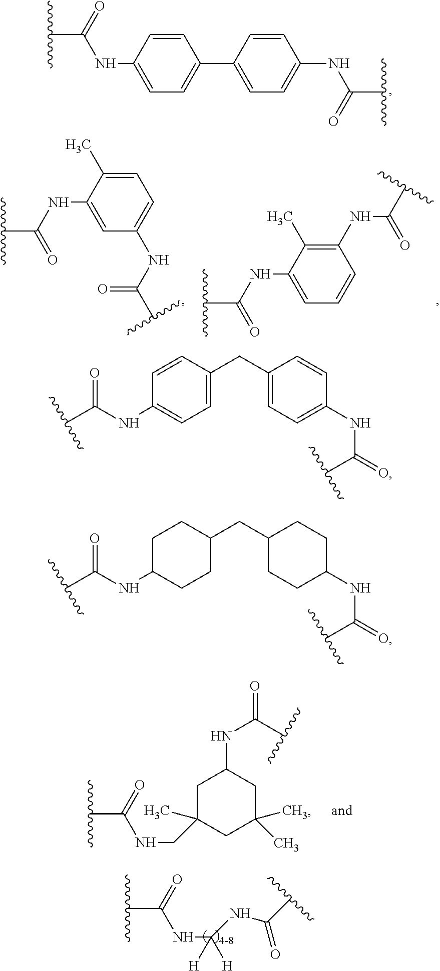
in monomeric, uretdione, biuret or tri-isocyanurate form;
R⁴ is absent, R^{4′}, or 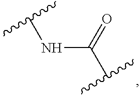 [SMILES: *NC(*)=O]
wherein the carbonyl is attached to the L moiety,
R⁵ is R^{5U} or R^{5S},
wherein
R^{5U} is selected from the group consisting of 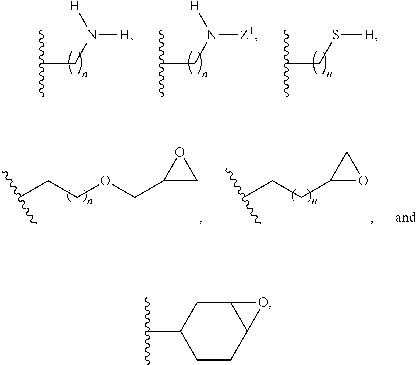
wherein n is an integer from 1 to 5;
Z¹ is selected from the group consisting of 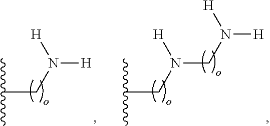
methyl, and ethyl, wherein o is an integer from 1 to 3;
R^{5S} is selected from the group consisting of 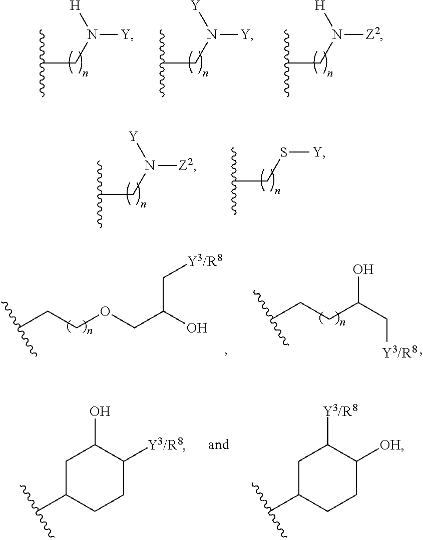
wherein n is an integer from 1 to 5;
Z² is selected from the group consisting of 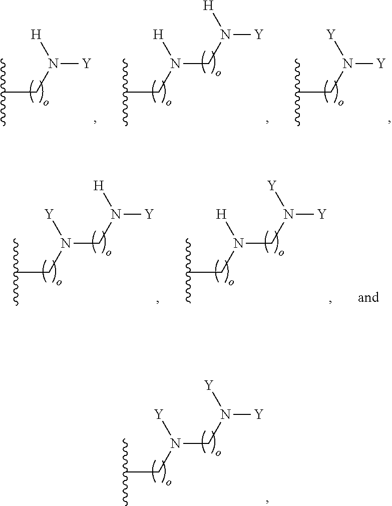
wherein o is an integer from 1 to 3;
Y is independently selected from the group consisting of Y¹, Y², —R^{4′}-L-Y², Y³, and Y⁴, wherein
Y¹ is selected from the group consisting of 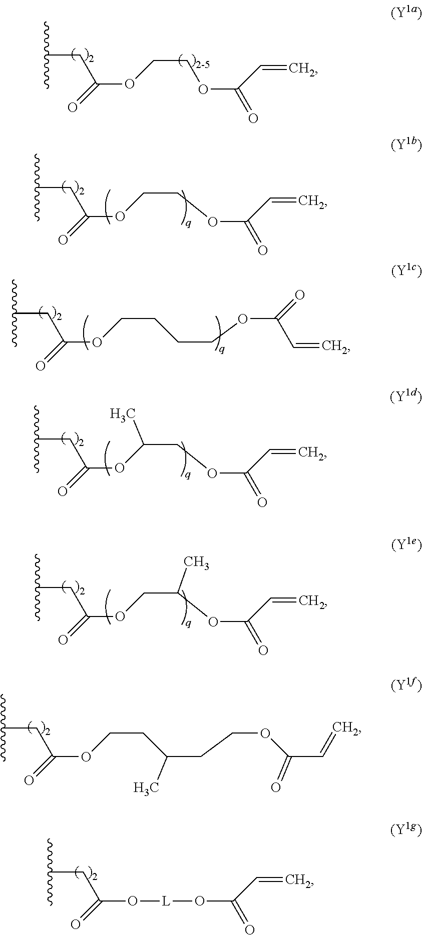 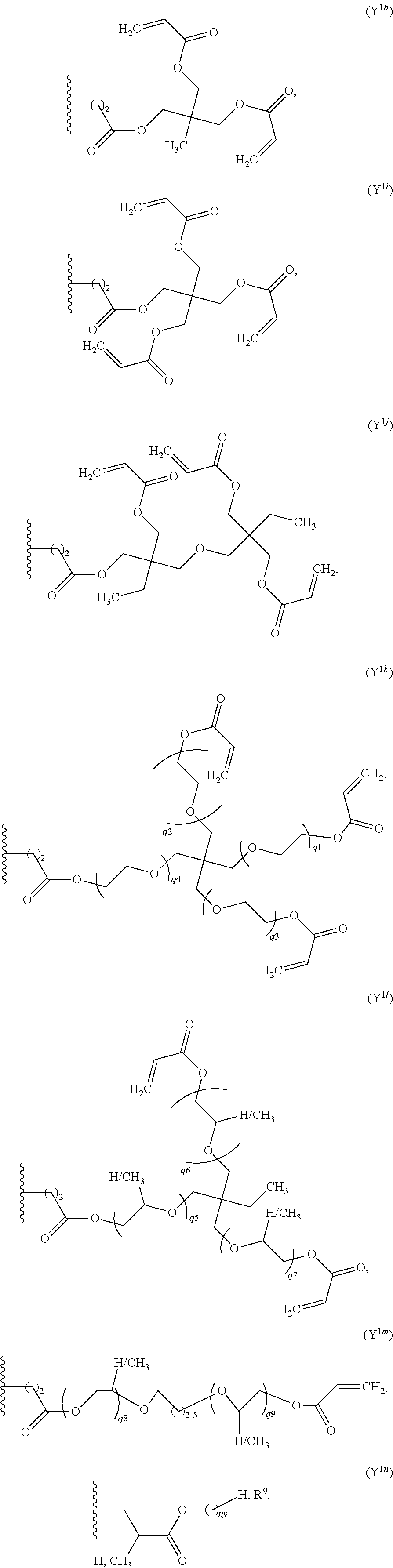 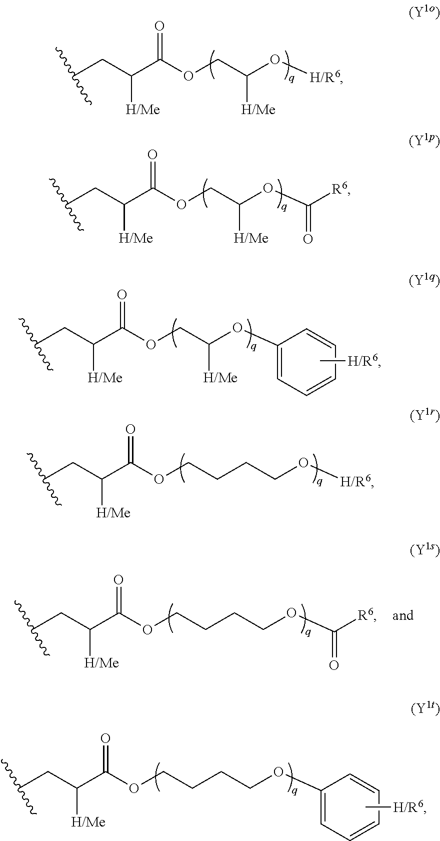
wherein
q is an integer from 1 to 10,
ny is an integer from 0 to 4,
each of q1 to q4 are integers independently from 0 to 8 and the sum of (q1+q2+q3+q4) is from 4 to 8,
each of q5 to q7 are integers independently from 0 to 24 and the sum of (q1+q6+q7) is from 3 to 24, and
each of q8 and q9 are integers independently from 0 to 6 and the sum of (q8+q9) is from 2 to 6, and
R⁹ is independently selected from the group consisting of 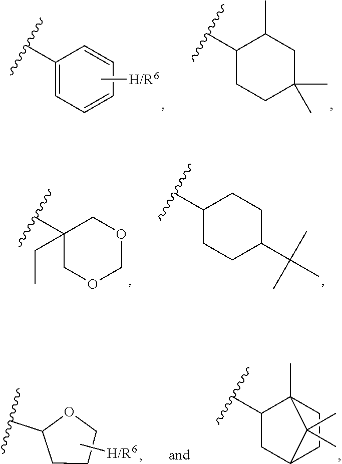
Y² is selected from the group consisting of 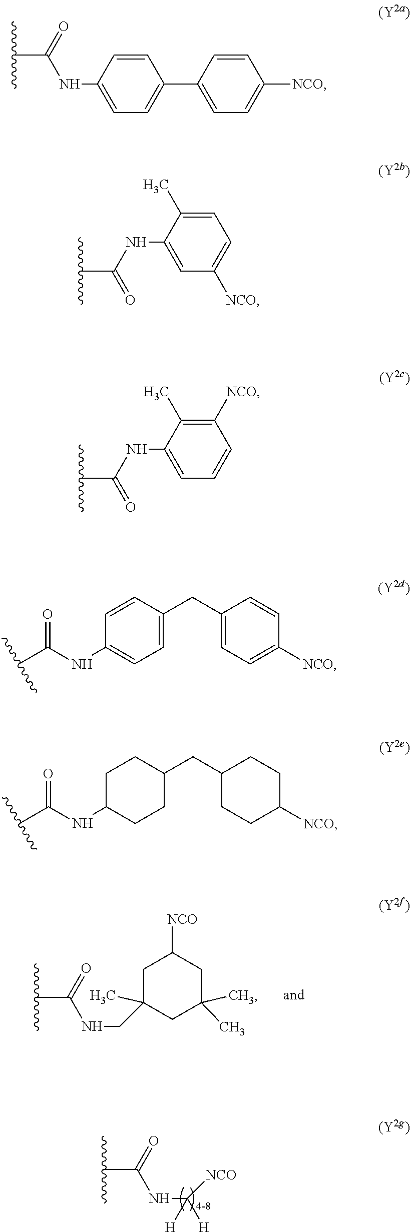
in monomeric, uretdione, biuret or tri-isocyanurate form;
Y³ is selected from the group consisting of 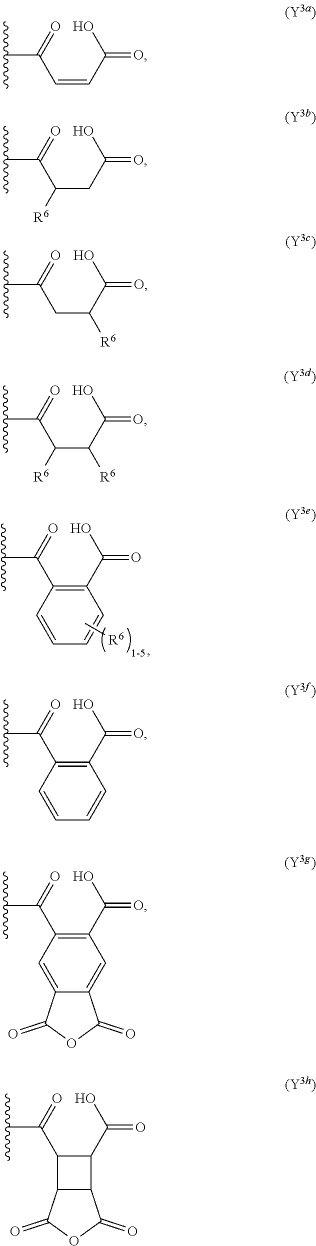 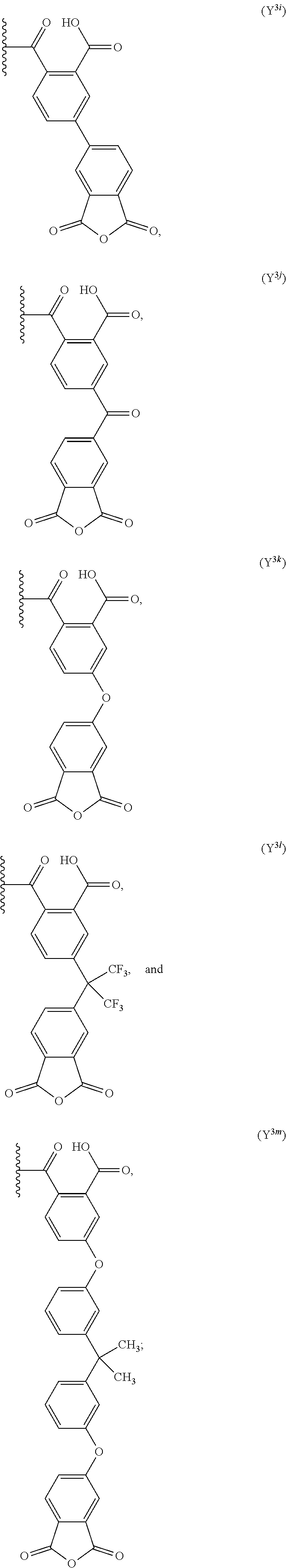 [SMILES: *C(=O)c1ccc(-c2ccc3c(c2)C(=O)OC3=O)cc1C(=O)O ; *C(=O)c1ccc(C(=O)c2ccc3c(c2)C(=O)OC3=O)cc1C(=O)O ; *C(=O)c1ccc(Oc2ccc3c(c2)C(=O)OC3=O)cc1C(=O)O ; *C(=O)c1ccc(C(c2ccc3c(c2)C(=O)OC3=O)(C(F)(F)F)C(F)(F)F)cc1C(=O)O ; *C(=O)c1ccc(Oc2cccc(C(C)(C)c3cccc(Oc4ccc5c(c4)C(=O)OC5=O)c3)c2)cc1C(=O)O]
Y⁴ is selected from the group consisting of: 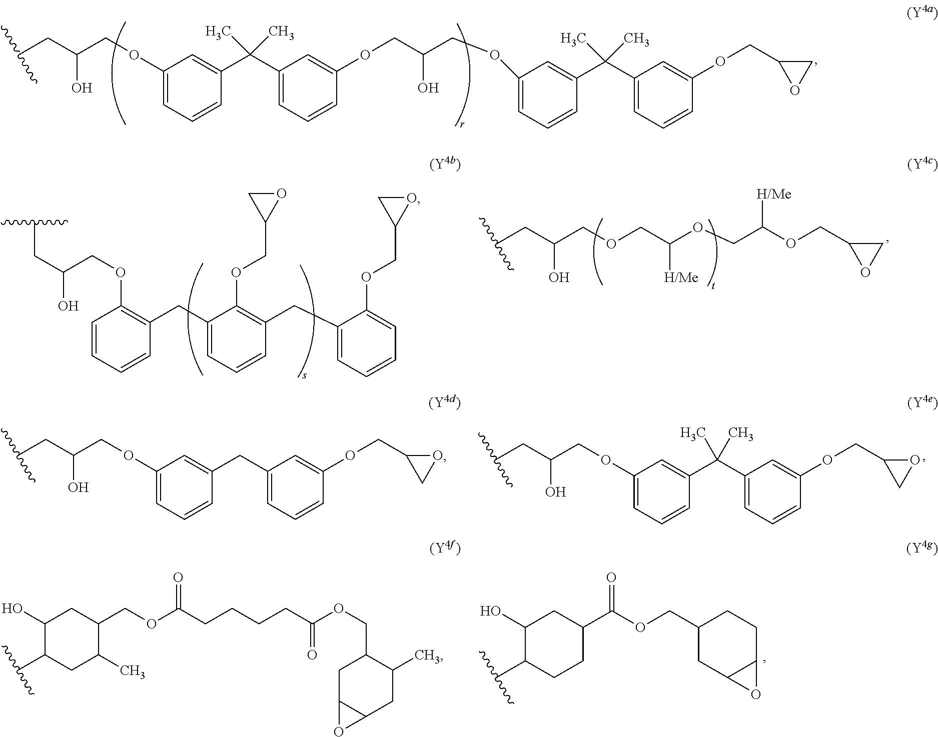 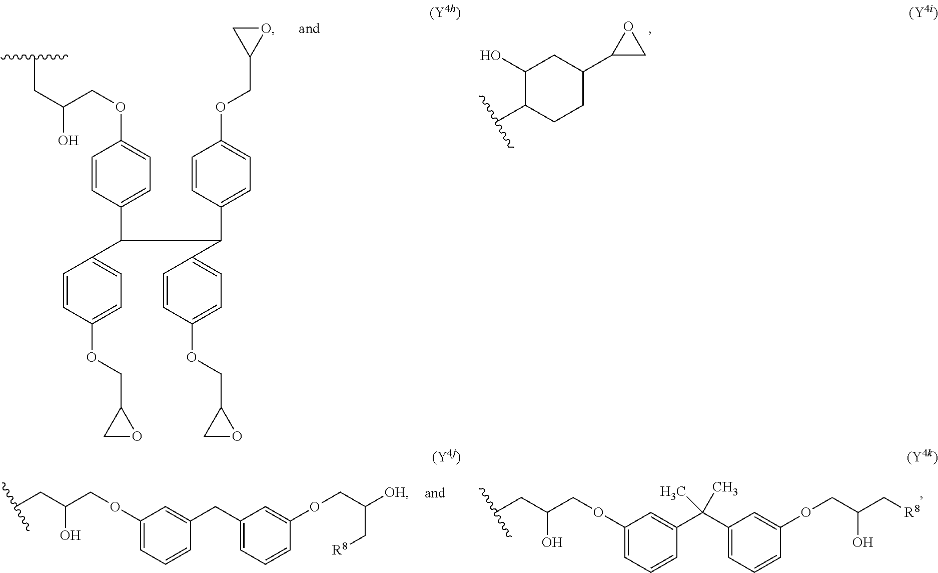
wherein r is an integer from 1 to 100, s is an integer from 1 to 15, and t is an integer from 1 to 10; and
R⁶ is selected from the group consisting of linear, branched or cyclic, substituted or non-substituted C₁₋₁₈ alkyl, linear, branched or cyclic, substituted or non-substituted C₂₋₁₈ alkenyl, and linear, branched or cyclic, substituted or non-substituted C₂₋₁₈ alkynyl;
R⁸ is 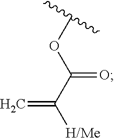
wherein
the degree of polymerization of the Q-type alkoxy-terminated siloxane moieties DP_{Q-type} is in the range of 1.3 to 2.7;
the degree of polymerization of the D-type alkoxy-terminated siloxane moieties DP_{D-type} is in the range of 1.0 to 1.9;
the degree of polymerization of the T-type alkoxy-terminated siloxane moieties DP_{T-type} is in the range of 1.1 to 2.7;
the total content of di-organofunctional D-type siloxane moieties in the polysiloxane material does not exceed 50 mol-%;
the material has a viscosity in the range of about 5 to 100,000 cP;
the material comprises about 0 or 0.5 to 15 mol-% silanol groups (Si—OH);
the atomic ratio of T-species to Q-species in the material is in the range of 0.01:1 to 1:1;
the atomic ratio of D-species to Q-species in the material is in the range of 0.01:1 to 0.5:1;
0 mol-% or at least 1 mol-% of all R⁵ moieties in the material are R^{5S} moieties; and
at most 2 mol-% of all R¹ moieties in the material are R³ moieties.

2. The polymeric liquid polysiloxane material according to claim 1, wherein at least one of:
the polysiloxane material comprises less than 45 mol-% four-membered combined Q^{2r}-type and Q^{3s,d}-type siloxane ring species relative to the total Q-type siloxane species;
the polysiloxane material comprises less than 70 mol-% four-membered combined Q^{3s,3d}-type siloxane ring species relative to all Q³-type siloxane species;
the polysiloxane material comprises less than 4.5 mol-% double four-membered Q^{3d}-type siloxane ring species relative to the total Q-type siloxane species;
the polysiloxane material comprises less than 25 mol-% double four-membered Q^{3d}-type siloxane ring species relative to all Q³-type siloxane species, or
a combination thereof.

3. The polymeric liquid polysiloxane material according to claim 1, wherein at least one of:
(a) less than 15 mol-% of all R¹ substituents are R^{1′} substituents,
(b) the material only comprises mono-organofunctional T-type siloxanes and essentially no di-organofunctional D-type siloxanes, or
(c) a combination thereof.

4. The polymeric liquid polysiloxane material according to claim 1, wherein the material comprises about 0 to 7 mol-% silanol groups (Si—OH).

5. The polymeric liquid polysiloxane material according to claim 1, wherein at least one of:
at least 1 mol-% of all R⁵ moieties in the material are R^{5S} moieties,
at least 0.05 mol-%, of all R¹ moieties in the material are R³ moieties,
at least 0.1 mol-% of all R¹ moieties in the material are R^{1′} moieties, or
a combination thereof.

6. The polymeric liquid polysiloxane material according to claim 1, wherein
R¹ is methyl, ethyl, R^{1′}, or R³;
R^{1′} is a polyol with at least one terminal —OH group;
R³ is selected from the group consisting of: 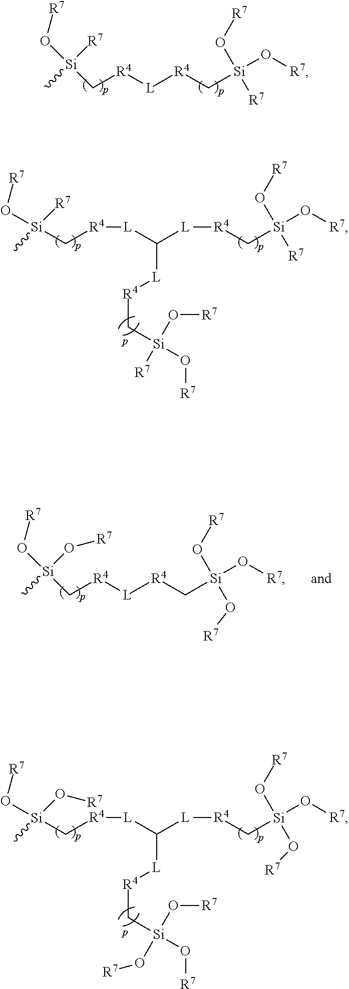
wherein p is an integer from 1 to 3;
R⁷ is methyl or ethyl;
L is selected from the group consisting of L′, 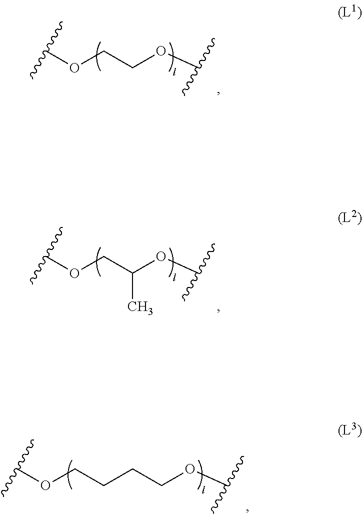
wherein l is an integer from 4 to 600,
L′ is selected from the group consisting of
-(L¹)ₘ₁-[(L¹)ₘ₂-R^{4′}]ₘ₃-co[(L²)ₘ₂-R⁴]ₘ₄-co-[(L³)ₘ₂-R^{4′}-]ₘ₅-(L¹)ₘ₁-, and
-(L²)ₘ₁-[(L¹)ₘ₂-R^{4′}]ₘ₃-co[(L²)ₘ₂-R^{4′}]ₘ₄-co-[(L³)ₘ₂-R⁴-]ₘ₅-(L¹)ₘ₁-,
wherein
L′ is about or less than 30,000 g/mol,
m1 is an integer from 0 to 10,
m2 is an integer from 10 to 150, and
m3, m4 and m5 are each independently integers from 0 to 6, with the proviso that at least one of m3 to m5 is not 0;
R^{4′} is selected from the group consisting of: 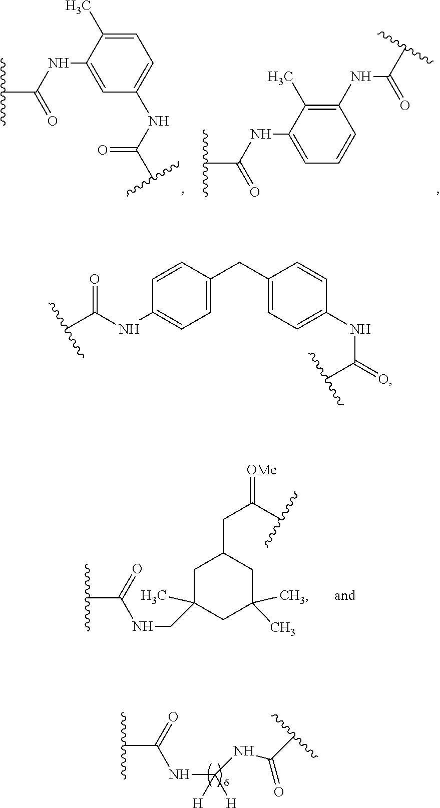
in monomeric, uretdione, biuret or tri-isocyanurate form;
R⁴ is absent, R^{4′}, or 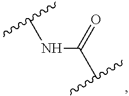 [SMILES: *NC(*)=O]
wherein the carbonyl is attached to the L moiety;
R^{5U} is 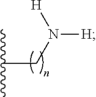
Z¹ is 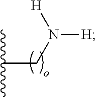
R^{5S} is selected from the group consisting of 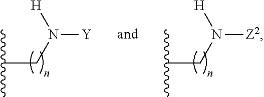
wherein n is an integer from 1 to 3;
Z² is selected from the group consisting of 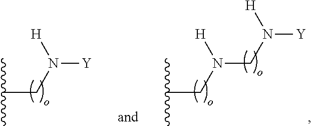
wherein o is an integer from 2 to 3; and
Y is independently selected from the group consisting of Y¹, Y², —R^{4′}-L-Y², Y³, and Y⁴, wherein
Y¹ is selected from the group consisting of 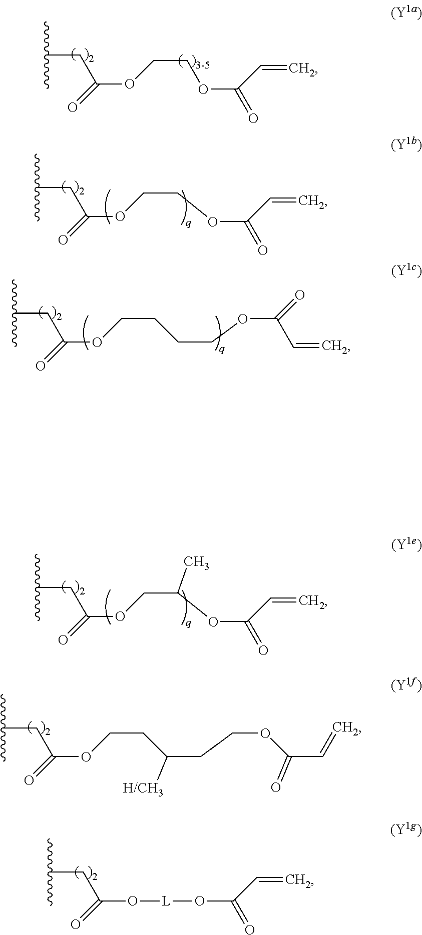 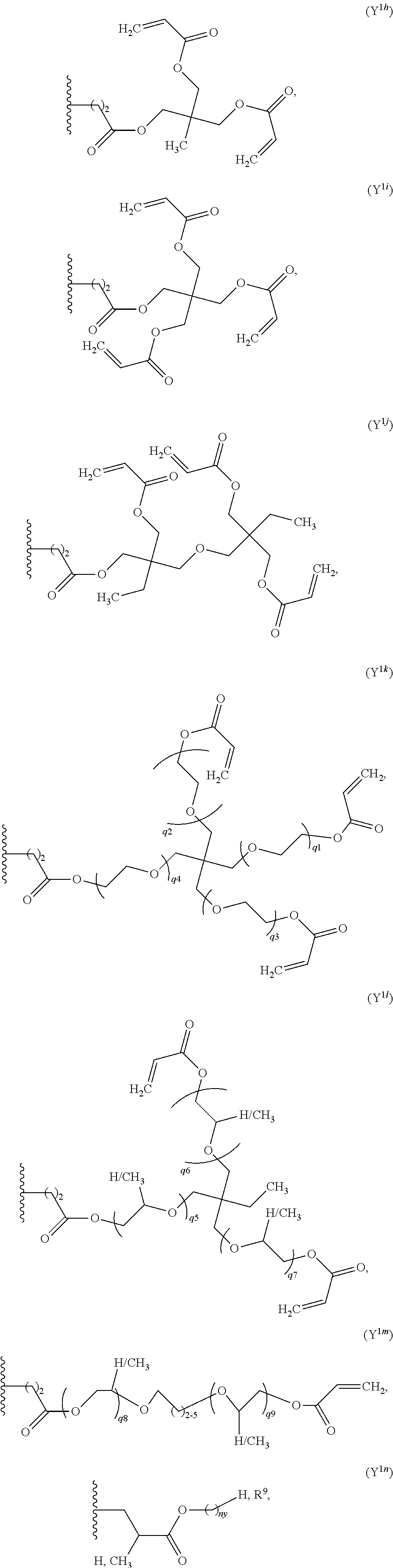 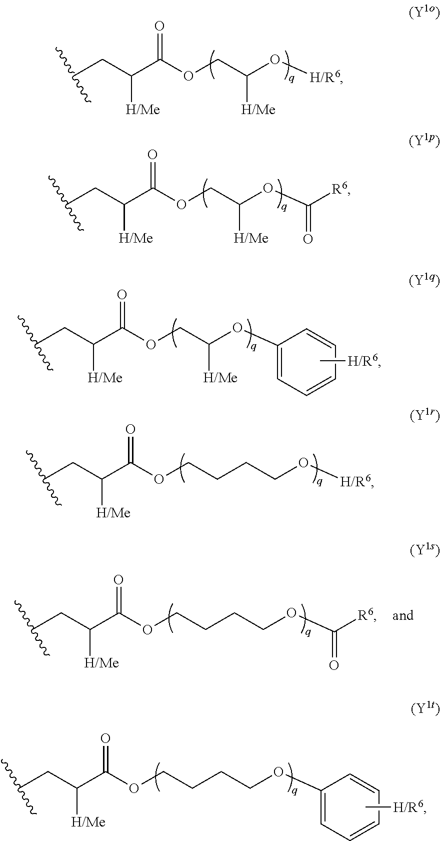
wherein
L is L¹ or L²
q is an integer from 1 to 4, and
ny is an integer from 0 to 4,
R⁹ is selected from the group consisting of 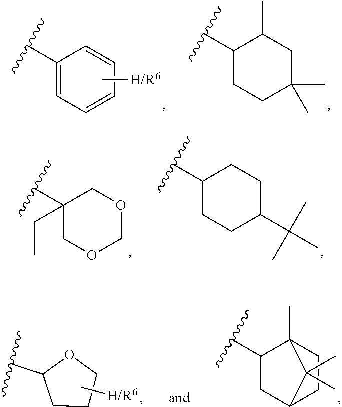
each of q1 to q4 are integers independently from 0 to 8 and the sum of (q1+q2+q3+q4) is from 4 to 8,
each of q5 to q7 are integers independently from 0 to 12 and the sum of (q5+q6+q7) is from 3 to 12, and
each of q8 and q9 are integers independently from 0 to 4 and the sum of (q8+q9) is from 2 to 4;
Y² is selected from the group consisting of 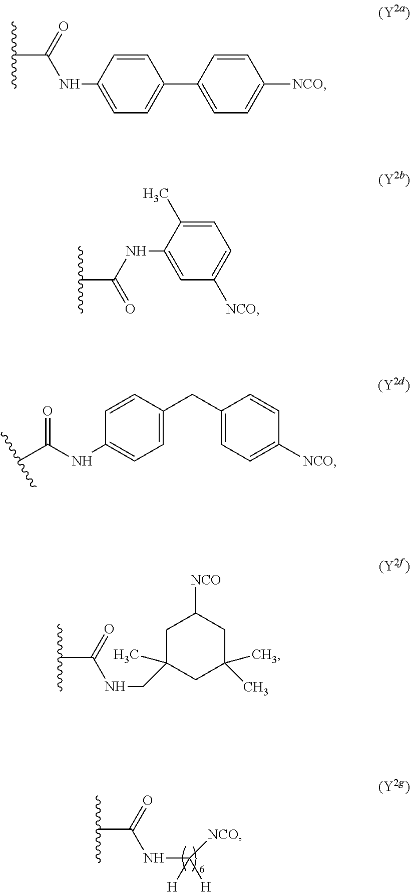
in monomeric, uretdione, biuret or tri-isocyanurate form;
Y³ is selected from the group consisting of 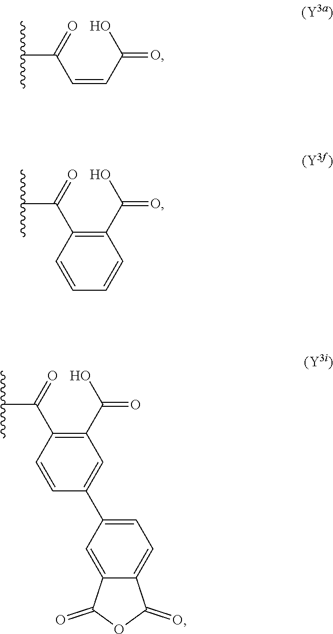 [SMILES: *C(=O)/C=C\C(=O)O ; *C(=O)c1ccccc1C(=O)O ; *C(=O)c1ccc(-c2ccc3c(c2)C(=O)OC3=O)cc1C(=O)O]
and
Y⁴ is selected from the group consisting of 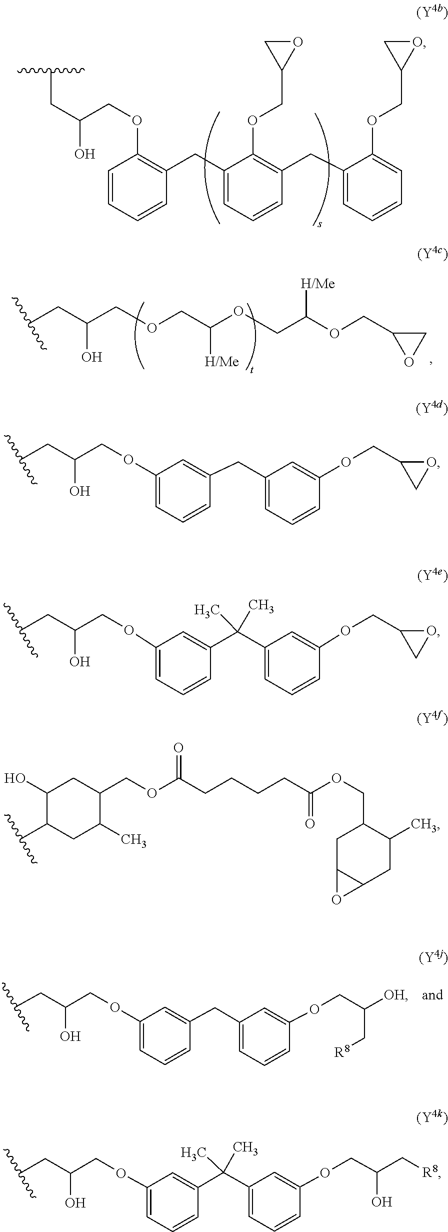
wherein s is an integer from 1 to 10 and t is an integer from 1 to 8.

7. The polymeric liquid polysiloxane material according to claim 6,
wherein
R^{1′} is a polyol selected from the group consisting of:
ethylene glycol, propylene glycol, glycerol, pentaerythritol, or trimethylolpropane;
linear or branched polyethyleneglycol, linear or branched poylpropylene glycol, or linear or branched poly(co-ethylene/propylene glycol) copolymer polyol, each with a molecular weight between 200 and 30,000 g/mol;
linear polyamid polyol with a molecular weight between 500 and 10,000 g/mol, comprising diamine units having 7 or less carbon atoms, triamine units having 7 or less carbon atoms, or a combination thereof, and di-carboxylic acid units having 10 or less carbon atoms;
linear polyester polyol with a molecular weight between 500 and 10,000 g/mol, comprising diol units having 7 or less carbon atoms, triol units having 7 or less carbon atoms, or a combination thereof, and di-carboxylic acid or anhydride units having 10 or less carbon atoms;
branched acrylic polyol with a molecular weight between 300 and 5,000 g/mol, comprising at least one of hydroxyethyl methacrylate, hydroxy butylacrylate, hydroxyethyl acrylate units, or a combination thereof;
linear acrylic polyol with a molecular weight between 300 and 5,000 g/mol comprising acrylate;
linear or branched polycarbonate polyol with a molecular weight between 500 and 50,000 g/mol comprising diol units, triol units, tetraol units, or a combination thereof, each having 13 or less carbon atoms; and
natural oil-based polyol with a molecular weight between 200 and 2,000 g/mol; and
L is selected from the group consisting of L′,

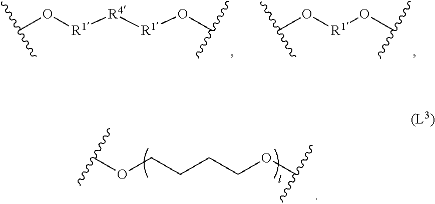

8. A UV-curable formulation comprising the polymeric liquid polysiloxane material according to claim 1, or
a ultaviolate (UV)-curable formulation comprising the polymeric liquid polysiloxane material, wherein the formulation comprises at least one of:
8a) wherein the polymeric liquid polysiloxane material comprises T-type siloxane moieties, D-type siloxane moieties, or a combination thereof, with R⁵ being R^{5U} and R^{5U} being 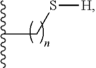
8b) wherein the polymeric liquid polysiloxane material comprises T-type siloxane moieties, D-type siloxane moieties, or a combination thereof, with R⁵ being R^{5S} and Y being Y¹, Y^{4j}, Y^{4k}, or a combination thereof,
8c) wherein the polymeric liquid polysiloxane material comprises T-type siloxane moieties, D-type siloxane moieties, or a combination thereof, with R⁵ being R^{5S} and wherein R^{5S} comprises at least one of 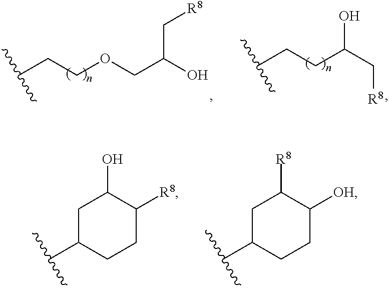
or a combination thereof, or
a combination thereof.

9. A humidity curing formulation comprising the polymeric liquid polysiloxane material according to claim 1, or
a humidity curing formulation comprising the polymeric liquid polysiloxane material, wherein the material comprises Q-type siloxane moieties, T-type siloxane moieties, D-type siloxane moieties, or a combination thereof, with R¹ being R³.

10. A 1K curable isocyanate-based formulation comprising the polymeric liquid polysiloxane material according to claim 1, or
a 1K curable isocyanate-based formulation comprising the polymeric liquid polysiloxane material, wherein the material comprises T-type siloxane moieties, D-type siloxane moieties, or a combination thereof, with R⁵ being R^{5S} and Y being Y², —R^{4′}-L-Y², or a combination thereof, or
a 1K curable isocyanate-based formulation comprising the polymeric liquid polysiloxane material, wherein the material comprises T-type siloxane moieties, D-type siloxane moieties, or a combination thereof, with R⁵ being R^{5S} and Y being Y², —R^{4′}-L-Y², or a combination thereof, and at least 25 to 100 mol-% of all R⁵ of the material are R^{5S} with Y being Y², —R^{4′}-L-Y², or a combination thereof.

11. A 2K curable isocyanate-based formulation comprising at least one resin, one hardener, and at least one of the polymeric liquid polysiloxanes material of claim 1, as defined in (I.), (II.), (V), and (VI.) below,
wherein the resin comprises at least one of:
(I.) the polymeric liquid polysiloxane material, wherein 1 to 20 mol-%, optionally 3 to 20 mol-% or 1 to 10 mol-% of all R⁵ of the material are R^{5S} with Y being Y² and/or —R^{4′}-L-Y²;
(II.) the polymeric liquid polysiloxane material, wherein at least 1 mol-% of all R¹ of the material are R^{1′};
(III.) a polyol, a polyamine, or a combination thereof; or
(IV.) a combination thereof
and the hardener is selected from:
(V.) the polymeric liquid polysiloxane material, wherein at least 50 mol-% of all R⁵ of the material are R^{5S} with Y being Y² or wherein at least 80 mol-% of all R⁵ of the material are R^{5S} with Y being Y²,
(VI.) the polymeric liquid polysiloxane material, wherein at least 40 mol-% of all R⁵ of the material are R^{5S} with Y being R4′-L-Y² or wherein at least 75 mol-% of all R⁵ of the material are R^{5S} with Y being R4′-L-Y²;
(VII.) an isocyanate monomer, uretdione, biuret or triisocyanurate, or an isocyanate terminated prepolymer, or
(VIII.) a combination thereof.

12. A 2K curable epoxy resin formulation comprising the polymeric liquid polysiloxane material according to claim 1, or
a 2K curable epoxy resin formulation comprising the polymeric liquid polysiloxane material comprising T-type siloxane moieties, D-type siloxane moieties, or a combination thereof, with R⁵ being R^{5S} and Y being Y⁴ with the exception of Y^{4j} and Y^{4k}, and at least one of an amine hardener, a mercapto hardener, an anhydride hardener, or a combination thereof.

13. A polymer resin formulation comprising
the polymeric liquid polysiloxane material according to claim 1, and
at least one of
a polyimide, polyamid, polyester resin or prepolymer, a diamine, a polyamine, or a polyol,
a catalyst and a filler, or
a combination thereof.

14. A directly emulsifiable formulation comprising the polymeric liquid polysiloxane material according to claim 1, or
a direct emulsifiable formulation comprising the polymeric liquid polysiloxane material, wherein the direct emulsifiable formulation comprises at least one of
the polymeric liquid polysiloxane material, wherein the material comprises T-type siloxane moieties, D-type siloxane moieties, or a combination thereof, with R⁵ being R^{5S} and Y being Y³, Y being 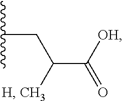
or a combination thereof
the polymeric liquid polysiloxane material, wherein the material comprises Q-type siloxane moieties, T-type siloxane moieties, D-type siloxane moieties, or a combination thereof, with R¹ being R³
an oil, a co-emulsifier, a stabilizer, a surfactant, or
a combination thereof.

15. A glass fiber sizing formulation comprising the polymeric liquid polysiloxane material according to claim 1, or
a glass fiber sizing formulation comprising
the polymeric liquid polysiloxane material comprising T-type siloxane moieties, D-type siloxane moieties, or a combination thereof, with R⁵ being R^{5U}, and
at least one of a silane in monomer or hydrolysed form, a lubricant, a biopolymer, an oil, a film former, a surfactant, an emulsifier, or a combination thereof.

16. A radical curable formulation comprising the polymeric liquid polysiloxane material according to claim 1, or
a radical curable formulation comprising the polymeric liquid polysiloxane material, wherein
the polymeric liquid polysiloxane material comprises
T-type siloxane moieties, D-type siloxane moieties, or a combination thereof, with R⁵ being R^{5U} and R^{5U} being vinyl, 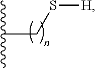
or a combination thereof,
T-type siloxane moieties, D-type siloxane moieties, or a combination thereof, with R⁵ being R^{5S} and R^{5S} comprising at least one of 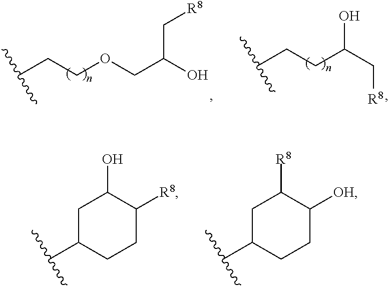
or a combination thereof, or R^{5S} with Y being Y³, Y^{4j}, Y^{4k} or a combination thereof, or
a combination thereof and
at least one of a filler, a radical initiator an unsaturated monomer or oligomer, a film former, a stabilizer, or a combination thereof.

17. A binder, adhesive, sealant, elastomer, or coating comprising at least one of: the polymeric liquid polysiloxane material according to claim 1, a formulations comprising the polymeric liquid polysiloxane material, or a combination thereof.

18. A solvent-based 2K polyurethane clearcoat formulation comprising at least one of: the polymeric liquid polysiloxane material according to claim 1, a formulation comprising the polymeric liquid polysiloxane material, or a combination thereof.

19. A binder, adhesive, sealant, elastomer, clearcoat, polymer, coating, or formulation obtained or obtainable by at least partial curing, thermal treatment, or a combination thereof, of the formulation according to claim 8.

20. A polymer dispersion obtained or obtainable by combining two formulations according to claim 14 and emulsifying the resulting mixture in water or a water/solvent mixture and polymerizing said mixture.

21. A cosmetics or personal care formulation comprising at least one of: the polymeric liquid polysiloxane material according to claim 1, a formulation comprising the polymeric liquid polysiloxane material, or a combination thereof.

22. The polymeric liquid polysiloxane material according to claim 1, wherein the material further comprises
(ii) tri-organofunctional M-type siloxane moieties selected from the group consisting of:

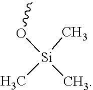

23. The polymeric liquid polysiloxane material according to claim 1, wherein at least one of:
R^{1′} is selected from the group consisting of low molecular linear or branched polyol, low molecular linear or branched polyether polyol, low molecular linear or branched polyester polyol, low molecular linear or branched acrylic polyol, low molecular linear or branched polycarbonate polyol, and low molecular linear or branched natural oil based polyol;
L is selected from the group consisting of 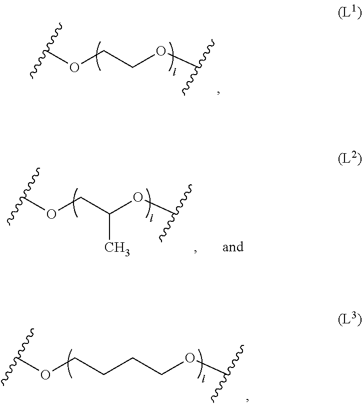
wherein l is an integer from 4 to 600;
L′ is selected from the group consisting of -(L¹)ₘ₁-[(L¹)ₘ₂-R^{4′}]ₘ₃-co-[(L²)ₘ₂-R^{4′}]ₘ₄-co-[(L³)ₘ₂-R⁴-]ₘ₅-(L¹)ₘ₁-, and -(L²)ₘ₁-[(L¹)ₘ₂-R^{4′}]ₘ₃-co-(L²)ₘ₂-R^{4′}]ₘ₄-co-[(L³)ₘ₂-R^{4′}-]ₘ₅-(L¹)ₘ₁-, wherein L¹ is 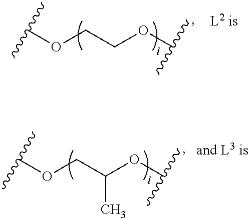
and L³ is 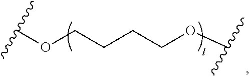
and wherein 1 is an integer from 4 to 600; or
a combination thereof.

24. The polymeric liquid polysiloxane material according to claim 6, wherein R^{1′} is at least one of:
a polyol with at least one terminal —OH group and comprising one or more carboxyl groups;
ethylene glycol, propylene glycol, glycerol, pentaerythritol, or trimethylolpropane;
linear or branched polyethyleneglycol, linear or branched poylpropylene glycol, or linear or branched poly(co-ethylene/propylene glycol) copolymer polyol, each with a molecular weight between 200 and 30,000 g/mol;
linear polyamid polyol with a molecular weight between 500 and 10,000 g/mol, comprising diamine units, triamine units, or both, having 7 or less carbon atoms and di-carboxylic acid units having 10 or less carbon atoms;
linear polyester polyol with a molecular weight between 500 and 10,000 g/mol, comprising diol units, triol units, or both, having 7 or less carbon atoms and di-carboxylic acid or anhydride units having of 10 or less carbon atoms;
branched acrylic polyol with a molecular weight between 300 and 5,000 g/mol, comprising at least one of hydroxyethyl methacrylate units, hydroxybutyl acrylate units, or hydroxyethyl acrylate units, or a combination thereof;
linear acrylic polyol with a molecular weight between 300 and 5,000 g/mol comprising acrylate;
linear or branched polycarbonate polyol with a molecular weight between 500 and 50,000 g/mol comprising diol units, triol units, tetraol units, or a combination thereof, having 13 or less carbon atoms; and
natural oil-based polyol with a molecular weight between 200 and 2,000 g/mol; or
a combination thereof.

25. The polymeric liquid polysiloxane material according to claim 7, wherein at least one of:
the branched acrylic polyol with a molecular weight between 300 and 5,000 g/mol for R^{1′} comprise one or more styrene units,
the linear acrylic polyol with a molecular weight between 300 and 5,000 g/mol for R^{1′} further comprise styrene units, or
a combination thereof.

26. The UV-curable formulation according to claim 8, wherein at least one of:
for 8a), at least 5 mol-% of all R⁵ of the material are 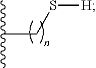
for 8b), at least 5 mol-% of all R⁵ of the material are R^{5S} with Y being Y¹, and/or Y^{4j} and/or Y^{4k};
the formulation further comprises at least two components selected from the group consisting of a reactive diluent, an acrylate resin, a photoinitiator, and a stabilizer, or
a combination thereof.

27. The glass fiber sizing formulation according to claim 15, wherein the material comprises Q-type siloxane moieties, T-type siloxane moieties, D-type siloxane moieties, or a combination thereof, with R¹ being R³.

28. The binder, adhesive, sealant, elastomer or coating according to claim 17 comprising more than one type of Y-functionality, R³-functionality, and/or R^{1′}-functionality, or a combination thereof, in the same formulation.
